(19) United States
(12) Patent Application Publication
(10) Pub. No.: US 2025/0065307 A1
(43) Pub. Date: Feb. 27, 2025

(54) ADDITIVE MANUFACTURING OF STRUCTURES FOR USE IN A THERMOCHEMICAL FUEL PRODUCTION PROCESS

(71) Applicant: ETH Zurich, Zurich (CH)

(72) Inventors: Aldo STEINFELD, Brugg (CH); André STUDART, Zürich (CH); Rafael NICOLOSI LIBANORI, Glattbrugg (CH); Fabio Luca BARGARDI, Wollerau (CH); Sebastian SAS BRUNSER, Glattpark (CH); Noëmi KAUFMANN, Winterthur (CH); Sabrina KISTLER, Döttingen (CH)

(73) Assignee: ETH Zurich, Zurich (CH)

(21) Appl. No.: 18/722,327

(22) PCT Filed: Dec. 20, 2022
(86) PCT No.: PCT/EP2022/087081

§ 371 Date: Jun. 20, 2024

(30) Foreign Application Priority Data
Dec. 21, 2021 (EP) 21216570.8

(51) Int. Cl. B01J 23/10; B01J 21/12; B01J 31/06; B01J 31/26; B01J 35/56; B01J 37/02; B01J 37/08; B33Y 40/20; B33Y 70/10; B33Y 80/00; C01B 3/06

(52) U.S. Cl. CPC B01J 23/10; B01J 21/12; B01J 31/06; B01J 31/26; B01J 35/56; B01J 37/0219; B01J 37/0236; B01J 37/08; B33Y 40/20; B33Y 70/10; B33Y 80/00; C01B 3/063

(57) ABSTRACT

An ink composition for additive manufacturing comprises at least a first phase, the first phase being a liquid phase, and inorganic particles being distributed in the first phase. The inorganic particles are redox active. The first phase furthermore comprises at least one organic processing additive. In a method of additive manufacturing a structure for use in a thermochemical fuel production process and/or in a heat transfer application, said ink composition is deposited so as to form a precursor structure, and said precursor structure is subjected to at least one thermal treatment so as to form the structure for use in the thermochemical fuel production process and/or in the heat transfer application.

### TECHNICAL FIELD

The present invention relates to ink compositions for additive manufacturing according to claim 1, to a method of producing such ink compositions according to claim 9, to the use of such ink compositions according to claim 10, to a method of additive manufacturing a structure for use in a thermochemical fuel production process according to claim 11, to a method of additive manufacturing a structure for use in a heat transfer application according to claim 12, to a structure being produced in said method according to claim 16, to a method of producing a fuel in a thermochemical fuel production process according to claim 20, to a method of heating a heat transfer fluid in a heat transfer application according to claim 21, and to a method of heating a structure in a heat transfer application according to claim 22.

### PRIOR ART

Concentrated solar energy provides a virtually unlimited source of clean, non-polluting, high-temperature heat, which can be used for driving thermochemical processes for the production of solar fuels [1-5]. The solar-driven splitting of H₂O and CO₂ via 2-step thermochemical redox cycles has emerged as a thermodynamically favorable pathway to produce syngas—a mixture of H₂ and CO which serves as the precursor for the synthesis of drop-in transportation fuels [11]. This 2-step thermochemical cycle comprises a first endothermic step for the thermal reduction of a metal oxide using concentrated solar process heat, followed by a second exothermic step for the oxidation of the reduced metal oxide with CO₂ and H₂O to generate CO and H₂, respectively. The metal oxide is not consumed and the net reactions are: CO₂=CO+½O₂ and H₂O=H₂+½O₂, with the fuel (H₂, CO) and O₂ generated in different steps, thereby avoiding an explosive mixture and eliminating the need for high-temperature gas separation. Among the candidate metal oxides for the thermochemical cycle, ceria has emerged as an attractive redox material because of its high oxygen ion diffusivity and crystallographic stability at high temperatures [6-13]. The redox cycle with ceria is represented by the reactions in Table 1.

TABLE 1
Thermochemical redox cycle for splitting CO₂ and H₂O into separate streams of
CO/H₂ and O₂ using ceria. This 2-step cycle comprises the solar endothermic reduction of
ceria followed by its exothermic oxidation with CO₂ and H₂O, wherein Δδ = δred − δox.

| | |
|---|---|
| Reduction | $\frac{1}{Δδ} {CeO}_{2 - {δ}_{ox}} \to \frac{1}{Δδ} {CeO}_{2 - {δ}_{red}} + \frac{1}{2} {O}_{2} \qquad ( 1 )$ |
| Oxidation with CO₂ | $\frac{1}{Δδ} {CeO}_{2 - {δ}_{red}} + {CO}_{2} \to \frac{1}{Δδ} {CeO}_{2 - {δ}_{ox}} + CO \qquad ( 2 a )$ |
| Oxidation with H₂O | $\frac{1}{Δδ} {CeO}_{2 - {δ}_{red}} + {H}_{2} O \to \frac{1}{Δδ} {CeO}_{2 - {δ}_{ox}} + {H}_{2} \qquad ( 2 b )$ |

The technical feasibility of the ceria-based redox cycle was demonstrated using porous structures [14-19]. Porous structures are attractive for high-temperature concentrating solar applications and particularly for the thermochemical splitting of H₂O and CO₂ because of their enhanced heat and mass transport properties leading to fast reaction rates, especially with regard to the absorption of concentrated solar radiation during the endothermic reduction step and the specific surface area during the exothermic oxidation step. It was shown that the morphology of the porous structure has a significant impact on the cycle's performance, e.g. on the molar conversion and energy efficiency, because the reduction step is heat transfer controlled while the oxidation step is surface/mass transfer controlled [16-19].

The so-called “volumetric absorption” of concentrated solar radiation, i.e. radiative absorption within a volume of a porous structure as opposed to radiative absorption on a surface, has been intensively investigated using ceramic receivers [20-22]. Thus, a desired porous structure for application in redox cycles should feature an appropriate optical thickness for volumetric absorption and uniform heating during the endothermic reduction step, but also a high specific surface area for rapid reaction kinetics during the exothermic oxidation step with H₂O and/or CO₂. In addition, high mass loading is crucial for maximum fuel output per unit volume, i.e. high effective density—defined as the redox material (ceria) mass per unit volume of the porous structure.

Reticulated porous ceramic (RPC) foam-type structures with dual-scale interconnected porosity (mm and μm-sized pores within the struts) fulfill some of these desired characteristics [16-19,23]. However, their uniform porosity and optical density results in Bouguer's law exponential-decay attenuation of incident radiation, which ultimately leads to an undesired temperature gradient along the radiation path over a wide range of structure morphologies (e.g. porosity) [24-26]. This implies that parts of the RPC structure located far down the radiation path do not reach the desired reaction temperature (≈1773 K) and therefore are not utilized to their full potential [26]. These parts become heat sinks without contributing to the solar-to-fuel conversion and thus detrimentally affect the conversion and energy efficiency. Contrarily, when the macro-porosity of the RPC is increased, its optical thickness decreases, radiation penetrates more deeply, which can improve to some extent the solar-to-fuel energy conversion efficiency, provided the effective density is not reduced.

Of special interest are structures featuring a porosity gradient obtained for example by composites with different pore dimensions [27], by introducing spikes [28], and by hierarchically-layered fractal-like structures [29]. The later was fabricated by the additive manufacturing (AM) technique. In particular, AM offers the possibility of fabricating ordered porous structures with a tailored porosity gradient, with the goal of adjusting the optical thickness and achieving uniform heating without compromising the apparent density and/or the specific surface area.

Recently, ordered ceria structures were fabricated by a combination of the AM method and the Schwartzwald replication method [30,31]. They consisted of uniform cells with decreasing cell size in the direction of incident radiation, except a V-groove geometry which had uniform porosity. These geometries were 3D-printed with a strut thickness of 0.3 mm using polymer ink. The resulting polymer templates were then coated with a ceria-based slurry which underwent sintering. Since the ordered and RPC structures were manufactured by the same replica-based method, using the same ceria slurry, sintering protocol, and dimensions of the strut's inner hollow channel, the thermochemical and mechanical stability of the ordered structures is comparable to that of the RPC structure subjected to the temperature-swing operating conditions of a solar reactor. These ordered structures with a porosity gradient exhibited a higher radiation penetration depth than the reference RPC with uniform porosity, leading to a more uniform temperature distribution. Furthermore, compared to the RPC, the ordered structures exhibited higher heating rates and reached peak temperatures further inside the volume and not on the exposed front surface, which is attributed to improved volumetric radiative absorption. However, their effective densities, were still low.

Ideally, the structures should maximize both their effective density and volumetric absorption. The former is needed in order to maximize the fuel output per unit volume, while the latter is needed to ensure effective volumetric absorption for reaching the required reaction temperatures uniformly within whole volume, ultimately contributing to fuel production. In principle, the maximum effective density would be obtained with a structure made of a solid block without porosity, but the resulting volumetric absorption would be practically negligible resulting in steep temperature gradients within the volume. On the other hand, the effective volumetric absorption would be obtained with a structure featuring high porosity and low optical thickness, but its effective density would be too low, resulting in too low fuel output per unit volume. Obviously, there is a tradeoff between effective density and volumetric absorption.

Structures can be printed using the Direct Ink Writing (DIW) approach [32,33]. In this method, a paste-like suspension of particles is directly extruded at room temperature to create three-dimensional objects with complex geometries. This extrusion-based technique was originally developed in the late 1990s under the term Robocasting [34]. The universal nature of the paste-like suspension used for DIW makes this process applicable to a wide range of particle morphologies and chemical compositions, including silica, barium titanate, alumina, silicon nitride, hydroxyapatite, among others [35,36].

In order to create three-dimensional structures via DIW, the suspension of particles needs to fulfill several rheological requirements. First, it should exhibit a shear-thinning behavior that facilitates flow within the nozzle during the extrusion process [35]. Such shear-thinning response is characterized by a decrease in the viscosity of the suspension under the applied shear stresses. Second, a minimum yield stress is required to prevent distortion of the as-printed structure [37]. Shape distortion in three-dimensional printed structures are usually caused by capillary or gravitational forces. Third, the paste-like suspension should display a viscoelastic behavior with high storage modulus at low deformation. This condition prevents excessive sagging of spanning filaments in printed objects with a grid-like architecture [38]. Finally, the ink is expected to quickly recover its initial storage modulus after the fluidization process that takes place in the extrusion nozzle.

The rheological response required for DIW printing is usually achieved by designing inks with particles with tuned interparticle forces [35]. The idea is to create paste-like inks through the formation of stiff and strong particle-based gels. Such gels can be generated by inducing attractive forces between the suspended particles, resulting in a three-dimensional load-bearing network. Typically, the particle network is formed by adjusting the pH or salt concentration of the suspension to a range where attractive van der Waals forces dominate over the repulsive interactions resulting from colloidal stabilization mechanisms. For example, particles electrostatically stabilized in water can form a gelled network if the pH of the suspension is shifted towards the isoelectric point. At this condition, the net electric charge on the particle surface is strongly reduced, preventing the formation of the electrical double layer needed for repulsive electrostatic interactions. The viscoelastic behavior of the resulting gels enables direct ink writing of complex geometries using state-of-the-art extrusion-based printers. After printing, objects are typically dried to remove the solvent and render a 3D particle assembly that is sintered to enhance the mechanical stability of the structure. DIW has been extensively used to print complex geometries and grid-like structures comprising dense filaments after drying and sintering.

In addition to particle suspensions, foams and emulsions containing particles in the continuous phase or adsorbed at the air/oil-water interfaces [39,40] have also been recently used as inks in DIW platforms [41,42]. In this case, the air bubbles or oil droplets of the foams or emulsions, respectively, serve as templates for the creation of macropores within the printed filaments. In contrast to the dense filaments formed from particle suspensions, filaments created from foams and emulsions are highly porous after drying and sintering of the printed object. This approach allows for the additive manufacturing of hierarchical porous structures with enhanced mechanical efficiency and permeability combined with high surface area. In such hierarchical porous structures, large open channels are generated by the print path at coarser length scales, whereas macropores at smaller scales are formed by the templating air bubbles and droplets.

While the extrusion of suspensions, foams and emulsions enables 3D printing of objects with unique geometrical complexity, the DIW process also faces limitations that require further developments in ink design and printing protocols. Shape distortion of printed objects and clogging of the ink within the nozzle are typical issues of the process. Distortion induced by gravitational forces is particularly challenging during direct ink writing of structures with increased heights and using inks with high specific gravity. In these cases, gravitational forces may exceed the yield stress of the ink, thus preventing the direct ink writing of high-fidelity and distortion-free structures. The clogging issue often results from drying of the suspension inside the nozzle. Drying-induced clogging usually occurs in suspensions with high volume fraction of particles, which are needed to minimize shrinkage of the printed part during drying. A common approach to circumvent these issues is to print the structure inside a non-wetting oil bath [38]. This reduces the effect of gravity and prevents rapid evaporation of the liquid phase of the ink. However, printing inside an oil bath is a cumbersome process that is not ideal for the manufacturing of large structures at industrial scale.

Gravity-induced shape distortion is particularly challenging to overcome when the ink contains particles with high specific gravity, such as ceria. While ceria monoliths have been already manufactured using the DIW approach, printed parts are typically small or show significant shape distortions [32,33]. This issue is potentially reduced by incorporating air bubbles into the ceria suspension to create foamed inks [43]. The resulting inks have been printed into porous ceria monoliths with the typical grid-like architecture that is often created by DIW. However, additional inorganic additives, such as hollow silica spheres and boehmite nanoparticles, were added to the ink to reach the rheological properties demanded for extrusion-based printing. Because they remain in the object after sintering, these inorganic oxides reduce the amount of redox active solid phase in the final structure. Moreover, grid-like printed structures with uniform relative density are not suitable for solar applications, since they prevent deep penetration of the solar radiation inside the monolith.

### REFERENCES

[1] Romero, M. & Steinfeld, A. Concentrating solar thermal power and thermochemical fuels. Energy & Environmental Science 5, 9234-9245, doi:10.1039/C2EE21275G (2012).
[2] Yadav, D. & Banerjee, R. A review of solar thermochemical processes. Renewable and Sustainable Energy Reviews 54, 497-532, doi:https://doi.org/10.1016/j.rser.2015.10.026 (2016).
[3] Agrafiotis, C., Roeb, M. & Sattler, C. A review on solar thermal syngas production via redox pair-based water/carbon dioxide splitting thermochemical cycles. Renewable and Sustainable Energy Reviews 42, 254-285, doi:https://doi.org/10.1016/j.rser.2014.09.039 (2015).
[4] Kodama, T. High-temperature solar chemistry for converting solar heat to chemical fuels. Prog. Energy Combust. Sci. 29, 567-597, doi:https://doi.org/10.1016/S0360-1285(03)00059-5 (2003).
[5] Muhich, C. L. et al. A review and perspective of efficient hydrogen generation via solar thermal water splitting. WIREs Energy and Environment 5, 261-287, doi:https://doi.org/10.1002/wene.174 (2016).
[6] Abanades, S. & Flamant, G. Thermochemical hydrogen production from a two-step solar-driven water-splitting cycle based on cerium oxides. Solar Energy 80, 1611-1623, doi:https://doi.org/10.1016/j.solener.2005.12.005 (2006).
[7] Ackermann, S., Scheffe, J. R. & Steinfeld, A. Diffusion of Oxygen in Ceria at Elevated Temperatures and Its Application to H2O/CO2 Splitting Thermochemical Redox Cycles. The Journal of Physical Chemistry C 118, 5216-5225, doi:10.1021/jp500755t (2014).
[8] Chueh, W. C. & Haile, S. M. A thermochemical study of ceria: exploiting an old material for new modes of energy conversion and CO<sub>2</sub> mitigation. Philosophical Transactions of the Royal Society A: Mathematical, Physical and Engineering Sciences 368, 3269-3294, doi:doi:10.1098/rsta.2010.0114 (2010).
[9] Gao, X. et al. Efficient ceria nanostructures for enhanced solar fuel production via high-temperature thermochemical redox cycles. Journal of Materials Chemistry A 4, 9614-9624, doi:10.1039/C6TA02187E (2016).
[10] Gokon, N., Sagawa, S. & Kodama, T. Comparative study of activity of cerium oxide at thermal reduction temperatures of 1300-1550° C. for solar thermochemical two-step water-splitting cycle. Int. J. Hydrogen Energy 38, 14402-14414, doi:https://doi.org/10.1016/j.ijhydene.2013.08.108 (2013).
[11] Knoblauch, N., Dörrer, L., Fielitz, P., Schmucker, M. & Borchardt, G. Surface controlled reduction kinetics of nominally undoped polycrystalline CeO2. Physical Chemistry Chemical Physics 17, 5849-5860, doi:10.1039/C4CP05742B (2015).
[12] Scheffe, J. R. & Steinfeld, A. Oxygen exchange materials for solar thermochemical splitting of H2O and CO2: a review. Mater. Today 17, 341-348, doi:https://doi.org/10.1016/j.mattod.2014.04.025 (2014).
[13] Gladen, A. C. & Davidson, J. H. The morphological stability and fuel production of commercial fibrous ceria particles for solar thermochemical redox cycling. Solar Energy 139, 524-532, doi:https://doi.org/10.1016/j.solener.2016.10.029 (2016).
[14] Chueh, W. C. et al. High-Flux Solar-Driven Thermochemical Dissociation of CO<sub>2</sub> and H<sub>2</sub>O Using Nonstoichiometric Ceria. Science 330, 1797-1801, doi:10.1126/science.1197834 (2010).
[15] Furler, P. et al. Solar Thermochemical CO2 Splitting Utilizing a Reticulated Porous Ceria Redox System. Energy & Fuels 26, 7051-7059, doi:10.1021/ef3013757 (2012).
[16] Furler, P. et al. Thermochemical CO2 splitting via redox cycling of ceria reticulated foam structures with dual-scale porosities. Physical Chemistry Chemical Physics 16, 10503-10511, doi:10.1039/C4CP01172D (2014).
[17] Furler, P., Scheffe, J. R. & Steinfeld, A. Syngas production by simultaneous splitting of H2O and CO2 via ceria redox reactions in a high-temperature solar reactor. Energy & Environmental Science 5, 6098-6103, doi:10.1039/C1EE02620H (2012).
[18] Marxer, D., Furler, P., Takacs, M. & Steinfeld, A. Solar thermochemical splitting of CO2 into separate streams of CO and O2 with high selectivity, stability, conversion, and efficiency. Energy & Environmental Science 10, 1142-1149, doi:10.1039/C6EE03776C (2017).
[19] Marxer, D. et al. Demonstration of the Entire Production Chain to Renewable Kerosene via Solar Thermochemical Splitting of H2O and CO2. Energy & Fuels 29, 3241-3250, doi:10.1021/acs.energyfuels.5b00351 (2015).
[20] Agrafiotis, C. C. et al. Evaluation of porous silicon carbide monolithic honeycombs as volumetric receivers/collectors of concentrated solar radiation. Sol. Energy Mater. Sol. Cells 91, 474-488, doi:https://doi.org/10.1016/j.solmat.2006.10.021 (2007).
[21] Avila-Marin, A. L. Volumetric receivers in Solar Thermal Power Plants with Central Receiver System technology: A review. Solar Energy 85, 891-910, doi:https://doi.org/10.1016/j.solener.2011.02.002 (2011).
[22] Hoffschmidt, B. et al. Development of ceramic volumetric receiver technology. (; DLR Deutsches Zentrum fuer Luft- und Raumfahrt e.V., Koeln (Germany). Solare Energietechnik, 2001).
[23] Steinfeld, A., Scheffe, J., Furler, P., Vogt, U. & Gorbar, M. Open-cell materials for use in thermochemical fuel production processes. (2013).
[24] Petrasch, J., Wyss, P. & Steinfeld, A. Tomography-based Monte Carlo determination of radiative properties of reticulate porous ceramics. J. Quant. Spectrosc. Radiat. Transfer 105, 180-197, doi:https://doi.org/10.1016/j.jqsrt.2006.11.002 (2007).
[25] Ackermann, S., Takacs, M., Scheffe, J. & Steinfeld, A. Reticulated porous ceria undergoing thermochemical reduction with high-flux irradiation. Int. J. Heat Mass Transfer 107, 439-449, doi:https://doi.org/10.1016/j.ijheatmasstransfer.2016.11.032 (2017).
[26] Zoller, S., Koepf, E., Roos, P. & Steinfeld, A. Heat Transfer Model of a 50 kW Solar Receiver-Reactor for Thermochemical Redox Cycling Using Cerium Dioxide. Journal of Solar Energy Engineering 141, doi:10.1115/1.4042059 (2019).
[27] Chen, X., Xia, X. L., Yan, X. W. & Sun, C. Heat transfer analysis of a volumetric solar receiver with composite porous structure. Energy Convers. Manage. 136, 262-269, doi:10.1016/j.enconman.2017.01.018 (2017).
[28] Capuano, R., Fend, T., Stadler, H., Hoffschmidt, B. & Pitz-Paal, R. Optimized volumetric solar receiver: Thermal performance prediction and experimental validation. Renew. Energy 114, 556-566, doi:10.1016/j.renene.2017.07.071 (2017).
[29] Luque, S. et al. Exploiting volumetric effects in novel additively manufactured open solar receivers. Solar Energy 174, 342-351, doi:https://doi.org/10.1016/j.solener.2018.09.030 (2018).
[30] Schwartzwalder, K. & Somers, A. V. Method of making porous ceramic articles. (1963).
[31] Hoes, M., Ackermann, S., Theiler, D., Furler, P. & Steinfeld, A. Additive-Manufactured Ordered Porous Structures Made of Ceria for Concentrating Solar Applications. Energy Technology 7, 1900484, doi:https://doi.org/10.1002/ente.201900484 (2019).
[32] Lucentini, I., Serrano, I., Soler, L., Divins, N. J. & Llorca, J. Ammonia decomposition over 3D-printed CeO2 structures loaded with Ni. Applied Catalysis A: General 591, 117382, doi:https://doi.org/10.1016/j.apcata.2019.117382 (2020).
[33] Leclerc, C. A. & Gudgila, R. Short Contact Time Catalytic Partial Oxidation of Methane over Rhodium Supported on Ceria Based 3-D Printed Supports. Industrial & Engineering Chemistry Research 58, 14632-14637, doi:10.1021/acs.iecr.9b01169 (2019).
[34] Cesarano, J. A Review of Robocasting Technology. MRS Proceedings 542, 133, doi:10.1557/PROC-542-133 (1998).
[35] Lewis, J. A. Direct ink writing of 3D functional materials. Adv. Funct. Mater. 16, 2193-2204, doi:10.1002/adfm.200600434 (2006).
[36] Lewis, J. A., Smay, J. E., Stuecker, J. & Cesarano, J. Direct Ink Writing of Three-Dimensional Ceramic Structures. Journal of the American Ceramic Society 89, 3599-3609, doi:https://doi.org/10.1111/j.1551-2916.2006.01382.x (2006).
[37] Kokkinis, D., Schaffner, M. & Studart, A. R. Multimaterial magnetically assisted 3D printing of composite materials. Nat Commun 6, Article number 8643, doi:10.1038/ncomms9643 (2015).
[38] Smay, J. E., Cesarano, J. & Lewis, J. A. Colloidal inks for directed assembly of 3-D periodic structures. Langmuir 18, 5429-5437 (2002).
[39] Gonzenbach, U. T., Studart, A. R., Tervoort, E. & Gauckler, L. J. Stabilization of foams with inorganic colloidal particles. Langmuir 22, 10983-10988 (2006).
[40] Gonzenbach, U. T., Studart, A. R., Tervoort, E. & Gauckler, L. J. Ultrastable particle-stabilized foams. Angewandte Chemie-International Edition 45, 3526-3530 (2006).
[41] Muth, J. T., Dixon, P. G., Woish, L., Gibson, L. J. & Lewis, J. A. Architected cellular ceramics with tailored stiffness via direct foam writing. Proceedings of the National Academy of Sciences 114, 1832-1837, doi:10.1073/pnas.1616769114 (2017).
[42] Minas, C., Carnelli, D., Tervoort, E. & Studart, A. R. 3D Printing of Emulsions and Foams into Hierarchical Porous Ceramics. Advanced Materials 28, 9993-9999, doi:10.1002/adma.201603390 (2016).
[43] Zhang, X., Zhang, Y., Lu, Y., Zhang, S. & Yang, J. Hierarchically porous ceria with tunable pore structure from particle-stabilized foams. Journal of the European Ceramic Society 40, 4366-4372, doi:https://doi.org/10.1016/j.jeurceramsoc.2020.05.034 (2020).

### SUMMARY OF THE INVENTION

It is an object of the present invention to overcome the shortcomings of the prior art. In particular, it is an object of the present invention to provide an ink composition for additive manufacturing that enables the manufacture of a structure for use in a thermochemical fuel production process exhibiting an enhanced solar-to-fuel conversion.

This object is achieved with an ink composition according to claim 1. In particular, an ink composition for additive manufacturing is provided, wherein the ink composition comprises at least a first phase and inorganic particles being distributed in the first phase. The first phase is a liquid phase. The inorganic particles are redox active. The first phase furthermore comprises at least one organic processing additive.

The inorganic particles are preferably capable of undergoing a thermochemical reaction. The inorganic particles preferably comprise or consists of a metal and/or a metal oxide. The metal oxides preferably are chosen from metal oxides having a perovskite structure ABO₃ where A is chosen from Sr, Ca, Ba, La and B is chosen from Mn, Fe, Ti, Co, Al, such as for example CaTiO₃, from iron oxides such as iron(II,III) oxide and mixed ferrites MₓFe₃₋ₓO₄ where M is preferably chosen from Zn (Zn-ferrite), Co (Co-ferrite), Ni (Ni-ferrite), Mn (Mn-ferrite), from tungsten trioxide (WO₃), from stannic oxide (SnO₂), and from ceria (CeO₂) and solid solutions of ceria (Ce₁₋ₓMₓO₂) where M can be Zr, Hf, Sm, La, Sc and from others such as with Zr (for example Ce_{0.85}Zr_{0.15}O₂) and Hf(Ce₁₋ₓHfₓO₂).

In addition or in the alternative, the inorganic particles are preferably likewise conceivable for heat transfer applications involving, for instance, the heating of a heat transfer fluid flowing across a structure being produced from an ink composition according to the invention.

The inorganic particles preferably have a diameter of 10 micrometer or less, more preferably of 5 micrometer or less.

It is furthermore preferred that the ink composition is free from inorganic rheology additives such as silica or boehmite. Since the ink composition herein disclosed is free from inorganic rheology additives, the manufacturing challenges of stereolithographic templating approaches and the limitations of current DIW methods are circumvented.

In a first aspect, the ink composition preferably is a suspension. Furthermore, the organic processing additive preferably is a thermoresponsive material and/or capable of undergoing a preferably reversible or irreversible temperature-dependent self-assembly and/or a thermo-gelling process.

As such, it is preferred that organic processing additive exhibits a lower critical solution temperature (LCST) in the liquid phase, i.e. in the first phase. The organic processing additive preferably comprises a LCST in the range of 5° C. to 50° C. and/or is capable of undergoing thermo-gelling at a temperature in the range of 5° to 50° C. It is however likewise preferred that the organic processing additive exhibits an upper critical solution temperature (UCST) in the liquid phase, i.e. in the first phase. The organic processing additive preferably comprises a UCST in the range of 5° C. to 50° C. and/or is capable of undergoing a thermo-gelling at a temperature in the range of 5° to 50° C.

Preferred organic additives exhibiting a UCST are UCST polymers and UCST copolymers such as Acrylamide (AAm) and acrylic acid (AAc) derivatives, such as poly-3-dimethyl(methacryloyloxyethyl) ammonium propane sulfonate (PDMAPS) and poly(3-[N-(3-methacrylamidopropyl)-N,N-di-methyl]ammoniopropane sulfonate (PSPP), and zwitterionic polymers.

Hence, it is particularly preferred that the thermoresponsive material is a thermoresponsive polymer or copolymer. Moreover, the organic processing additive preferably is a thermoresponsive polymer or copolymer that is capable of forming a reversible gel upon heating. Preferred thermoresponsive polymers are synthetic or natural macromolecules such as poly(N-isopropylacrylamide), Poly(N,N-diethyl acrylamide), Poly(2-(N-(dimethylamino) ethyl methacrylate), Poly(N-vinyl caprolactam), Poly(oligoethylene glycol [methyl ether][meth]acrylates), Poly(2-oxazolines), gelan gum, methylcellulose, hydroxypropyl methyl cellulose, chitosan, starch. A particularly preferred thermoresponsive copolymer is a thermoresponsive triblock copolymer such as a PEO-PPG-PEO copolymer, for instance Pluronic F-127.

Furthermore, it is preferred that an amount of the organic processing additive in the ink composition according to the first aspect, i.e. wherein the ink composition is a suspension and the organic processing additive is a thermoresponsive material and/or capable of undergoing a preferably reversible or irreversible temperature-dependent self-assembly and/or a thermo-gelling process, preferably is between 5% by weight to 50% by weight of the organic processing additive per total weight of the first phase, more preferably between 10% by weight to 30% by weight of the organic processing additive per total weight of the first phase, and most preferably between 15% by weight to 25% by weight of the organic processing additive per total weight of the first phase.

The ink composition preferably further comprises at least one dispersing agent. The dispersing agent is preferably provided in the first phase. The dispersing agent preferably is capable of preventing the agglomeration of the inorganic particles and/or is capable of adsorbing on the surface of the inorganic particles. The dispersing agent preferably is a polyelectrolyte dispersing agent and/or an organic acid, preferably an adsorbing organic acid, or a polymer or copolymer or a derivative thereof and/or an inorganic acid or a derivative or a polymer or a copolymer thereof and/or a polyamine such as polyethylene imine or copolymers thereof, a poly(methacrylate) or their acids or copolymers thereof, poly(acrylates) or their acids or copolymers thereof, or polyvinylalcohol.

A preferred polyelectrolytic dispersing agent is an anionic polyelectrolyte dispersing agent, and particularly preferably a salt of a carboxylic acid or a polymer thereof such as an ammonium salt of a polycarboxylic acid, for example Dolapix CE64. A preferred organic acid is a carboxylic acid such as citric acid, being also an adsorbing organic acid, or acrylic acid. A preferred polymer of an organic acid is a polymer of an acrylic acid such as polyacrylic acid and a preferred copolymer thereof is a copolymer of acrylic acid and maleic acid such as polycarboxylate. A preferred inorganic acid is phosphoric acid and a preferred derivative thereof is a phosphate.

An amount of the dispersing agent preferably is in the range of 0.05% by weight to 2% by weight of dispersing agent per total weight of the ink composition, more preferably in the range of 0.1% by weight to 1% by weight of dispersing agent per total weight of the ink composition, and particularly preferably in the range of 0.25% by weight to 0.75% by weight of dispersing agent per total weight of the ink composition.

Alternatively, it is conceivable that the ink composition according to the first aspect is free from dispersing agents. Additionally or alternatively it is conceivable that the effect of the dispersing agent is achieved by adjusting the pH value of the ink composition. A preferred pH value of the ink composition according to the first aspect preferably is higher or lower than the isoelectric point of the particles exhibiting surfaces with acidic or alkaline character, respectively. Additionally or alternatively, a pH value of the ink composition according to the first aspect preferably is above 4, more preferably in the range between 5 to 9, and most preferably in the range between 5.5 to 7.

In a second aspect, the ink composition preferably is an emulsion and the organic processing additive preferably is a particle surface modifier and/or a surface active additive. As such, the ink composition preferably further comprises a second phase, wherein the first phase preferably is a continuous phase and the second phase is a dispersed phase. In fact, the continuous phase preferably is an aqueous phase and/or the dispersed phase preferably is an oil phase. That is, the ink composition can be an emulsion, preferably an oil-in-water emulsion, and wherein the inorganic particles preferably are in a continuous aqueous phase. The oil phase can be used to generate porosity upon drying.

The particle surface modifier preferably is at least one of an organic acid or a derivative thereof such as a carboxylic acid, a gallate such as propyl gallate or butyl gallate, an alkyl amine such as nonyl amine and hexyl amine, or a surfactant such as sodium dodecyl sulfate (SDS) or an ammonium surfactant like cetyl trimethyl ammonium bromide (CTAB) or dodecyl trimethyl ammonium bromide (DTAB) or an amphiphile such as propionic acid. A preferred carboxylic acid is an alkyl carboxylic acid, such as formic acid, acetic acid, propionic acid, butyric acid, valeric acid, or caproic acid.

An amount of the particle surface modifier in the ink composition according to the second aspect, i.e. wherein the ink composition is an emulsion, preferably is between 0.0001 millimol (mmol) to 0.5 millimol, more preferably between 0.01 millimol to 0.1 millimol, and most preferably between 0.03 millimol to 0.06 millimol per gram of inorganic particles in the continuous phase of the emulsion. The optimum concentration of the particle surface modifier preferably depends on a length of the hydrocarbon chain of the particle surface modifier, and is preferably chosen based on the correlation being disclosed in [Studart, A. R.; Libanori, R.; Moreno, A.; Gonzenbach, U. T.; Tervoort, E.; Gauckler, L. J., Unifying Model for the Electrokinetic and Phase Behavior of Aqueous Suspensions Containing Short and Long Amphiphiles. Langmuir 2011, 27 (19), 11835-11844].

The surface active additive preferably is a polymeric surfactant, particularly preferably a vinyl polymer such as polyvinylalcohol (PVA) or polyvinylpyrrolidone (PVP). A polymeric surfactant is also known as a surface active polymer. The surface active additive serves the purpose of partially displacing inorganic particles adsorbed at the oil-water interface being formed by the first phase and the second phase of the emulsion. Thereby, an open porosity can be generated after drying and sintering of a precursor structure in a method of additive manufacturing a structure for use in a thermochemical fuel production process, see further below.

An amount of the surface active additive in the ink composition according to the second aspect, i.e. wherein the ink composition is an emulsion, preferably is between 0% by weight to 6% by weight of the surface active additive per total weight of the continuous phase of the emulsion, more preferably between 0.1% by weight to 2% by weight of the surface active additive per total weight of the continuous phase of the emulsion, and particularly preferably between 0.3% by weight to 1.5% by weight of the surface active additive per total weight of the continuous phase of the emulsion.

The emulsion preferably comprises 10% by volume of the dispersed phase per total volume of the emulsion or more, more preferably 30% by volume of the dispersed phase per total volume of the emulsion or more such as 40% by volume of the dispersed phase per total volume of the emulsion or more. For instance, the emulsion preferably comprises up to 60% by volume of the dispersed phase per total volume of the emulsion.

The inorganic particles are preferably adsorbed at an oil-water interface being formed by the first phase and the second phase of the emulsion. As mentioned earlier, the emulsion preferably is an oil-in-water emulsion. As such it is preferred that the inorganic particles are adsorbed at an oil-water interface being formed by the first phase, i.e. the aqueous phase, and the second phase, i.e. the dispersed phase in the form of the oil phase. Alternatively, the inorganic particles preferably form a percolating network throughout the first phase. The percolating network is preferably formed by the inorganic particles throughout the continuous aqueous phase. It can be important in order to tune the rheological properties of the ink.

The dispersed phase preferably comprises or consists of a hydrophobic organic compound, preferably an alkane hydrocarbon, and particularly preferably to an alkane hydrocarbon comprising between 6-16 carbon atoms such as octane or decane, or an aromatic hydrocarbon such as toluene or triglyceride oils.

The ink composition according to this second aspect is preferably free from dispersing agents. However, it is likewise conceivable that the ink composition according to the second aspect comprises at least one dispersing agent as mentioned above.

In a third aspect, the ink composition preferably is a wet foam and the organic processing additive preferably is a particle surface modifier and/or a surface active additive. As such, it is preferred that the ink composition further comprises a second phase, wherein the first phase is a continuous phase and the second phase is a dispersed phase. The continuous phase preferably is an aqueous phase and/or the dispersed phase preferably a gaseous phase such as air.

The particle surface modifier preferably is at least one of an organic acid or a derivative thereof such as a carboxylic acid, a gallate such as propyl gallate or butyl gallate, an alkyl amine such as nonyl amine and hexyl amine, a catechol-based molecule such as dopamine modified with alkyl chains, or a surfactant such as sodium dodecyl sulfate (SDS) or an ammonium surfactant like cetyl trimethyl ammonium bromide (CTAB) or dodecyl trimethyl ammonium bromide (DTAB). A preferred carboxylic acid is an alkyl carboxylic acid, such as formic acid, acetic acid, propionic acid, butyric acid, valeric acid, or caproic acid.

An amount of the particle surface modifier in the ink composition according to the third aspect, i.e. wherein the ink composition is a wet foam, preferably is between 0.05 microliter to 50 microliter, more preferably between 0.10 microliter to 2.0 microliter, and most preferably between 0.50 microliter to 1 microliter per gram of inorganic particles in the continuous phase of the wet foam. The optimum concentration of the particle surface modifier preferably depends on a length of the hydrocarbon chain of the particle surface modifier, and is preferably chosen based on the correlation being disclosed in [Studart, A. R.; Libanori, R.; Moreno, A.; Gonzenbach, U. T.; Tervoort, E.; Gauckler, L. J., Unifying Model for the Electrokinetic and Phase Behavior of Aqueous Suspensions Containing Short and Long Amphiphiles. Langmuir 2011, 27 (19), 11835-11844].

The surface active additive preferably is a polymeric surfactant, particularly preferably a vinyl polymer such as polyvinylalcohol (PVA) or polyvinylpyrrolidone (PVP). A polymeric surfactant is also known as a surface active polymer. The surface active additive serves the purpose of partially displacing inorganic particles adsorbed at the gas-water interface being formed by the first phase and the second phase of the wet foam. Thereby, an open porosity can be generated after drying and sintering of a precursor structure in a method of additive manufacturing a structure for use in a thermochemical fuel production process, see further below.

An amount of the surface active additive in the ink composition according to the third aspect, i.e. wherein the ink composition is a wet foam, preferably is between 0% by weight to 6% by weight of the surface active additive per total weight of the continuous phase of the emulsion, more preferably between 0.1% by weight to 2% by weight of the surface active additive per total weight of the continuous phase of the emulsion, and particularly preferably between 0.3% by weight to 1.5% by weight of the surface active additive per total weight of the continuous phase of the emulsion.

The wet foam preferably comprises 10% by volume of the dispersed phase per total volume of the wet foam or more, more preferably 30% by volume of the dispersed phase per total volume of the wet foam or more such as 40% by volume of the dispersed phase per total volume of the wet foam or more.

The inorganic particles are preferably adsorbed at a gas-water interface being formed by the first phase and the second phase of the wet foam. Alternatively, the inorganic particles preferably form a percolating network throughout the first phase.

The ink composition according to this third aspect is preferably free from dispersing agents. However, it is likewise conceivable that the ink composition according to the third aspect comprises at least one dispersing agent as mentioned above.

A volume fraction of the inorganic particles preferably is at least 10% by volume, more preferably at least 20% by volume, and particularly preferably at least 30% by volume with respect to a total volume of the ink composition.

Preferably, in the ink composition according to the first aspect, i.e. wherein the ink composition is a suspension, an amount of the inorganic particles preferably is between 45% by weight to 92% by weight of the inorganic particles per total weight of the ink composition, more preferably between 75% by weight to 90% by weight of the inorganic particles per total weight of the ink composition, and particularly preferably between 86% by weight to 88% by weight of the inorganic particles per total weight of the ink composition.

Preferably, in the ink composition according to the second and third aspect, i.e. wherein the ink composition is an emulsion or a wet foam, an amount of the inorganic particles preferably is between 44% by weight to 83% by weight of the inorganic particles per total weight of the first phase, more preferably between 70% by weight to 81% by weight of the inorganic particles per total weight of the first phase, and particularly preferably between 75% by weight to 80% by weight of the inorganic particles per total weight of the first phase.

In fact, a preferred ink composition according to the second aspect, i.e. being an emulsion, and comprising 50% by volume of the second phase (oil phase) per total volume of the ink composition preferably comprises between 30% by weight to 71% by weight of ceria per total weight of the ink composition, more preferably between 55% by weight to 68% by weight of ceria per total weight of the ink composition, and particularly between 60% by weight to 65% by weight of ceria per total weight of the ink composition.

It should be noted that the ink composition may comprise different amounts of the second phase per total volume of the ink composition, such as 10% by volume, 20% by volume, 30% by volume, 40% by volume, 50% by volume, 60% by volume, 70% by volume or 80% by volume of the second phase (oil phase) per total volume of the ink composition, and wherein a relative amount of the inorganic particles such as of ceria preferably increases with decreasing amount of the second phase and vice versa.

For instance, an ink composition according to the second aspect and comprising 10% by volume of the second phase (oil phase) per total volume of the ink composition preferably comprises between 42% by weight to 83% by weight of ceria per total weight of the ink composition, more preferably between 68% by weight to 81% by weight of ceria per total weight of the ink composition, and particularly preferably between 73% by weight to 78% by weight of ceria per total weight of the ink composition.

An ink composition according to the second aspect and comprising 80% by volume of the second phase (oil phase) per total volume of the ink composition preferably comprises between 16% by weight to 48% by weight of ceria per total weight of the ink composition, more preferably between 33% by weight to 45% by weight of ceria per total weight of the ink composition, and particularly preferably between 37% by weight to 42% by weight of ceria per total weight of the ink composition.

The ink composition according to any aspect preferably further comprises at least one rheology modifier. The rheology modifier preferably is provided in the first phase and/or in a second phase, if applicable.

The rheology modifier preferably is a terpene such as limonene, cellulose or a cellulose derivative such as carboxymethylcellulose, hydroxyethyl cellulose, cellulose crystals, cellulose fibers, a polysaccharide such as starch, or an alkali swellable emulsion such as carboxyl-containing acrylic polymers and copolymers.

An amount of the rheology modifier preferably is between 0.1% by weight to 5% by weight of the rheology modifier per total weight of the ink composition, more preferably between 0.25% by weight to 2% by weight of the rheology modifier per total weight of the ink composition, and particularly preferably between 0.5% by weight to 1.5% by weight of the rheology modifier per total weight of the ink composition.

A viscosity of the ink composition according to any aspect preferably is in the range of 10² Pa to 10⁶ Pa with a shear rate in the range of 10⁻³ 1/s to 10 1/s and at room temperature.

In the event that the ink composition is a suspension and the inorganic particles are ceria, it is preferred that a pH value of the ink composition is 3 or higher if the suspension comprises anionic dispersing agents and/or that a pH value of the ink composition is different than 6 in the absence of dispersing agents.

In the event that the ink composition is an emulsion or a wet foam, it is preferred that a pH value of the ink composition essentially corresponds to the acid dissociation constant, pKa, of the particle surface modifier or preferably to a pH value between pKa±1. Additionally or alternatively, a pH value of the ink composition being an emulsion or a wet foam preferably is in the range of 2 to 6, more preferably 3 to 5, most preferably 3.5 to 4.5.

In any case, it is furthermore preferred that the ink composition comprises at least one pH-adjusting agent such as an acid, preferably hydrochloric acid, and/or a base, such as NaOH.

Moreover, if ceria is used as inorganic particles, a density of the ink composition preferably is in the range of 1.6 g/cm³ to 4.7 g/cm³, preferably in the range of 2.8 g/cm³ to 4.4 g/cm³, and particularly preferably in the range of 3.8 g/cm³ to 4.1 g/cm³.

In a further aspect, a method of producing the ink composition as described above is provided. The method comprises the steps of distributing the inorganic particles and dissolving the organic processing additive in a liquid solution in order to form the first phase.

Any explanations made herein regarding the ink composition per se likewise apply to the method of producing the ink composition and vice versa.

In the event that the ink composition is a suspension, it is preferred to generate the first phase by dissolving the organic processing additive and preferably also the dispersing agent in a liquid solution in a first step and by thereafter distributing the inorganic particles in a subsequent second step. As mentioned earlier, in the event that the ink composition is a suspension it is furthermore preferred that the organic processing additive is a thermoresponsive material. Hence, after generating the first phase it is preferred to cool the first phase so as to form a slurry below the transition temperature of the thermoresponsive material, if the thermoresponsive material is for example a LCST polymer. For instance, the first phase is preferably cooled to a temperature in the range of 0° C. to 23° C., more preferably in the range of 2° C. to 18° C., particularly preferably in the range of 4° C. to 8° C. Additionally or alternatively it is preferred to cool the first phase during a time period in the range of 1 minute to 2 days, more preferably in the range of 2 minutes to 2 hours, and particularly preferably during 5 minutes to 30 minutes.

In the event that the ink composition is an emulsion, it is preferred to generate the first phase by distributing the inorganic particles in a liquid solution in a first step and by thereafter dissolving the organic processing additive, which is in this case preferably a particle surface modifier and/or a surface active additive, in a subsequent second step. It is particularly preferred to add a surface active additive firstly and to add a particle surface modifier subsequently. However, it is likewise preferred to add the particle surface modifier firstly and to then add the surface active additive subsequently or to add them simultaneously. In a subsequent third step, it is preferred to disperse the second phase in the form of the oil phase in the first phase. For instance, a surface active additive in the form of a PVA solution could be added to the first phase, then a particle surface modifier in the form of propionic acid could be added to the first phase comprising the inorganic particles and the PVA solution, and lastly the oil phase could be generated by dispersing the oil phase in the first phase.

In the event that the ink composition is a wet foam, it is preferred to generate the first phase by distributing the inorganic particles in a liquid solution in a first step and by thereafter dissolving the organic processing additive, which is in this case preferably a particle surface modifier and/or a surface active additive, in a subsequent second step. Also in this case it is particularly preferred to add both, a particle surface modifier and a surface active additive, wherein the surface active additive is preferably added before the particle surface modifier is added. However, here too it is likewise preferred to add the particle surface modifier firstly and to then add the surface active additive subsequently or to add them simultaneously. In a subsequent third step, it is preferred to disperse the second phase in the form of a gaseous phase in the first phase. For instance, a surface active additive in the form of a PVA solution could be added to the first phase, then a particle surface modifier in the form of valeric acid could be added to the first phase comprising the inorganic particles and the PVA solution, and thereafter the gaseous phase could be generated by dispersing the gaseous phase in the first phase.

In another aspect, the ink composition as described above and/or as produced in the method as described above is used for additive manufacturing preferably a structure for use in a thermochemical fuel production process and/or in a heat transfer application.

It should be noted that any explanations made herein regarding the ink composition per se or the method of producing the ink composition likewise apply to the use of said ink composition and vice versa.

In another aspect, a method of additive manufacturing a structure for use in a thermochemical fuel production process is provided. The method comprises the steps of i) providing the ink composition as described above and/or as produced above, ii) depositing the ink composition so as to form a precursor structure, and iii) subjecting the precursor structure to at least one thermal treatment so as to form the structure for use in the thermochemical fuel production process. The thermal treatment preferably comprises at least a drying step and/or a calcination and/or a sintering step.

In another aspect, a method of additive manufacturing a structure for use in a heat transfer application is provided. The method comprises the steps of i) providing the ink composition as described above and/or as produced above, ii) depositing the ink composition so as to form a precursor structure, and iii) subjecting the precursor structure to at least one thermal treatment so as to form the structure for use in the heat transfer application. The thermal treatment preferably comprises at least a drying step and/or a calcination and/or a sintering step.

That is to say, the present invention allows the manufacturing of structures from the ink compositions that find different applications, in particular in thermochemical fuel production processes and in heat transfer applications.

It should be noted that any explanations made herein regarding the ink composition per se or the method of producing the ink composition or the use of the ink composition likewise apply to the method of additive manufacturing the structure using the ink composition and vice versa. Moreover, explanations made herein regarding the manufacturing of the structure for use in the heat transfer application preferably likewise apply to the manufacturing of the structure for use in a thermochemical fuel production process and vice versa.

The method of additive manufacturing preferably is direct ink writing.

The deposition of the ink composition preferably corresponds to an extrusion of the ink composition. The ink composition is preferably extruded while a pressure in the range of 0.1 bar to 5 bar, more preferably in the range of 0.5 bar to 2 bar is applied. The ink composition is preferably extruded while being moved at a speed in the range of 1 mm/s to 50 mm/s, more preferably in the range of 4 mm/s to 20 mm/s, particularly preferably in the range of 6 mm/s to 16 mm/s. The ink composition is preferably extruded at a constant extrusion rate and/or at an extrusion rate in the range of 10 μl/min to 1000 μl/min, preferably in the range of 20 μl/min to 400 μl/min, and particularly preferably in the range of 50 μl/min to 200 μl/min.

The ink composition is preferably extruded from a nozzle and/or while rotating an extrusion screw. The nozzle preferably has a nozzle diameter in the range of 0.1 millimeter to 10 millimeter, more preferably in the range of 0.2 millimeter to 2 millimeter, and particularly preferably in the range of 0.4 millimeter to 0.8 millimeter.

In the drying step, the precursor structure is preferably dried at a drying temperature in the range of 1° C. to 150° C. and/or during a drying period in the range of 10 minutes to 30 days, preferably at a drying temperature in the range of 15° C. to 100° C. and/or during a drying period in the range of 30 minutes to 5 days, and particularly preferably at a drying temperature in the range of 20° C. to 80° C. and/or during a drying period in the range of 1 hour to 1 day.

In the calcination step, the precursor structure is preferably calcined at a calcination temperature in the range of 150° C. to 1000° C. and/or during a calcination period in the range of 10 minutes to 1 day, preferably at a calcination temperature in the range of 200° C. to 800° C. and/or during a calcination period in the range of 30 minutes to 12 hours, and particularly preferably at a calcination temperature in the range of 250° C. to 650° C. and/or during a calcination period in the range of 1 hour to 5 hours.

In the sintering step, the precursor structure is preferably sintered at a sintering temperature in the range of 1100° C. to 1900° C. and/or during a sintering period in the range of 10 minutes to 5 days, preferably at a sintering temperature in the range of 1300° C. to 1800° C. and/or during a sintering period in the range of 30 minutes to 24 hours, and particularly preferably at a sintering temperature in the range of 1500° C. to 1700° C. and/or during a sintering period in the range of 1 hour to 10 hours.

The precursor structure is preferably heated during the thermal treatment at a heating rate in the range of 0.1° C./min to 20° C./min, preferably in the range of 0.5° C./min to 10° C./min, and particularly preferably in the range of 1° C./min to 4° C./min.

The structure is preferably cooled after the thermal treatment at a cooling rate in the range of 0.1° C./min to 20° C./min, preferably in the range of 0.5° C./min to 10° C./min, and particularly preferably in the range of 1° C./min to 4° C./min.

The precursor structure, while being formed by the deposition of the ink composition, is preferably at least partially dried. That is, it is preferred that the precursor structure is allowed to at least partially dry while being formed. The above described thermal treatment is preferably performed in addition to said at least partial drying of the precursor structure and preferably after the precursor structure has been allowed to at least partially dry. A partial drying during printing increases the stiffness of the deposited filament, thereby allowing the structure to withstand gravitational forces without undesired distortion. This enables printing of tall structures, which is specially challenging in the case of oxides with high specific gravity like ceria.

It is furthermore preferred that a coating is applied on the structure, preferably after the calcination and sintering steps, and wherein the coating preferably is a suspension comprising inorganic particles being redox reactive such as ceria (CeO₂).

In other words, the precursor structure is preferably coated with at least one coating. The coating is preferably applied to the precursor structure under vacuum. That is, it is preferred that the precursor structure is vacuum coated. Said coating serves the purpose of eliminating any existing imperfections caused by the additive manufacturing. While being applied to the precursor structure, the coating preferably corresponds to a suspension comprising inorganic particles being redox reactive. Moreover, the coated precursor structure is preferably subjected to at least one thermal treatment, wherein the thermal treatment preferably comprises at least one drying step and/or calcination step and/or sintering step.

Said inorganic particles can be the same or different from the inorganic particles of the ink composition.

The suspension preferably comprises at least one solvent and suspended inorganic particles. The solvent preferably is demineralized water. That is, the suspension preferably is an aqueous solution comprising suspended inorganic particles. However, other solvents are likewise conceivable, for instance decane, octane, butyl acetate.

The suspension preferably comprises inorganic particles of different average sizes. In particular, it is preferred that the suspension comprises at least a first set of inorganic particles having a first average size and a second set of particles having a second average size being smaller or larger than the first average size. For instance, the first average size could be in the micrometer range, for example between 1 micrometer to 100 micrometer, and the second average size could be in the nanometer range, for example between 1 nanometer and 100 nanometer. However, it should be noted that inorganic particles of a same average size are likewise conceivable.

Moreover, the first and second set of inorganic particles can be the same or different from one another. For example, the suspension could comprise first and second sets of inorganic particles both being cerium oxide (CeO₂). Moreover, these first and second set of same inorganic particles preferably have different average sizes, for example the first set of cerium oxide having an average size of about 5 micrometer and the second set of cerium oxide having an average size of about 10 nanometer. Alternatively, the suspension could comprise a first set of inorganic particles being cerium oxide (CeO₂) and a second set of inorganic particles being another metal oxide such as stannic oxide (SnO₂). It goes without saying that any other types of inorganic particles are likewise conceivable.

The suspension preferably comprise a larger amount of inorganic particles having a larger average size than of inorganic particles having a smaller average size. For example, the larger inorganic particles and the smaller inorganic particles may be present in a ratio of 1.5:1 to 3.5:1, in particular in a ratio of about 2.5:1.

The suspension preferably furthermore comprises at least one pore former that is configured to form pores, preferably micron-sized pores in the structure. Said pore former preferably comprises or consists of carbon fibers, although other pore formers being capable of forming pores in the structure are likewise conceivable. An example of a conceivable pore former are short carbon fibers such as SIGRAFIL® C UN from the company SGL Group.

The suspension preferably furthermore comprises at least one dispersing agent. A conceivable dispersing agent is a polyelectrolytic dispersing agent such as an anionic polyelectrolyte dispersing agent, and particularly preferably a salt of a carboxylic acid or a polymer thereof such as an ammonium salt of a polycarboxylic acid, for example Dolapix CE64.

The suspension preferably has a viscosity being lower than 100 Pa·s.

To this end it is particularly preferred that the precursor structure is infiltrated with the suspension while the precursor structure is arranged within a vacuum chamber, for instance in a vacuum desiccator or the like. Once the precursor structure is fully covered in the suspension, the vacuum chamber is preferably re-pressurized to ambient and the precursor structure is left to impregnate. The precursor structure is preferably impregnated for 5 minutes or more, preferably for 10 minutes or more such as for 15 minutes.

After being impregnated the precursor structure is preferably dried. The precursor structure is preferably dried for 1 hour or more such as for about 2 hours and/or at a temperature of 50° C. or more such as about 90° C. Before drying the precursor structure it is preferred that the precursor structure is cleared off from any excess suspension.

After being dried the precursor structure is preferably sintered, in addition to the sintering step applied before coating as described earlier. It is conceivable to pre-sinter the precursor structure at a temperature being between the drying temperature and the final sintering temperature.

Hence, the ink composition according to the invention is formulated to prevent rapid drying, enabling direct printing in air without clogging issues. To reduce drying speed and reach the rheological properties required for printing via Direct Ink Writing, see further below, the ink composition according to the invention uses organic processing additives that are completely removed from the printed structure during a thermal treatment the printed structure is subjected to. In particular, and as will be outlined below, the 3D printing of the ink composition according to the invention allows the generation of large monoliths comprising inorganic redox reactive particles with thin walls and graded porous architecture that significantly enhance the throughput of solar-driven thermochemical reactions.

In another aspect, a structure for use in a thermochemical fuel production process being produced in the method as described above is provided. Said structure has an open-cell void phase and a solid phase, and wherein the structure has an effective porosity, defined as the ratio of a volume of the void phase to a total volume of the structure, being lower than 0.9, preferably being lower than 0.75, and wherein the structure when exposed to a radiative flux of at least 1300 kilowatts per square meter reaches a temperature at which the inorganic particles undergo a reduction and exhibits a temperature gradient of maximal 200 degrees Celsius per centimeter of the structure along one or more directions of the structure.

The temperature at which the inorganic particles undergo a reduction depends on the inorganic particles being used. For instance, for typical operating conditions of the redox cycle for nonstoichiometric ceria CeO_{2-δ}, i.e. the reduction step at 1500° C. and 0.1 mbar and the oxidation step at 900° C. and 1 bar, thermodynamic predicts Δδ=0.04.

A relationship between the effective porosity and the relative density of the structure is defined as follows:

$$effective porosity = 1 - relative density .$$

The solid phase of the structure preferably comprises or consists of the inorganic particles. The solid phase consisting of inorganic particles means that the structure consists of the inorganic particles. That is, the invention allows the manufacturing of a structure that comprises 100% by weight of inorganic particles per total weight of the structure. For instance, in the event of the inorganic particles being cerium oxide a structure comprising 100% by weight of cerium oxide per total weight of the structure can be manufactured.

Moreover, the effective porosity of the structure preferably decreases along a path of radiation being incident on the structure.

The structure preferably has an extinction coefficient for solar or infrared radiation, and wherein the extinction coefficient increases along a path of radiation being incident on the structure.

Moreover, it is preferred that the structure is reticulated. Alternatively, it is likewise preferred that the structure is hierarchically ordered. In the latter case, it is furthermore preferred that the structure comprises channels having a cross section per channel that decreases along a path of radiation being incident on the structure. The channels can have any shape. For instance, the channels can be rectangular channels or square channels, etc.

The structure preferably further comprises at least one coating, wherein the coating comprises the inorganic particles. Said coating is preferably formed from the suspension comprising the inorganic particles as described earlier and reference is therefore made to the above explanations.

In another aspect, a method of producing a fuel in a thermochemical fuel production process is provided. The method comprises the steps of i) providing a structure being produced in the method of additive manufacturing a structure for use in a thermochemical fuel production process as described above, ii) irradiating the structure with radiation, preferably solar radiation, wherein the structure absorbs the radiation and is reduced, and iii) subjecting the reduced structure to at least one reacting gas and oxidizing the reduced structure, whereby the reacting gas is reduced and is converted to the fuel.

For example, the reacting gases could be carbon dioxide (CO₂) and water (H₂O) that are reduced, resulting in a mixture of carbon monoxide (CO) and molecular hydrogen (H₂) also known as syngas. To enable said thermochemical conversion the structure, for instance ceria, is first reduced and subsequently oxidized again to complete a full redox cycle. During reduction, oxygen atoms from ceria are released as a gas, leading to the formation of oxygen vacancies in the solid lattice. In the oxidation step, these vacancies take up oxygen atoms from the injected CO₂ and H₂O molecules, resulting in the mixture of CO and H₂, i.e. in the formation of the fuel. That is, the structure according to the invention enables the production of a fuel such as syngas by the thermochemical splitting of water and carbon dioxide using concentrated solar energy.

It should be noted that various reacting gases can be used and converted into fuel.

Hence, the present invention allows to 3D print structures comprising redox reactive inorganic particles such as ceria structures with a graded architecture that are designed to enhance solar-to-fuel conversion by increasing radiative heat transfer through the reactor without significantly compromising the surface area available for the redox reactions. In particular, the present invention enables the production of structures that exhibit both reasonable high effective densities and volumetric absorption, and therefore have the potential to yield high values of fuel output per unit of volume.

In another aspect, a method of heating a heat transfer fluid in a heat transfer application is provided. The method comprises the steps of i) providing a structure being produced in the method of additive manufacturing a structure for use in a heat transfer application as described above, ii) providing at least one heat transfer fluid that flows across the structure, and iii) irradiating the structure with radiation, preferably solar radiation, wherein the structure absorbs the radiation and transfers the thus converted heat by convection and radiation to the heat transfer fluid, whereby the heat transfer fluid is heated.

That is, the present invention furthermore allows to 3D print structures that can be used in heat transfer applications in order to heat a heat transfer fluid. Various heat transfer fluids are conceivable and well-known in the art. For instance, the heat transfer fluid can be a reactant fluid that undergoes a chemical reaction and/or a chemical transformation when being heated. The heat transfer fluid can likewise constitute a heat transfer fluid in a thermochemical process, the thermochemical process preferably being an endothermic step in the production of fuels, cement, metals, or metallic compounds or the like. Another example concerns a heat transfer fluid being a working fluid for a heat engine, etc.

The heat transfer fluid is heated by heat being converted by the structure upon its irradiation with radiation when the heat transfer fluid flows across the structure. The radiation preferably corresponds to solar radiation. As such, the structure can be provided in a solar receiver. Moreover, the structure can be used as a solid absorber of a solar receive, and wherein said solar receiver is preferably part of an industrial system such as a heat engine or a chemical reactor, for instance.

In another aspect, a method of heating a structure in a heat transfer application is provided. The method comprises the steps of i) providing a structure being produced in the method of additive manufacturing a structure for use in a heat transfer application as described above, and ii) providing at least one heat transfer fluid that flows across the structure to transfer heat by convection and radiation to the structure, whereby the structure is heated.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a design of a graded macroporous ceramic structure for use in a thermochemical fuel production process that has been produced according to the method of the invention. The rectangular cuboid part of the structure is comprised of four different sections with equal height and different macroporosity levels. Section 1 is closest to the irradiating source and exhibits the highest macroporosity. Macroporosity decreases gradually from section 1 to 4.

FIG. 2a shows a temperature profile used for calcination of the structure according to the invention;

FIG. 2b shows a temperature profile used for sintering of the structure according to the invention;

FIG. 3 shows a digital image of the structure according to the invention after the calcination step (left side) and the sintering step (right side);

FIG. 4a shows a schematic isometric view of a Solar TG;

FIG. 4b shows a cross-sectional view of the Solar TG of FIG. 4a;

FIG. 5 shows temperature profiles along the direction of incident radiation obtained in the Solar-TG experimental runs for two samples: the structure according to the invention (“new sample”) and the reference RPC. The measured data points are marked as “x”; the straight connecting lines are added to aid visualization. Z (x-axis) denotes the distance from the sample's top, exposed to the incident irradiation. Shown are also the top-view photographs of the new sample (top) and of the RPC (bottom);

FIG. 6 shows the main characteristics of ten porous ceria structures;

FIG. 7 shows the temporal variations of the weight of the structure “Medium”, temperatures across the structure, and product gas concentrations (O₂ during the reduction step, CO during the oxidation step) of a representative experimental run with two consecutive redox cycles of the structure “Medium”;

FIG. 8 shows the steady-state temperature profiles across the structure (z=0 is the top face exposed to the incoming radiative flux) during the reduction step for all ten structures;

FIG. 9a-9b show the mass (y-axis) above a temperature level (x-axis) at the end of the reduction step for: a) uniform-porosity structures; b) gradient-porosity structures. Assumptions: (i) a linear interpolation between the measured temperatures (circles), and (ii) constant temperature at equal heights;

FIG. 10 show the total released volume of O₂ (grey) and CO (black) during the reduction and oxidation steps, respectively, for 100 consecutive redox cycles;

FIG. 11a-11f show a characterization of the ceria particles and copolymer solutions used for the preparation of the ink compositions. (a) Zeta potential of ceria particles in water and after the addition of 0.5 wt % of polyacrylic acid salt. In the presence of the polyelectrolyte, the isoelectric point (IEP) is shifted from neutral pH to pH values of 2-3. This leads to a stable particle suspension at neutral pH. (b) Particle size distribution of the ceria powder obtained by dynamic light scattering. (c) Gelation temperature as a function of the concentration of PEO—PPO-PEO copolymer in solution. Data from Gioffredi et al. 33 (d) Storage and loss moduli of a 20 wt % PEO-PPO-PEO aqueous solution as a function of the temperature. (e) Storage and loss moduli and (f) shear strain as a function of the shear stress for a 20 wt % PEO-PPO-PEO aqueous solution with and without limonene oil. In the limonene-containing gel, 10 wt % of the aqueous solution was replaced by the oil;

FIG. 12 show a schematics of the ink preparation workflow;

FIG. 13a-13f show the ink composition rheology and 3D printing of ceria structures. (a) Apparent viscosity as a function of the applied shear rate for a fresh ceria-based ink composition. The ink composition shows the strong shear thinning behaviour that favours successful paste extrusion. (b) Shear measurement performed to determine the shear yield stress of the fresh ink composition (τy=390 Pa). (c) Oscillatory storage (G′) and loss (G″) moduli as a function of the shear stress amplitude for a freshly prepared ink composition and a partially dried ink composition. The yield stress increases with drying-induced removal of the liquid phase. (d) Rheological map displaying the height and normalized spanning length achievable when printing, respectively, profiled objects and grid-like structures from a fresh ink compositing and a partially dried ink composition. Horizontal and vertical lines represent data predicted from simple beam theory and from gravitational arguments, respectively. (e) Digital image illustrating the 3D printing of a profiled object with a height up to 48 mm. (f) Detailed view of the ink deposition process using a nozzle with 0.41 mm inner diameter;

FIG. 14a-14f show calcination and sintering of printed ceria structures. (a) Weight loss and heat flow during heating of a dried ceria structure up to the sintering temperature. (b) Temperature protocol used to sinter the printed ceria structures. Dwell times of 2 h, 2 h and 5 h were applied at 150° C., 600° C. and 1600° C., respectively. (c) Scanning electron micrograph (SEM) of a ceria grid-like structure after sintering. In this exemplary structure, the printing lines have a thickness of 300 μm and the average grain size is 5 μm. (d) Digital image of the samples before and after sintering. (e) Digital images of monoliths with uniform (D1-D4) and graded densities (center). (f) Relative density and surface area of the 5 different structural designs shown in (e);

FIG. 15a-15f show the general concept to enhance a thermochemical reactor performance using hierarchical porous structures. (a) Graded structure illuminated by solar radiation that is concentrated by a primary panel of reflective mirrors and redirected by the secondary reflector. (b) Cartoon providing details of a printed wall showing the macropores incorporated to increase the reactive surface area of the structure. (c) Design of the four layers with distinct line densities (D1-D4) used to build the graded architecture. (d) Expected temperature gradient along different structures, showing that graded architectures should lead to a higher temperature at the bottom of the reactor compared to RPCs. (e) The increase in reactive surface area expected upon the incorporation of macroporosity within the walls of the reactor. (f) The typical tradeoff between light penetration depth, represented by the local temperature, and the specific surface area observed for isotropic RPC structures;

FIG. 16a-16b show the design and preparation of emulsion-based ink compositions. (a) The preparation of the ink composition starts with the mixing of the constituents of the aqueous phase: CeO₂ particles, water, PVA and propionic acid (1). Then, the oil phase is added (2) and emulsification with a mixer is performed (3). The ink composition is loaded in a cartridge (4) and the latter mounted on the printer (5). (b) Schematics illustrating the hierarchical nature of the printed structure. The printed walls contain oil droplets that are stabilized by ceria particles modified with propionic acid. PVA molecules competitively adsorb at the oil-water interface to generate open macropores upon drying and sintering of the structure;

FIG. 17a-17d show the microstructure and porosity of macroporous ceria structures. (a) Electron microscopy images of sintered porous ceria structures with closed and open porosity obtained from emulsions containing different concentrations of PVA and propionic acid. The schematics indicate the closed and open macropores obtained without PVA (left) and with sufficient PVA (right) after sintering, respectively. (b) Macropore size, (c) relative open porosity and (d) total porosity as a function of the PVA content for structures obtained from emulsions with 45 and 52.5 μmol/g propionic acid concentrations;

FIG. 18a-18f show rheology and printability of emulsion-based ceria ink compositions. (a) Shear thinning behavior of emulsions prepared with different PVA concentrations, as shown by the decrease of viscosity η with increasing shear rate \dot{γ}. (b,c) Storage (G′) and loss modulus (G″) of emulsions containing systematically varied concentrations of (b) PVA and (c) propionic acid. These curves were used for the determination of the yield stress τ_{y}. (d,e) Effect of PVA concentration on (d) the storage modulus plateau (G′) and (e) the yield stress (τ_{y}). (f) Formulation map indicating the combinations of PVA and propionic acid concentrations expected to lead to printable (circle symbols) and non-printable emulsions (triangle symbols);

FIG. 19 show photographs of emulsion structures printed from ink compositions with different concentrations of propionic acid and PVA in water;

FIG. 20a-20e show hierarchical porous ceria structures after calcination and sintering. (a) Dimensional comparison between the initial model design of an open-channel structure and its printed version after calcination and sintering. (b) Electron microscopy images of stacked filaments of a printed sintered structure (left), highlighting the open macropores generated by oil droplets within the filament (right). (c) Top view of a sintered graded structure with 4 relative density levels (D1-D4), indicating the presence of open channels at the millimeter range given by the print paths. (d) Linear and volumetric shrinkage, and (e) relative density of a ceria printed graded monolith after drying, calcination and sintering;

FIG. 21a-21c show the effect of the extrusion rate and nozzle diameter on the wall thickness and relative density of porous and dense ceria monoliths. (a) Digital photographs displaying the side and top views of sintered monoliths printed with extrusion rates of 120, 170 and 180 μL/min using nozzle diameters of 410 μm, 610 μm and 610 μm, respectively. (b) Wall thickness and (c) relative density of sintered structures printed with different sets of extrusion rates and nozzle diameter. Results for a dense-walled structure obtained by printing a ceria suspension are also shown for comparison. The used nozzle tip diameter is shown at the top of the plots;

FIG. 22a-22f show mechanical properties and microstructure of grid-like monoliths with dense or porous walls. (a) Typical stress-strain curves obtained from compression tests on grids with porous monoliths prepared from emulsions with 33 and 36 vol % ceria as compared to structures with dense walls. (b,c) Electron microscopy image of a print line of a grid with (b) dense and (c) porous microstructures. (d) Young's modulus (E), (e) compressive strength, and (f) energy absorption of grids with dense and porous microstructures. The modulus was determined by the initial slope of the stress-strain curves, whereas the compressive strength corresponds to the highest recorded stress value. The energy absorbed is obtained by integrating the area under the stress-strain curve. Error bars and average values were calculated based on measurements from 5 specimens;

FIG. 23a-23f show the redox performance of graded ceria monoliths under fast thermal cycling. (a,b) CO gas concentration obtained from the oxidation of ceria and reduction of CO₂ and temperature evolution using graded monoliths with (a) dense or (b) macroporous walls. (c) Normalization of the CO volume evolution per gram of CeO₂ at selected cycle numbers for an emulsion- and a suspension-based monolith. (d) Schematic illustration of the infrared furnace used for the cyclic redox experiments. (e) Digital photograph of a broken monolith with dense walls after 120 cycles in the furnace. (f) Digital photograph of a hierarchical monolith with porous walls after 62 cycles. The structural integrity of the monolith is almost preserved;

FIG. 24a-24c show sintering and characterization of ceria monoliths. (a) Heating and cooling protocols used for the calcination and sintering of the ceria structures. (b) Mass and volume, and (c) absolute density of sintered monoliths printed using different extrusion rates and nozzle diameters (FIG. 21).

### DESCRIPTION OF PREFERRED EMBODIMENTS

With respect to the figures various aspects of the ink composition, its use in the additive manufacturing and the thus produced structure shall be illustrated in greater detail.

In the figures, the following materials were used for the ink composition. The inorganic redox reactive particles were cerium oxide particles with particle size<5 μm and the organic processing additive was Pluronic F-127 (a thermoresponsive triblock copolymer tri-block co-polymer, PEO-PPG-PEO), wherein both the inorganic particles and the organic processing additive were purchased from Sigma-Aldrich. The ink composition furthermore comprised a dispersing agent, namely Dolapix CE 64, a commercial dispersing agent from Zschimmer und Schwarz (Lahnstein, Germany). In addition, limonene was added as a rheology modifier. Limonene is a food grade oil provided by Fluka Chemie AG. Deionized water with an electrical resistance>18.2 MΩ·cm was used.

Herein below a first example of an ink composition according to the invention is given, wherein said ink composition corresponds to a suspension containing 50 vol % (87.80 wt %) of cerium oxide particles. In a first step, a stock solution containing 10 g Pluronic F-127 dissolved in 40 g of deionized water was prepared. Next, 13.97 g of this stock solution (representing 90 wt % of the total liquid content), 0.57 g of Dolapix CE 64 (0.5 wt % based on the solid loading) and 114.08 g of cerium oxide are added to a 250 ml container with two zirconia balls (d=10 mm) to improve mixing and dispersion. The suspension was then mixed for 1.5 min at 2000 rpm in a Thinky Mixer (THINKY U.S.A., INC). Afterwards, the closed container was cooled down in an ice-bath for 30 minutes to minimize evaporation and reduce the viscosity of the slurry. Finally, 1.30 g of limonene (remaining 10 wt % of the total liquid content) was added to the liquified slurry, mixed at 2000 rpm for 1.5 minutes and cooled down in an ice bath for 20 minutes. The obtained ink composition was then inserted into a 30 ml syringe for 3D printing. Throughout the calculations the following densities for the materials were assumed: 1 g/cm³ for the Pluronic water solution, 1.2 g/cm³ for the Dolapix CE 64 and 7.13 g/cm³ for the cerium oxide particles. The final ink composition is summarized in Table 2 reproduced below.

TABLE 2
Composition of suspension-based ink

| | Density | Mass fraction | Volume fraction |
|---|---|---|---|
| Component | [g/cm³] | [wt %] | [vol %] |
| 20 wt % Pluronic in | 1.00 | 10.75 | 43.66 |
| deionized water at | | | |
| neutral pH | | | |
| Limonene | 0.84 | 10.00 (wrt | 6.3 |
| | | liquid content) | |
| Dolapix CE 64 | 1.20 | 0.50 (wrt | |
| | | mass of particles) | |
| Cerium oxide particles | 7.13 | 87.80 | 50 |

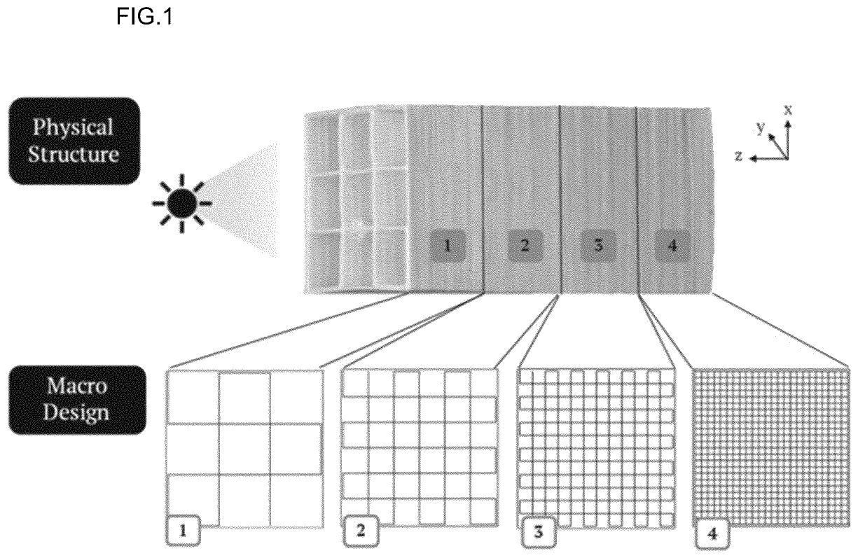

The design of the printed structure corresponds to a structured ceramic part consisting of a graded rectangular cuboid comprised of four different macroporosity levels that are integrated into one single structure. FIG. 1 depicts the graded macroporosity of the cuboid geometry with its subdivisions of the macroporosity levels and their orientation towards the irradiation source. In addition to the graded macroporosity design, the printed ceramic structure contains four cavities to insert thermocouples for temperature measurements at different spatial regions during irradiation in the solar simulator.

For the fabrication of the structured ceramic part by Direct-ink Writing, G code files for the geometry shown in FIG. 1 were created in BioCAD software. The syringes containing the ink compositions comprising cerium oxide particles were installed in an extrusion system (Preeflow eco-PEN, Germany) and printing was performed on a 3D Discovery Printer (RegenHu, Switzerland). Extrusion of the ink composition was ensured by applying pressures between 1 to 2 bar onto the syringe while moving the nozzle at a print speed of 12 mm/s. A constant extrusion rate of 90 μl/min was obtained by using a system comprised of a rotating extrusion screw. Tapered copper nozzles (Micron S, Switzerland) with an inner diameter of 0.44 mm have been used to print the geometry depicted in FIG. 1.

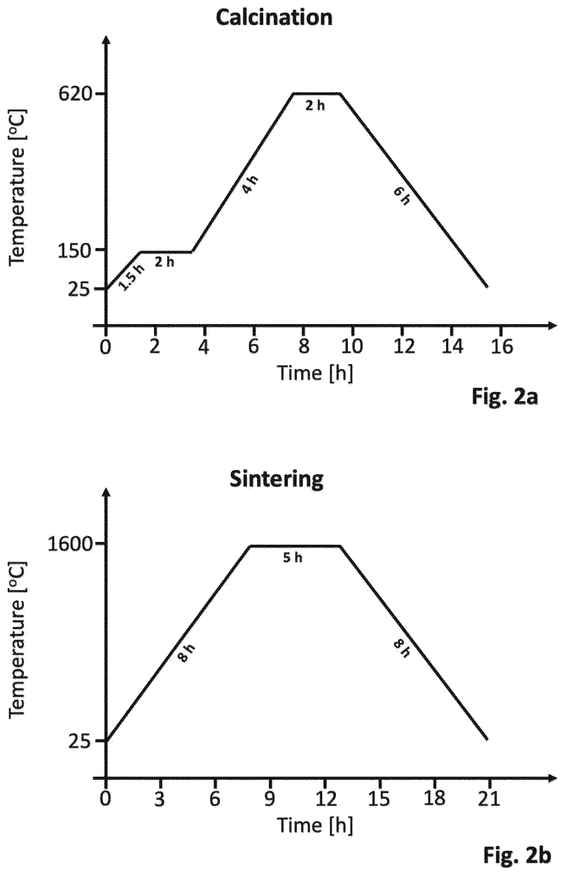

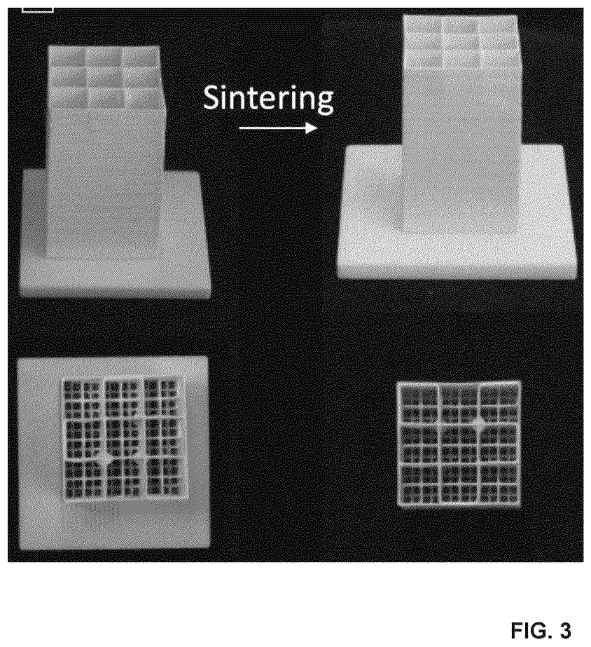

To obtain the final structured ceramic part, the as-printed geometry was subjected to a thermal treatment comprising drying, calcination and sintering steps. Drying was carried out at room temperature for at least 1 day with the printed part still attached to the glass substrate. Next, the sample was removed from the glass substrate and placed on an alumina plate in the oven (Nabertherm LHT 08/18, Germany) for calcination and sintering. In the first heating step, the temperature of the oven was increased to 150° C. with a heating rate of 1.4° C./min. This temperature was kept for 2 h to ensure complete evaporation of the liquid phase. Then, the dried part was subjected to a temperature of 620° C. (heating rate of 2° C./min) for 2 h to remove the organic volatiles. The sample was cooled down to room temperature (cooling rate of 2° C./min) before the sintering step. Finally, the printed parts were sintered at 1600° C. for 5 h and cooled down to room temperature with heating and cooling rates of 3.3° C./min (Nabertherm LHT 08/18, Germany). The temperature profiles used for this step are depicted in FIGS. 2a and 2b. Digital images of the printed geometry were taken after calcination and sintering steps and are shown in FIG. 3.

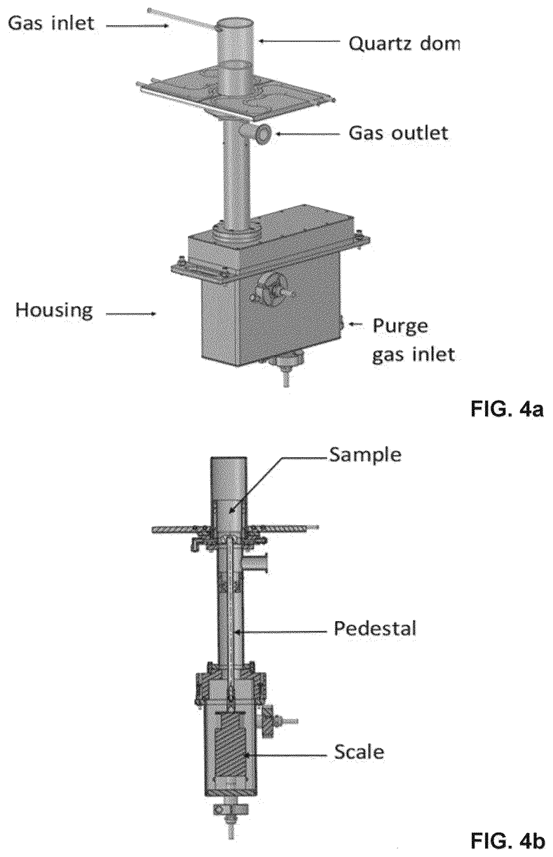

In order to evaluate the redox performance a solar thermogravimetric analyzer, or “Solar TG”, was used. Said Solar TG is an analytical instrument for monitoring the weight and temperature of a sample placed in a controlled atmosphere and exposed to concentrated radiation. The Solar TG is schematically shown in FIGS. 4a and 4b. It consists of a transparent quartz dome, sealed to an Inconel pipe that interconnects the dome to a lower metal housing. Inside the dome, the sample rests on top of an alumina platform. A pedestal transfers the sample's weight from the alumina base to a scale located in the housing. The housing also encloses a pressure transmitter and instrumentation for three platinum shielded type-S thermocouples inserted into the sample. The sample's atmosphere is controlled by mass flow controllers connected to the dome's gas inlet. A gas analyzer is installed downstream of the Solar TG to measure oxygen and syngas (H₂ and/or CO) evolution during the ceria redox reactions. The gas measurements are used to verify the weight changes recorded by the scale.

Experimentation was carried out using the ETH's High-Flux Solar Simulator: an array of high-pressure Xenon arcs, each closed-coupled with truncated ellipsoidal specular reflectors, to provide a source of intense thermal radiation—mostly in the visible and IR spectra—that closely mimics realistic operating conditions and heat transfer characteristics of highly concentrating solar systems. The radiative flux distribution at the sample front was measured optically using a CCD camera focused on a Lambertian target and calibrated with a thermal flux gage. The Solar TG was aligned to a single Xe arc lamp. Three thermocouples were fitted into the sample from the bottom, up to 2.4, 11.8, and 22.0 millimeters measured from the sample's top (FIG. 4a, 4b). The experimental run started by closing the system and purging it with argon. The sample was then heated up by exposing it to concentrated radiation of 400 suns (1 sun equivalent to a radiative flux of 1 kW/m²). After 20 minutes, the radiative flux was ramped up to 1236-1338 suns, quickly raising the sample's temperature above 1300° C., and triggering the ceria reduction and consequent oxygen release. These reduction conditions were kept for 20 minutes, at which point oxygen could no longer be measured at the gas outlet. The radiative flux was then ramped down to 400 suns, and after 20 minutes, the gas flow to the dome was switched to CO₂, initiating the oxidation step. After another 20 minutes, the gas feed to the dome was switched back to argon to purge any remaining gas. At this point, a single redox cycle was completed. A second cycle was performed by repeating these steps. The reduction and oxidation reactions extents were determined by the sample's weight change, which was corrected for buoyancy effects. These values were verified using the gas measurements.

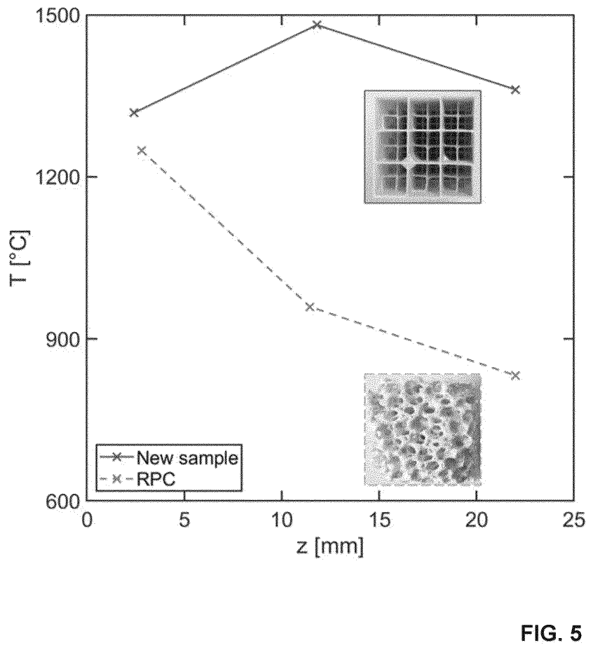

FIG. 5 shows the temperature profiles along the direction of the incoming radiation for the printed graded sample and for the reference RPC, achieved in the Solar-TG experimental runs at the end of the reduction step. Both samples had the exact same total volume. Clearly, the new sample, i.e. the structure according to the invention, exhibited a more uniform temperature profile than that of the RPC. Remarkably, this morphology also achieves a higher overall temperature while increasing the total mass loading within the defined volume. The improved temperature profile and higher overall temperatures are the result of the enhanced volumetric absorption. The gradient morphology changes its optical thickness along the beam path, allowing the incoming radiation to penetrate deeper. As a result, the radiation is better absorbed within the volume, and the structure's hottest zone is shifted deeper, reducing the re-radiation losses. Consistent with the thermodynamic equilibrium of cerium oxide, the higher temperatures reached across the new sample translated to higher oxygen release and, consequently fuel yield. In terms of total fuel yield, the new sample outperformed the RPC by 138%. In terms of mass-specific fuel production, the new sample also outperformed the RPC by 124%.

In the following two further examples for an ink composition according to the invention are given.

Namely, the second example corresponds to an ink composition in the form of an emulsion, wherein a suspension was prepared consisting of 35.65 g of cerium oxide particles, a variable amount (up to a maximum of 10 g) of water and 280 μL of a 1M HCl solution to adjust the pH to a value of approximately 4 for optimal dispersion. The suspension was mixed for 1 min at 2000 rpm in a Thinky Mixer with the help of two zirconia balls (diameter of 15 mm). Then the remaining amount of liquid phase to reach 10 g was added in form of a 5 wt % PVA in water solution and mixed for further 30 seconds at 2000 rpm was performed. For emulsification, a metallic beater from a household kitchen mixer was used. Firstly, the suspension was mixed at 200 rpm and an amount between 100-160 μL (0.037-0.060 mmol/g of CeO₂ particles) of propionic acid was added dropwise to the suspension to prevent rapid particle agglomeration. Then the same amount in volume of decane was added and the mixing speed was increased to 700 rpm and hold for 2 minutes. The obtained ink composition was filled in cartridges and centrifuged for 30 seconds at 1500 rpm. The final ink composition is summarized in Table 3.

TABLE 3
Composition of the emulsion-based ink

| | Density | Mass fraction | Volume fraction |
|---|---|---|---|
| Component | [g/cm³] | [wt %] | [vol %] |
| Water | 1.00 | 17.36 | 32.54 |
| 1M HCl | 1.00 | 0.49 | 0.92 |
| PVA | 1.00 | 0.18 | 0.33 |
| Cerium oxide particles | 7.13 | 62.52 | 16.44 |
| Propionic acid | 0.99 | 0.25 | 0.46 |
| Decane | 0.73 | 19.20 | 49.31 |

The third example concerns an ink composition in the form of a wet foam, wherein a suspension comprising 76.3 wt % of cerium oxide particles, 22.9 wt % of water and 0.11 wt % of PVA was prepared. The pH was set to a value of approximately 4 with the addition of HCl. The suspension was mixed for 1 min at 2000 rpm in a Thinky Mixer with the help of two zirconia balls. For foaming, a metallic beater from a household kitchen mixer was used. An amount of valeric acid between 0.50-0.55 μL/g of CeO₂ particles was added to the suspension (most broad range: 0.05-50 μL/g, broad range: 0.1-2 μL/g). The obtained ink composition was filled in cartridges. The final ink composition is summarized in Table 4.

TABLE 4
Composition of the foam-based ink.

| | Density | Mass fraction | Volume fraction |
|---|---|---|---|
| Component | [g/cm³] | [wt %] | [vol %] |
| Water | 1.00 | 22.90 | 66.60 |
| 1M HCl | 1.00 | 0.63 | 1.83 |
| PVA | 1.00 | 0.11 | 0.33 |
| Cerium oxide particles | 7.13 | 76.32 | 31.13 |
| Valeric acid | 0.93 | 10.04 | 0.11 |

In order to eliminate any existing imperfections caused by the printing a vacuum coating and infiltration is performed on the DIW structures. The coating is formed from a low-viscosity ceria slurry using 350 g of CeO₂, of which 100 g are nanoparticles of 10 nm average particle size. The ceria is mixed with 32.2 g of the pore former carbon pore and added to 175 g of demineralized water and 3.5 g of the dispersing agent Dolapix CE 64.

TABLE 5
Low-viscosity ceria slurry composition.

| Component | Quantity | |
|---|---|---|
| Cerium oxide (5 μm avg. particle size) | 250 | g |
| Cerium oxide (10 nm avg. particle size) | 100 | g |
| Carbon pore former (SIGRAFIL C UN) | 32.2 | g |
| Demineralized water | 175 | g |
| Dolapix CE 64 | 3.5 | g |

The coating process is performed in a vacuum desiccator, evacuated with a vacuum membrane pump to approximately 50 mbar absolute pressure. At the top of the desiccator, a plastic tube connects to a beaker containing the low-viscosity ceria slurry. This tube has a valve to pour the slurry onto the structure once the vacuum is reached. Once the structure is fully covered in slurry, the desiccator is re-pressurized to ambient, and the structure is left to impregnate for 15 mins. Any excess slurry is shaken off or gently removed with compressed air. After the structure has been cleared of excess slurry, it is dried for two hours in an oven at 90° C. Finally, the structure is sintered at 1600° C. (heat-up ramp of 1 to 2° C./min) for 8 hours. Since presintering occurs at lower temperature than sintering, the pores shrink less and the slurry will have better infiltration.

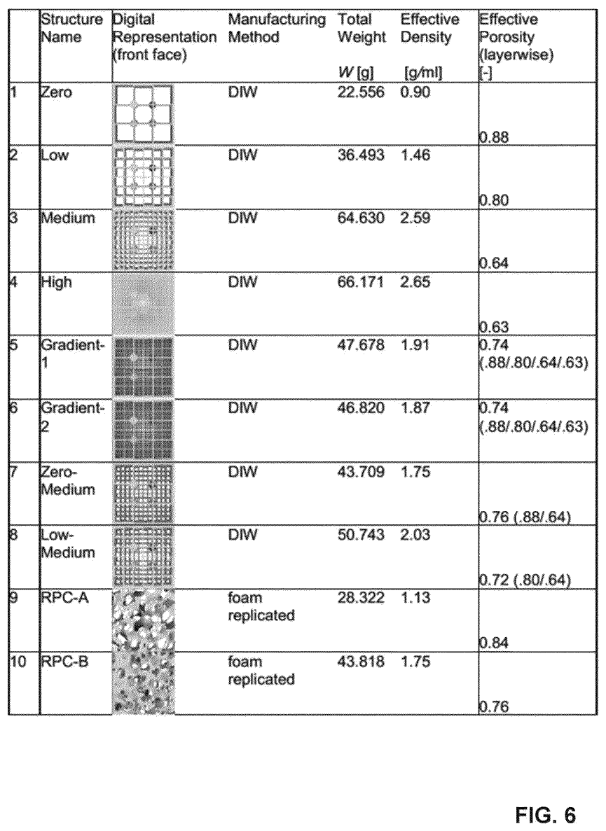

With reference to FIGS. 6 to 10 further structures according to the invention are discussed in greater detail. All printed structures had constant outer dimensions (25×25×40 mm) and were made from stacked square grids forming channeled structures. Four constant-channeled structures were printed with grids of increasing mesh densities: “Zero,” “Low,” “Medium,” and “High”. Additionally, three structures were printed combining different grids: “Zero-Med” (top half with the “Zero” grid and bottom half with the “Medium” grid); “Low-Med” (top half with the “Low” grid and bottom half with the “Medium” grid), and “Gradient,” (combining the four aforementioned grids). In addition, two 10-ppi (pores per inch) ceria RPCs were manufactured with suspensions containing 30% v/v cylindrical pore formers by the foam replicated method using centrifugal coating. Every structure included four conduits of different lengths to serve as tubular radiative shields for inserting thermocouples. FIG. 6 lists the main characteristics of each structure.

Two experimental setups were employed to assess the redox performance of the printed ceria structures: 1) the solar thermogravimeter analyzer (solar-TGA), and 2) the infrared (IR) furnace. The solar-TGA is a specially designed experimental platform for monitoring the weight change of the structure directly exposed to high-flux irradiation. The solar TG was mounted at the focus of the ETH's High-Flux Solar Simulator (HFSS) to provide a source of intense thermal radiation mimicking the radiative heat transfer characteristics of highly concentrating solar systems and enabling realistic operating conditions occurring in a solar reactor. The IR furnace was used to evaluate the thermomechanical and chemical stability of structures by performing multiple consecutive redox cycles with rapid heating and cooling between the redox steps.

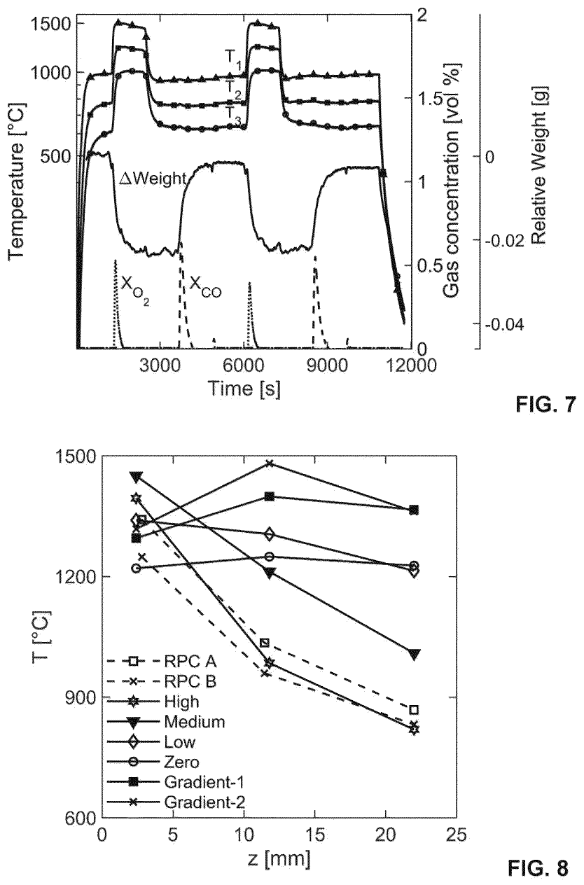

A total of 10 experimental runs were performed in the solar TG, one for each of the ten ceria structures of FIG. 6. Each run consisted of two consecutive redox cycles. FIG. 7 shows a representative experimental run displaying the temporal variations of the structure's weight, temperatures across the structure, and product gas concentrations (O₂ during the reduction step, CO during the oxidation step) for the structure “Medium”. Table 6 summarizes the operational conditions. Temperatures T1, T2, and T3 were measured at depths Z1=2.4, Z2=11.8, and Z3=22 mm from the top. The experimental run started by pre-heating the structure with an incident radiative flux of 400 suns on the top face for about 20 minutes until approximately steady-state temperatures were achieved (ΔT<2 K/min). The reduction step started by ramping up (1-min ramp) the incident radiative flux to 1290 suns under an Ar flow of 0.5 Ln/m (Ln denotes normal liters), resulting in the steep increase of temperatures, which in turn drove the oxygen evolution and consequently the weight drop. The radiative flux was maintained for 20 minutes to allow for the reduction step to be completed and the oxygen concentration XO2 to return to zero (XO2<0.005%). Next, the radiative flux was ramped down (1-minute ramp) back to 400 suns and maintained for 20 minutes until steady-state conditions were reached at the lower temperature level. The oxidation step started by switching the gas flow from Ar to 0.5 Ln/min CO₂, which drove the CO evolution and consequently the weight gain. After 20 minutes, the gas flow was switched back to 0.5 Ln/min Ar for another 20 min to purge the system, completing the cycle. The cycle was then repeated for a second time. The total masses of O₂ and CO released during the reduction and oxidation steps, m_{O2} and m_{CO}, were derived from the structures' weight drop and gain, respectively. The on-line O₂ measurements could only be used qualitatively due to its limited accuracy below 0.6 vol. %, while the integration of the on-line measurement of CO concentration matched m_{CO} within 7%. The molar ratio of n_{CO,ox}/n_{O2,red}=1.9±0.25 (error within the range of the measurement accuracy), indicating total selectivity for the splitting reaction CO₂=CO+½O₂ in two separate streams of CO and O₂. Results for all structures are tabulated in Table 6.

TABLE 6
Operation conditions for the steps in
the redox cycling of ceria structures.

| | | Dome | Housing |
|---|---|---|---|
| | Radiative Flux | gas feed | gas feed |
| Step | [suns] | [Ln/min] | [Ln/min] |
| Pre-heat | 400 | 0.5 Ar | 0.5 Ar |
| Reduction | 1287 | 0.5 Ar | 0.5 Ar |
| Cool-Down | 400 | 0.5 Ar | 0.5 Ar |
| Oxidation | 400 | 0.5 CO2 | 0.5 Ar |
| Purge | 400 | 0.5 Ar | 0.5 Ar |

FIG. 8 shows the steady-state temperature profiles across the structure (z=0 is the top face exposed to the incoming radiative flux) during the reduction step for all ten structures. The non-graded channeled structures “Medium” and “High” and the RPC structures displayed monotonically decreasing temperature profiles with the highest values at the top (front) and lowest values at the bottom (rear). These results are consistent with the expected exponential attenuation of incoming radiation on structures with uniform porosity. As expected, the non-graded channeled structures “Zero” and “Low”, which have a much lower effective density, enabled deeper penetration of incident radiation, thus reaching a more uniform temperature distribution along the structure's depth.

In contrast to the non-graded channeled and RPC structures, the structures with a porosity gradient exhibited higher and more uniform temperature values, with smaller temperature gradients and further deviated from the monotonically decreasing temperature profile. Furthermore, these structures achieved their peak temperatures deeper within the structure, attributed to the volumetric effect, effectively reducing reradiation heat losses and leading to higher overall temperatures. Comparatively, the structure “Zero”, which has a uniform porosity, also achieved a uniform temperature profile thanks to its relatively low optical thickness and reradiation effects, but at a much lower overall temperature level. In terms of the temperature profile, the best performing structure across all ten designs was “Gradient-2”, which reached a peak T=1481° C. and a gradient ΔT=18° C./mm.

TABLE 7
Total O₂ and CO evolutions during the reduction
and oxidation steps of the CO₂-splitting cycle,
respectively, and the molar ratio between them.

| | Cycle | Cycle | Cycle | Cycle | m_{CO, ox}/m_{o2, red} |
|---|---|---|---|---|---|
| | no1 | no2 | no1 | no2 | ratio |
| Structure | m_{o2, red} [mln] | | m_{co, ox} [mln] | | Cycle no2 |
| RPC-A | 8.3 | 6.9 | 5.6 | 7.7 | 1.1 |
| RPC-B | 8.6 | 8.4 | 12.5 | 12.7 | 1.5 |
| High | 12.6 | 12.0 | 21.6 | 23.1 | 1.9 |
| Medium | 16.7 | 13.4 | 26.2 | 25.3 | 1.9 |
| Low | 9.7 | 5.1 | 10.8 | 9.5 | 1.9 |
| Zero | 5.0 | 3.6 | 4.1 | 4.2 | 1.2 |
| Gradient-1 | 20.0 | 15.4 | 28.0 | 29.4 | 1.9 |
| Gradient-2 | 21.8 | 18.8 | 37.8 | 30.2 | 1.6 |
| Zero-Medium | 16.5 | 13.1 | 21.6 | 23.8 | 1.8 |
| Low-Medium | 14.9 | 9.9 | 22.5 | 21.6 | 2.2 |

As expected from the thermodynamics of nonstoichiometric ceria, higher temperatures lead to higher O₂ release during the reduction step and, consequently, higher specific fuel yield per unit volume during the oxidation step. Structures “Gradient-1” and “Gradient-2” released 15.4 and 18.8 mLn O₂, respectively, i.e., more than twice the RPC's average of 7.7 mLₙ O₂. Considering that the RPC-B has a mass comparable to that of the graded structures, this increase is clearly the result of the improved volumetric absorption. The structure “Medium” exhibited the next highest O₂ release despite having a more pronounced temperature gradient. This is mainly due to its high effective density, which makes it the second heaviest structure. Higher mass loading often adversely affects the optical thickness and the potential for volumetric absorption, resulting in portions of ceria not reaching the reduction temperature and thus becoming heat sinks without contribution to fuel generation. This is the case for the uniform-porosity structures “RPC-A”, “RPC-B”, “Zero”, “Low”, “Medium”, and “High”. On the other hand, the gradient-porosity structures “Gradient-1” and “Gradient-2” show the potential of further optimization for maximum mass loading when the optical thickness is changed along the radiation path. These structures have a higher than the RPC ones (FIG. 6) but nevertheless exhibit a higher and more uniform temperature profile.

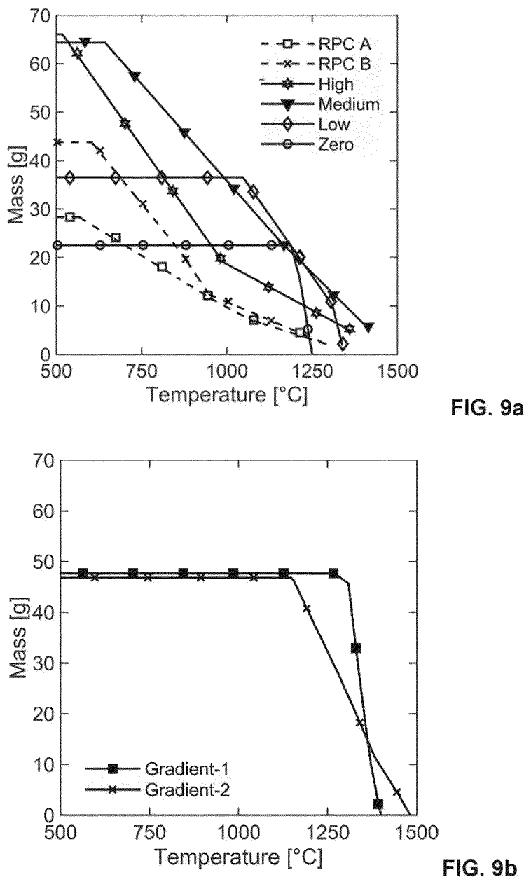

All DIW structures with a porosity gradient produced significantly more CO than the RPC structures due to their higher and improved volumetric absorption. Remarkably, “Gradient-1” and “Gradient-2” produced approximately three times more CO than the RPC-A, having only 67% more mass. They also produced 2.3 times more CO than the RPC-B, with only 8% more mass. The structure “Zero-Medium” produced 1.9 times more CO than the RPC-B, with similar masses. The extent of the volumetric effect can be observed in FIGS. 9a and 9b, which show the amount of mass heated (y-axis) above a temperature level (x-axis) at the end of the reduction step. For example, both RPCs had less than 10 g above 1250° C., in stark contrast to structure “Gradient-1”, which had its total mass (ca.48 g) heated above 1250° C. These results are consistent with a previous modeling study that predicted up to 3.4 times higher O₂ evolution by the porosity-gradient structures compared to that by the uniform-porosity RPC.

Long-term stability tests performed in the IR furnace showed that DIW structures lost mechanical integrity after approximately 30 cycles, where sections detached at the location of cracks already present from the manufacturing process. Vacuum coating of the DIW structures was performed to infiltrate cracks with ceria (details on the vacuum coating are given in the S.I.). Computer tomography and SEM images revealed coating thicknesses of 149±15 μm, which preserved the structure's shape while infiltrating the cracks. Long-term stability was demonstrated for coated DIW structures in 100 consecutive redox cycles without breaking. The total oxygen and CO output decreased by 19-26% over these 100 cycles due to slight degradation of the oxidation's kinetics (details in the S.I.).

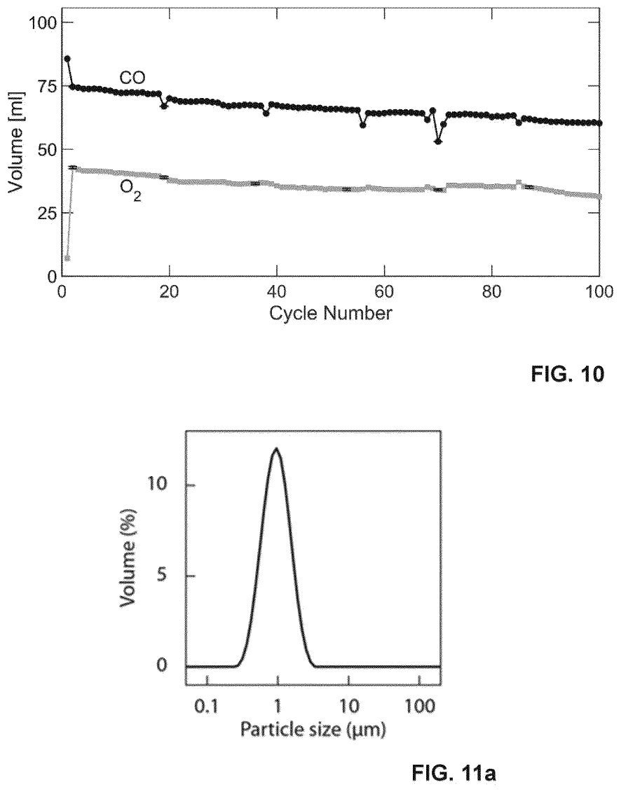

FIG. 10 shows the total released volume of O₂ (grey) and CO (black) during the reduction and oxidation steps, respectively, for 100 consecutive redox cycles with sample 4341 built with grid with the highest effective density “High”. The total oxygen and CO output decreased by 19-26% over these 100 cycles due to slight degradation of the oxidation's kinetics, also manifested by the final coloration of the tested structure. As the chemical stability of ceria has already been extensively demonstrated, the observed degradation suggests changes in the microporosity of the ceria structure, although SEM imaging showed no apparent changes neither in the printed or the coated layers.

To fabricate ceria structures with the proposed graded architecture, we utilize direct ink writing as a versatile extrusion-based approach for room-temperature 3D printing. Direct ink writing of large, crack-free structures requires the development of colloidal pastes featuring high concentration of particles and tailored rheological properties. The high particle concentration is essential to minimize the shrinkage of the as-printed structures and therefore prevent cracking during drying. In terms of rheological properties, the colloidal paste needs to be fluid enough to enable proper extrusion and bonding between printed filaments, while also sufficiently elastic to prevent distortion of the printed structure. This set of properties is often achieved by designing viscoelastic inks that exhibit shear-thinning response, high storage modulus and high yield stress.

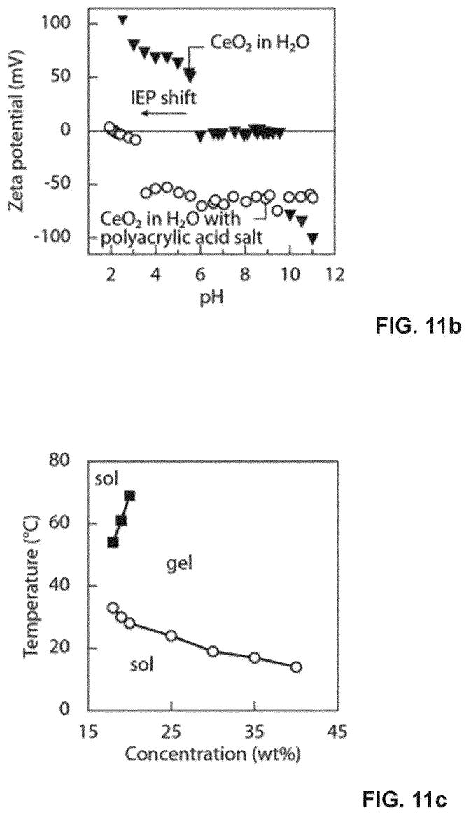

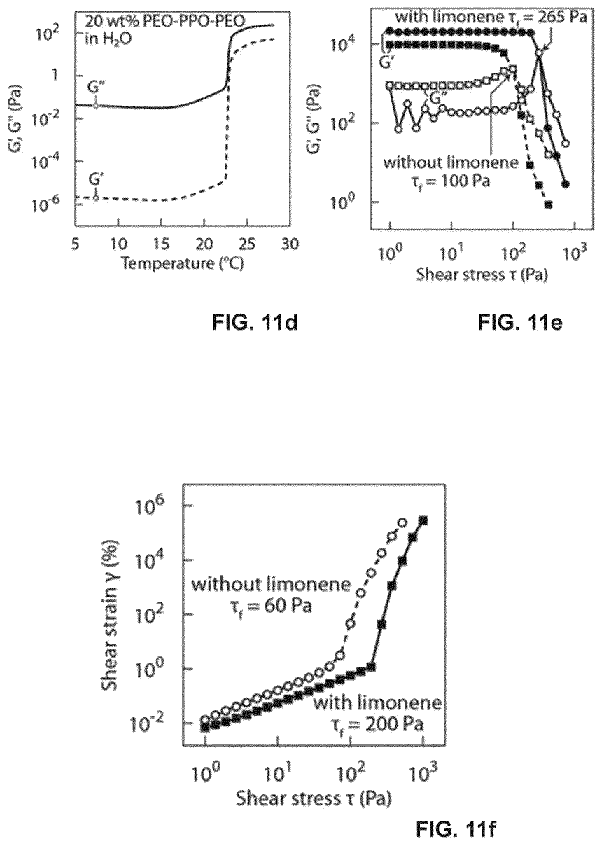

Water-based colloidal suspensions with ceria particle concentrations up to 50 vol % were prepared through an electrosteric stabilization mechanism using a polyacrylic acid salt. The ceria particles display a monomodal size distribution with average size of 1 μm (FIG. 11a). At pHs higher than 3, the polyelectrolyte becomes negatively charged and adsorbs on the surface of the ceria particles to form an electrosteric layer that prevents particle agglomeration. Zeta potential measurements confirmed the adsorption of polyacrylate on the colloid surface and the formation of negatively charged ceria particles at pH values above 3 (FIG. 11b). The repulsive interactions between the electrosterically stabilized particles lead to a shear-thinning suspension with a yield stress of 1-5 Pa, which is insufficient for printing distortion-free objects by direct ink writing.

To imbue the suspension with the viscoelastic properties needed for printing distortion-free structures, we incorporate gel-forming agents in the aqueous phase of the ceria suspension. Because of its well-known gel-forming capabilities in aqueous solutions, a poly(ethylene oxide)-poly(propylene oxide)-poly(ethylene oxide) copolymers (PEO-PPO-PEO, Pluronic) was used to prepare ceria pastes with viscoelastic properties. An attractive feature of aqueous solutions of this copolymer is that it undergoes a sol-gel transition that can be induced by temperature shifts (FIG. 11c). For this particular copolymer, gels are formed upon heating of the solution beyond the sol-gel transition temperature (critical micelle temperature), above which the macromolecules self-assemble into a phase separated percolating network. Such sol-gel transition temperature depends on the concentration of copolymer in solution, which can be tuned to enable the formation of a gel close to room temperature. Oscillatory rheology shows that such a temperature-triggered sol-gel transition increases the storage modulus of PEO-PPO-PEO aqueous solutions by 5 to 6 orders of magnitude (FIG. 11d).

Besides the storage modulus, rheological measurements were also performed to assess the yield stress of PEO-PPO-PEO aqueous solutions in the gelled state. The results indicate that aqueous solutions containing 20 wt % of copolymer exhibit a well-defined yield stress of 60-100 Pa at 25° C. (FIG. 11e,f). Since this value falls within the lower limit of the yield stress level usually required to print distortion-free structures (>100 Pa), we also explored other approaches to further increase the yield stress of the copolymer solutions. The substitution of 10 wt % of the PEO-PPO-PEO aqueous solution with limonene oil was found to be an effective means to increase the yield stress and the storage modulus by a factor of 3 and 2, respectively, of the copolymer gel (FIG. 11e,f). Given the very low solubility of the oil in water, such an effect probably arises from the formation of limonene droplets within the gel, which enhance the interconnectivity and strengthen the copolymer network.

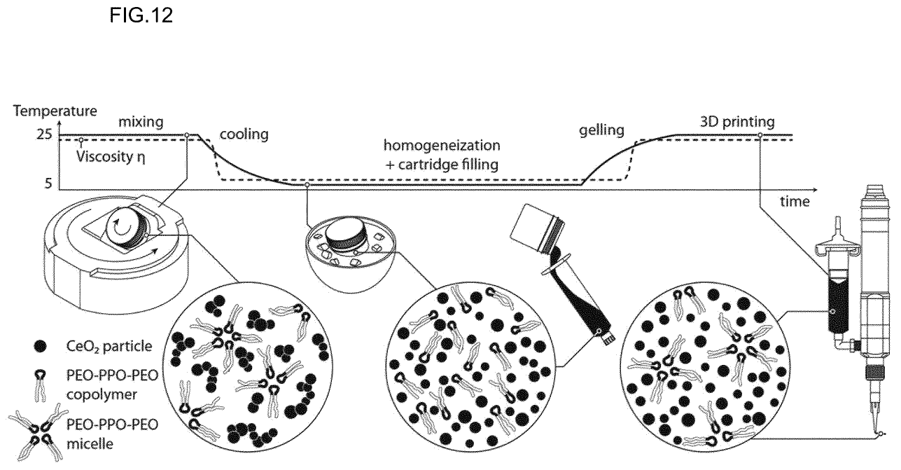

The ability to reversibly switch the limonene-containing copolymer solutions between the sol and gel states via simple heating and cooling makes this colloidal system ideal for the formulation of extrudable ink compositions with a high concentration of particles. Below the critical temperature of 22.5° C., the solution is sufficiently fluid to enable the incorporation of up to 50 vol % of electrosterically stabilized ceria nanoparticles. Above this temperature, the suspension transitions to a gel state with the paste-like behaviour desired for 3D printing via direct ink writing. Based on this knowledge, we developed a protocol in which the ink constituents are added to a planetary mixer and subjected to high-speed mixing and homogenization cycles above and below the critical transition temperature, resulting in highly homogeneous pastes for printing (FIG. 12). That is, the ink constituents are first mixed at room temperature (T) in a laboratory mixer. Then, the ink composition is cooled in an ice bath to reduce its viscosity (η) and favour the breakdown of agglomerated CeO₂ particles. The resulting homogeneous ink composition is afterwards filled in a printing cartridge. Upon heating the cartridge back to room temperature, the PEO-PPO-PEO molecules self-assemble into micelles again, leading to a viscoelastic printable ink composition.

The rheological behaviour of ceria ink compositions with optimum copolymer and limonene concentrations was characterized under steady-shear and oscillatory strains to quantify their shear-thinning response, storage modulus and yield stress under room-temperature printing conditions.

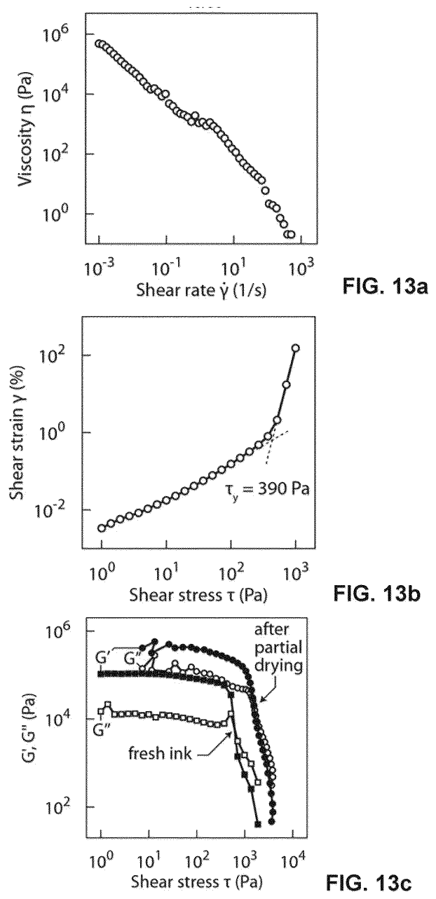

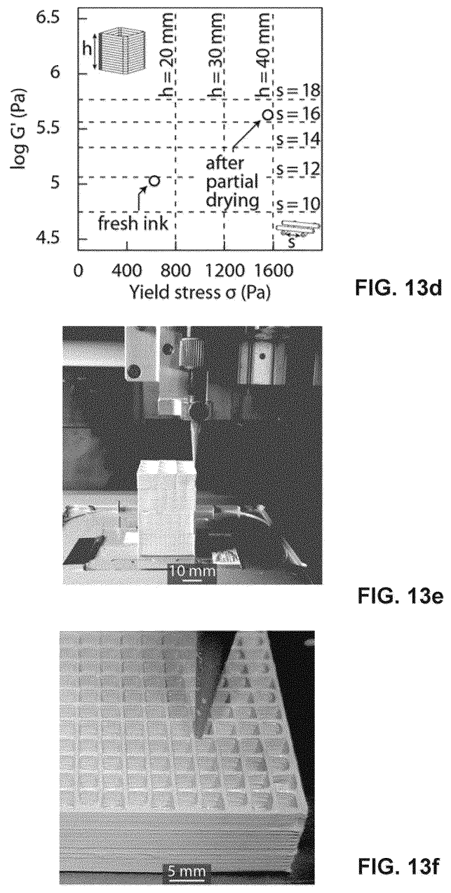

Our experimental results show that the ink composition exhibits a clear viscoelastic response, which can be attributed to the gelation of the copolymer solution at the measuring temperature. This results in a strong shear-thinning behaviour, as evidenced from the decrease in apparent viscosity by 5 orders of magnitude upon an increase in shear rate up to 100 s-1 (FIG. 13a). Stress-strain measurements reveal that the ink composition also features an apparent yield stress of approximately 390 Pa (FIG. 13b), which is in the same order of magnitude of the value obtained for the particle-free copolymer solution (200 Pa). This suggest that the viscoelastic behaviour of the ink composition is dominated by the gel formed by the PEO-PPO-PEO copolymer and limonene droplets. The gel state of the ink composition at room temperature was confirmed by oscillatory shear experiments. Below the yield point, the ink composition behaves like a gel with a high storage modulus of 105 Pa (FIG. 13c). Above this critical stress (625 Pa), the storage modulus drops below the loss modulus, indicating the breakdown of the gel and the fluidification of the ink composition.

By quantifying the rheological properties of the ink composition, we were able to establish guidelines for the direct ink writing of geometries of interest for solar-to-fuel conversion reactors. Structures with grid-like or long profiled architectures are particularly suitable for this application, since they can generate the open macroporosity required for a deeper penetration of solar radiation. To print such structures via direct ink writing, it is crucial to develop ink compositions with storage modulus and yield stress values that are sufficiently high to prevent geometrical distortion of the as-printed material. Because of the high density of ceria particles, gravity was experimentally found to a major cause of distortion of as-printed structures with profiled and grid-like architectures. Other possible failure mechanisms include filament drying, warping, delamination, poor adhesion to substrate, nozzle clogging and buckling.

On the basis of simple beam theory and gravitational arguments, we mapped out the set of storage modulus (G′) and yield stress (σ_{y}) levels required to print distortion-free profiled and grid-like architectures (FIG. 13d). For profiled architectures, the height of the printed object is the limiting factor, since it determines the weight carried by the bottom printed layer. To prevent gravity-induced distortion of the bottom layer, the height of the printed object should be lower than the critical value h=σ_{y}/ρg, where σ_{y} is the yield stress of the ink, p is the density of the ink composition and g is the gravitational acceleration. For grid-like structures, the span length (L) of a filament hanging in air between two underlying print lines is an important geometrical parameter to create open architectures. Earlier work has shown that the span length (L) normalized by the filament diameter (D) depends on the storage modulus of the ink (G′) as follows: s=L/D=[G′/(1.4wD)]^{1/4}, where w is the specific weight of the ink (ρg/4).

Using these simple relations, a rheological map was constructed to predict the maximum height of profiled structures and the maximum span length of grid-like architectures that can be printed using our optimized ceria-based ink composition (FIG. 13d). The analysis reveals that our as-prepared ink compositions enable the manufacturing of profiled objects with heights up to 15 mm and grids with filaments spanning over a length 12 times higher than their own diameter. For this estimation, we assumed a typical filament diameter of 400 μm and a suspension density of 4.07 g/cm3 (50 vol % particles).

Direct ink writing experiments confirmed the successful printing of distortion-free profiled and grid-like structures (FIG. 13e,f). Experimentally, we found that the manufactured profiled structures can reach heights and span lengths significantly higher than predicted by the rheological map due to the drying of the structure during the direct ink writing process. Indeed, rheological measurements reveal that partial drying of the ink composition increases significantly its storage modulus and yield stress (FIG. 13c). This effect increases to 38 mm and 16 the maximum height and normalized span length of the printed object, respectively (FIG. 13d).

To better quantify the drying effect, we measured the weight loss of a printed ink filament at the typical temperature and relative humidity conditions used during printing. Our analysis shows that drying of the concentrated ceria ink compositions starts right after preparation and takes place over a timescale of 90 minutes. For a typical footprint area of 9 cm² (square of 30 mm length) and a printhead velocity of 12 mm/s, it takes approximately 17, 29, 61 and 45 minutes to print a 10 mm-high object with fill factors of 0.12 (D1), 0.20 (D2), 0.34 (D3) and 0.59 (D4), respectively. Since these printing timescales are comparable to the drying timescale, the yield stress and the storage modulus of the deposited ink composition is expected to steadily increase during printing, extending the maximum height and span length that can be achieved in a single printing step. Indeed, we experimentally observed that it is possible to continuously print structures as tall as 48 mm without gravity-induced distortion or cracking. Digital images of the ink deposition process demonstrate our ability to print tall structures in a single step and illustrate the high accuracy achieved during the printing process (FIG. 13e,f).

Drying of the structure is eventually completed by leaving the printed object at room temperature for 24 hours. Our experiments show that the as-printed structures undergo linear shrinkage of less than 1% (<0.5 mm) after complete drying. This increases the volume fraction of ceria particles in the system from 50 vol % in the initial ink to 52.5 vol % in the fully dried structure.

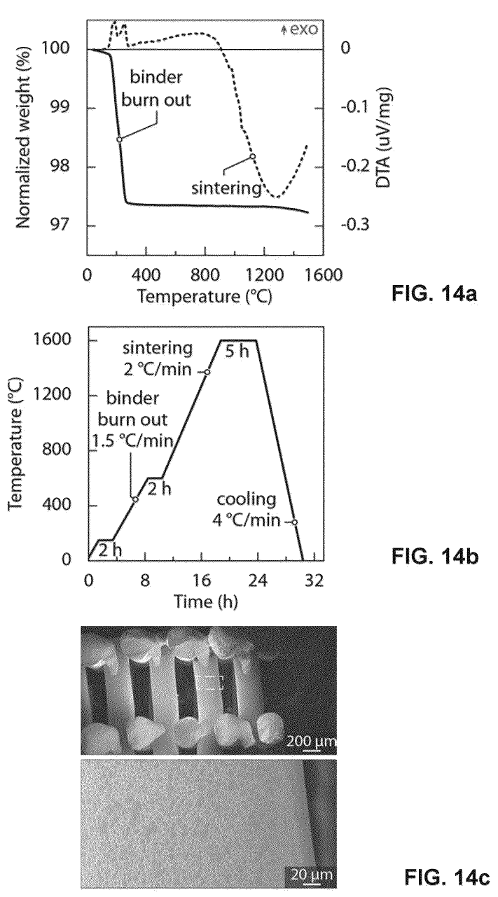

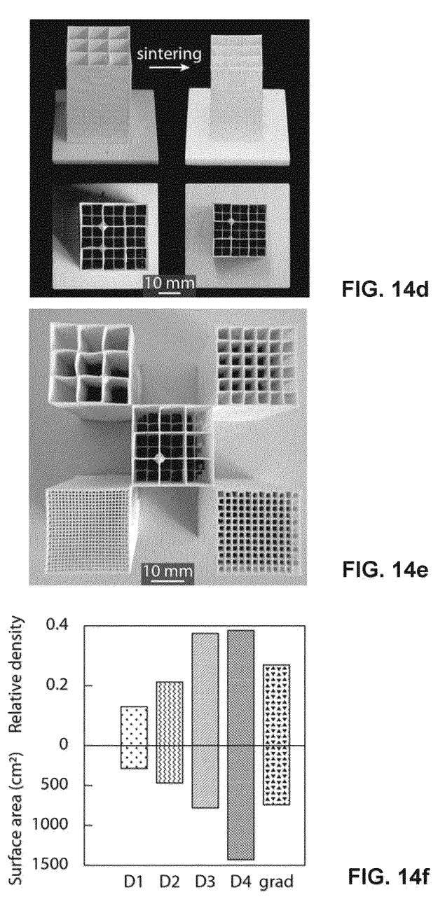

Ink compositions with optimal rheological behaviour were used to 3D print profiled ceria structures with architectures tailored to enhance penetration of sunlight in solar reactors (FIG. 14). The conversion of the as-printed objects into mechanically strong parts involves a two-step heat treatment for calcination and sintering of the structure at high temperatures. During calcination, the organic phase of the structure is removed through the thermal decomposition of the copolymer and remaining oil. To ensure complete removal of the organic phase without damaging the object, it is essential to heat up the material to the decomposition temperature of the organic phase and provide enough time for the resulting gases to diffuse out of the structure. By performing thermogravimetric analysis (TGA) of dried as-printed ink compositions, we were able to establish a calcination protocol for the effective thermal decomposition of the organic phase. The TGA results indicate significant mass losses at temperatures between 17° and 260° C., which correspond to the thermal decomposition of the copolymer (FIG. 14a). By holding the material for a minimum of 2 hours above this critical temperature range, we were able to obtain crack-free structures after the calcination process. Upon removal of the organic phase, the material does not show any considerable linear shrinkage.

Calcination was followed by a standard sintering procedure, in which the material is heated to 1600° C. and maintained at this temperature for 5 hours to promote densification of the calcined structure (FIG. 14b). Scanning electron microscopy of sintered samples showed that these conditions allowed for the development of a dense ceria microstructure with limited grain growth (FIG. 14c). The average grain size of the sintered ceria was found to be 5 μm, which is on the same order of magnitude of values previously reported for ceria-based reactors. Archimedes measurements reveal a remaining strut porosity of 7% which results in a relative density of 93%. To enable densification up to this relative density level, the material undergoes linear and volumetric shrinkages of approximately 17% and 44% during the sintering process. From these experimental shrinkage values, we estimate the volume fraction of solids in the printed material to be 49 vol % before sintering, which is in agreement with the fraction of ceria particles in the ink formulation (50 vol %).

The established calcination and sintering protocols allowed us to manufacture tall profiled monoliths featuring high-aspect-ratio dense walls (FIG. 14e). The thickness of the walls is ultimately defined by the diameter of the printing nozzle, the print path and the shrinkage associated to the drying, calcination and sintering steps. Using a nozzle diameter of 400 μm and the optimized ink composition, it is possible to reach wall thickness down to 290 μm in 5 cm-tall monolithic pieces. Since this wall thickness lies in a length scale at which the ceria is expected to undergo reduction in less than 10 seconds at 1500° C. 14,34, our monolith design ensures that all the oxide present in the structure contributes to the redox reaction. By programming the print path via computer-aided design, we were able to 3D print the envisioned ceria monoliths with deliberately tuned line densities along the height of the structure (FIG. 14e). Monoliths with fill factors of 0.590 (D4), 0.338 (D3), 0.202 (D2) and 0.124 (D1) and line densities of 0.833 (D4), 0.417 (D3), 0.208 (D2) and 0.104 1/mm (D1) were produced either with a graded or with uniform designs (FIG. 14e,f).

As has been outlined above, redox-active structures with a graded hierarchical porous design are expected to simultaneously display high light penetration depth and high surface area. Such structural features should enhance the throughput of solar-driven thermochemical reactions by reaching high, more homogeneous local temperatures across the structure and providing a high density of reactive sites for the reduction and oxidation reactions.

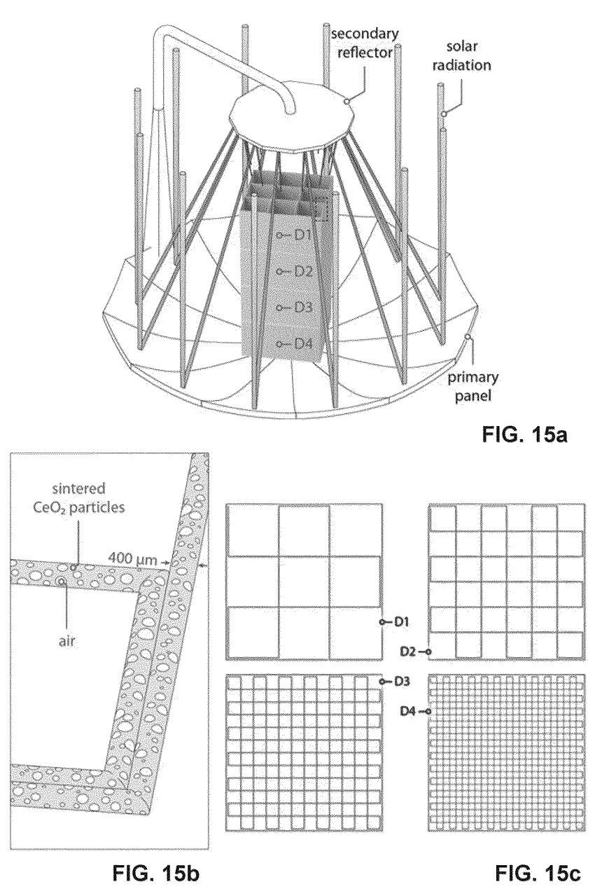

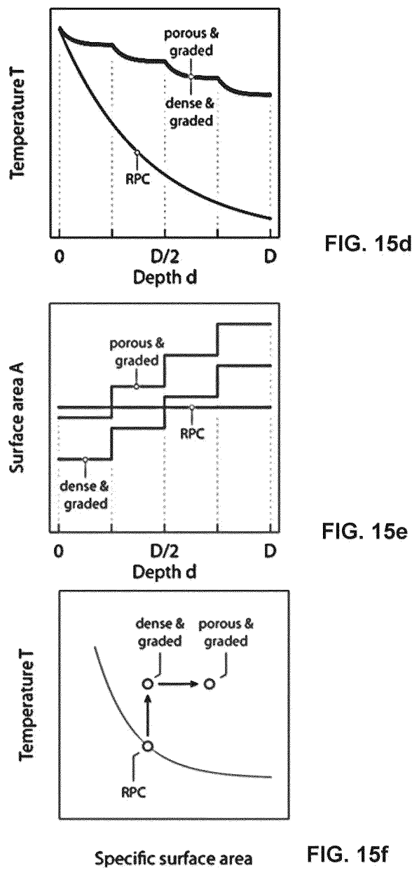

To enhance the light penetration depth, we design a structure with graded solid cross-sectional areas and large open channels oriented along the direction of incident light (FIG. 15a). The design consists of four layers with increasing line density as one moves further away from the light source (FIG. 15c). This reduces light scattering and enables deeper penetration of solar radiation, thereby increasing the temperatures reached inside the structure (FIG. 15d). To increase the reactive surface area, macropores are incorporated into the walls of the open oriented channels (FIG. 15b) while keeping the wall thickness unchanged. Such macroporosity is expected to increase the density of oxygen vacancies available for the CO₂ splitting reaction, thus enhancing the throughput of the thermochemical process (FIG. 15e).

The graded hierarchical porous design will allow us to circumvent the typical trade-off between light penetration depth and specific surface area found for state-of-the-art reticulated porous ceramics and similar isotropic architectures. Indeed, the open channels oriented along the illumination direction and the macroporosity on the channel walls enable the exploration of an attractive region of the design space that is currently not accessible using current designs (FIG. 15f).

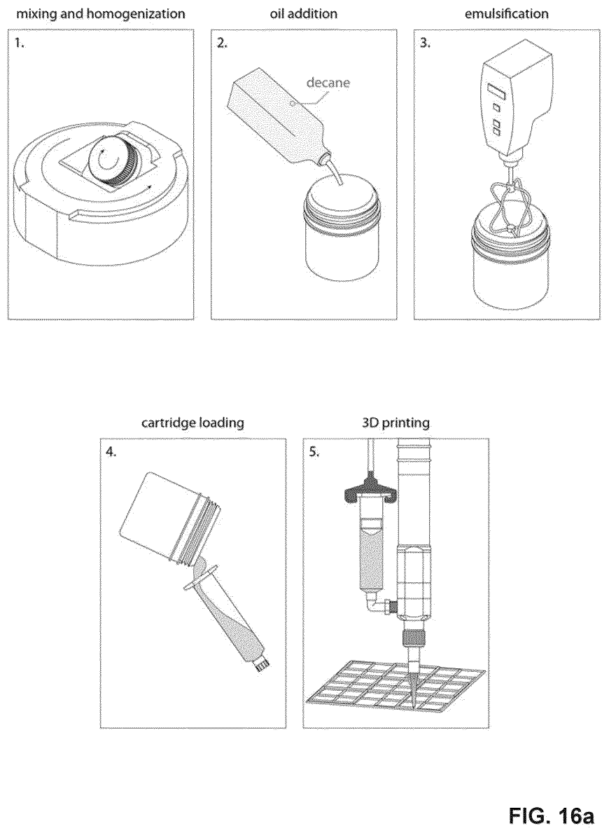

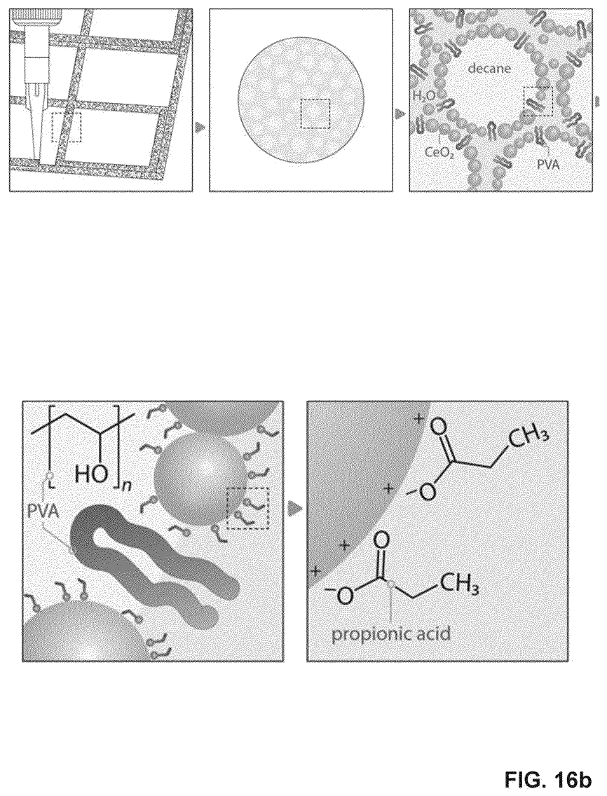

Ceria monoliths with graded architecture and porous walls were 3D printed using the direct ink writing technique. To create structures with macroporous walls, we utilize ink compositions in the form of particle-stabilized emulsions as feedstock ink in the 3D printer (FIG. 16). The emulsion consists of oil droplets dispersed in a continuous aqueous phase containing ceria particles, particle surface modifiers in the form of short amphiphilic molecules and a surface active additive in the form of a surface-active polymer. The oil droplets of the emulsion serve as templates for the generation of macropores during drying of the printed structures, whereas the aqueous continuous phase contains the ceria particles that form the solid phase of the monolith after sintering of the dried printed parts. Besides its role as precursor of the solid phase of the structure, the ceria particles are also essential to stabilize the emulsion, thus preventing undesired coalescence and coarsening of droplets under the shear stresses applied during printing.

The stabilization of the oil-in-water emulsions with colloidal particles relies on the adsorption of particles at the oil-water interface, which form a protective physical barrier that keeps the droplets apart (FIG. 16). Because of the large interfacial area that they are able to replace, particles adsorb more strongly to liquid interfaces compared to conventional surface-active molecules. Indeed, the adsorption energy of a nanoparticle at the oil-water interface is typically orders of magnitude larger than those of surfactants and of thermal energy. To strongly adsorb on the surface of oil droplets, particles need to be partially wetted by the two liquids involved, forming a finite contact angle at the oil-water interface. Particle surface modifiers in the form of amphiphiles with short alkyl chains have been shown to increase the hydrophobicity of oxide particles and to favor their adsorption at the oil-water interfaces. In our emulsified ink compositions, particle adsorption at the oil-water interface is induced using propionic acid molecules added to the continuous aqueous phase. Such short amphiphilic molecules promote adsorption of the ceria particles at the oil-water interface by coating them with a molecular layer that is electrostatically adsorbed onto the particle surface. Upon adsorption of the propionic acid molecules, the initially hydrophilic ceria particles become partially hydrophobized and therefore prone to adsorb on the surface of the oil droplets. In agreement with previous studies, the resulting Pickering emulsions were experimentally found to be very stable against coalescence and coarsening during the printing process. Stabilization occurs through the formation of a compact layer of partially hydrophobized particles around the droplets combined with the build-up of an attractive network of such particles throughout the continuous phase.

While the interfacial adsorption of modified particles is an important contribution to the stabilization of the emulsion, it is also known to generate predominantly closed macropores after removal of the templating oil droplets. Since open macropores are crucial to provide a high surface area for the redox reactions, poly(vinyl alcohol) (PVA) was also added to the emulsion in order to create windows between the macropores of the final dried and sintered structure. Earlier work has shown that the addition of partially hydrolyzed PVA enables the formation of open macroporous in ceramics derived from Pickering emulsions with similar formulation to those investigated here. The open pores likely result from the competitive adsorption of the short amphiphilic molecules and the partially hydrolyzed PVA molecules at the oil-water interface. Because they can be removed during calcination and sintering, the interfacially adsorbed PVA molecules offer a simple mechanism to prevent complete coverage of the droplet by particles and thus enable the formation of windows between the macropores of the final structure. In contrast to an early approach to introduce porosity in ceria structures using hollow glass spheres, the method proposed here leads to a monolith without contaminations and inactive materials.

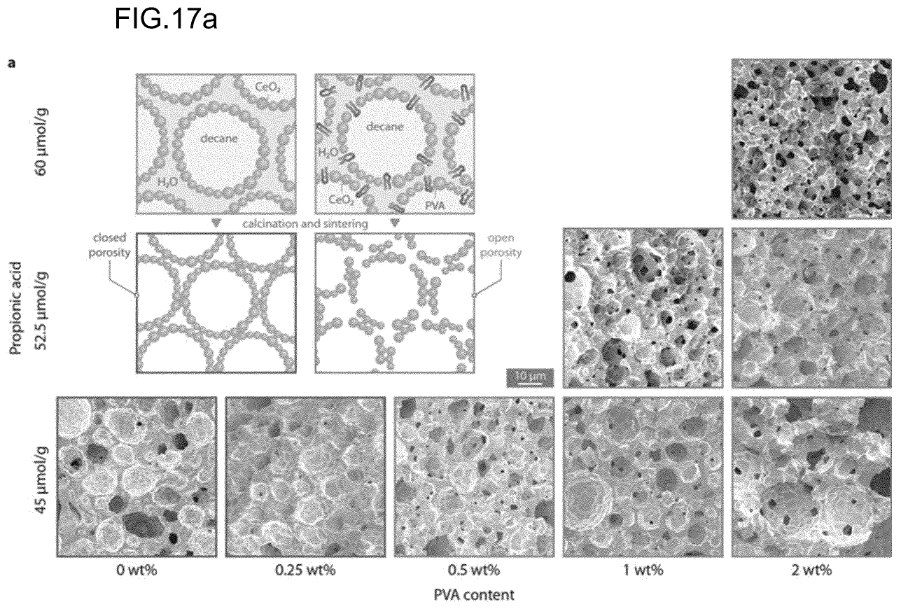

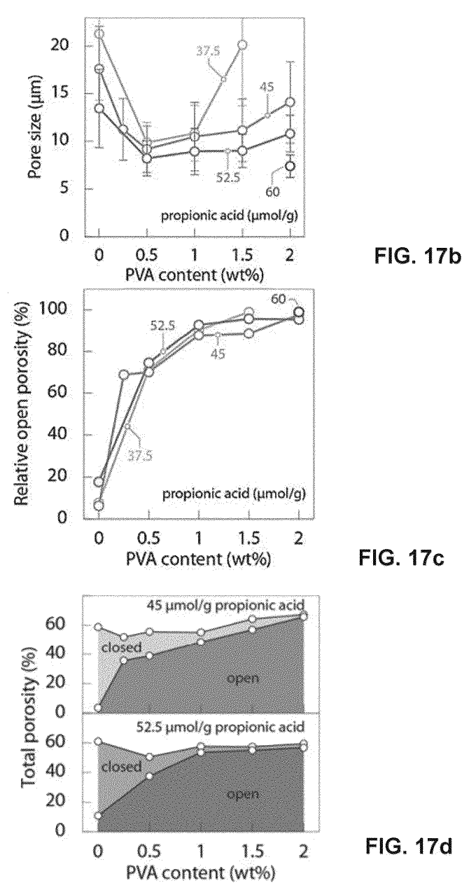

To evaluate the conditions required to create porous ceria structures with open macropores, we analysed the microstructure and porosity of specimens obtained after drying and sintering oil-in-water emulsions containing different concentrations of propionic acid and PVA (FIG. 17). In these experiments, the concentration of ceria particles in the aqueous phase was kept constant at 33.3 vol %, whereas the volume fraction of oil in the emulsion was fixed at 50 vol %. The emulsions were obtained by first preparing an aqueous suspension containing ceria particles and pre-dissolved PVA molecules. Propionic acid was afterwards added to this suspension before incorporation of the oil phase. The resulting mixture was mechanically homogenized in a laboratory mixer and let dry at room temperature for 24 hours. The dried samples were calcined and sintered in an electrical oven at temperatures of 600 and 1600° C., respectively.

Electron microscopy imaging of the sintered ceria structures reveal that the pore morphology is strongly affected by the concentrations of propionic acid and PVA molecules in the initial emulsion (FIG. 17a). The propionic acid concentration is given in number of moles of the amphiphilic molecule divided by the mass of ceria particles in the suspension. In the absence of PVA, emulsions containing 45 μmol/g of propionic acid results in sintered structures with predominantly closed spherical macropores. This suggests that the templating oil droplets were completely covered by the ceria particles in the emulsion. After removal of the oil droplets, these particles densify into pore-free walls during the subsequent sintering process. The addition of 0.5-2 wt % PVA to these emulsions led to the formation of sintered structures displaying open windows on the walls of the macropores, in agreement with our initial hypothesis and previous work. Interestingly, the size of such open macropores can be reduced by further increasing the propionic acid concentration up to 60 μmol/g.

The effect of PVA and propionic acid on the morphology of the macroporous ceria structures was quantified by measuring the pore size (FIG. 17b) and the porosity of the sintered samples (FIG. 17c-d). The pore size was measured through image analysis of Scanning Electron Microscopy (SEM) micrographs, whereas the open and closed porosities were quantified using the Archimedes method. For samples prepared with a constant propionic acid concentration of 45 μmol/g, we observed that the average macropore size decreases from 18 μm to 9 μm as the PVA content is increased from 0 to 0.5 wt %. Since the macropores are predominantly closed in this PVA concentration range, we expect that the presence of the polymer does not affect the stabilization of the emulsions through the interfacial adsorption of modified ceria particles. Therefore, the observed decrease in average macropore size for this lower PVA concentration range might be caused by an increase in the viscosity of the emulsion upon addition of up to 0.5 wt % PVA. Emulsions with higher viscosity lead to higher shear stresses on the oil droplets during mixing, thereby reducing their final average size 31.

By increasing the PVA concentration above 0.5 wt %, we found that the initial trend is inverted, leading to an increase of the average macropore size up to 14 μm at 2 wt % of polymer. Since PVA molecules in this concentration range are expected to compete with propionic acid for the oil-water interface, it is reasonable to assume that the increased average macropore size results from the partial destabilization of the emulsions at these high polymer concentrations. Partial destabilization probably takes place because the oil droplets in these emulsions are not fully covered by particles, thus favoring their coalescence and coarsening. Importantly, we observed that this destabilization effect can be compensated by increasing the propionic acid concentrations up to 60 μmol/g in emulsions containing 2 wt % PVA. Indeed, emulsions prepared with these concentrations result in sintered structures with open macropores with an average size as small as 7 μm. In terms of porosity, our results indicate that the total porosity of the ceria structures remains nearly unchanged, whereas the ratio between open and closed pores varies significantly depending on the PVA and propionic acid concentrations in the emulsion (FIG. 17c,d). The total porosity of approximately 60% measured for all samples is slightly higher than the volume fraction of oil phase added to the emulsion (50 vol %). This suggests that a small fraction of air bubbles was also incorporated in the emulsion during the emulsification step. Notably, the fraction of open macropores within this total porosity was found to increase from 6% to nearly 100% when the PVA concentration is increased from 0 to 2 wt % while keeping the propionic acid content constant at 45 μmol/g. This trend quantitatively confirms that the addition of PVA favors the formation of windows on the macropores, likely due to competitive adsorption with particles at the oil-water interface. Our data show that a PVA concentration of 0.5 wt % is already sufficient to open 70% of the porosity of structures prepared with 45 μmol/g of propionic acid.

Oil-in-water emulsions stabilized by modified ceria particles were used as feedstock for the 3D printing of hierarchical porous structures via the direct ink writing technique. To identify ink compositions that can be printed using this extrusion-based approach, we investigated the rheological behavior of emulsions containing different concentrations of propionic acid and PVA molecules.

Tuning the rheological properties of the ink is an essential requirement for printing by direct ink writing. To enable printing of spanning filaments in grid-like architectures or structures with sharp curvatures and high heights, the ink composition needs to display viscoelastic properties that prevent shape distortions induced by gravity and capillary forces. Gravity-driven sagging of supported filaments is a common distortion of grid-like structures, which can be avoided by formulating inks with sufficient storage modulus under rest. For a filament diameter (D) of 0.4 mm made from an emulsified ink composition with an estimated specific density of 1.89 g/cm3 (see Table 8, Supporting Information), we estimate from beam theory that a minimum storage modulus (G′) of approximately 1.6 kPa is necessary to minimize sagging in a grid with an arbitrary spanning distance of 5D (see supporting information).

In the case of structures with increased local curvatures or high heights, a minimum yield stress (τ_{y}) is required to prevent flow of the ink composition induced by capillary or gravitational forces, respectively. Assuming a typical surface tension of 40 mN/m for the ink composition, we estimate that a yield stress of approximately 200 Pa should be sufficient to prevent capillary-driven distortion of structures with local radii of curvature down to 200 μm. This level of yield stress should be enough to print structures with a total height of nearly 1 cm without undergoing gravity-induced shape distortion at the bottom layers (see supporting information). These estimates provide useful guidelines for tuning the rheological behavior of the emulsified ink compositions.

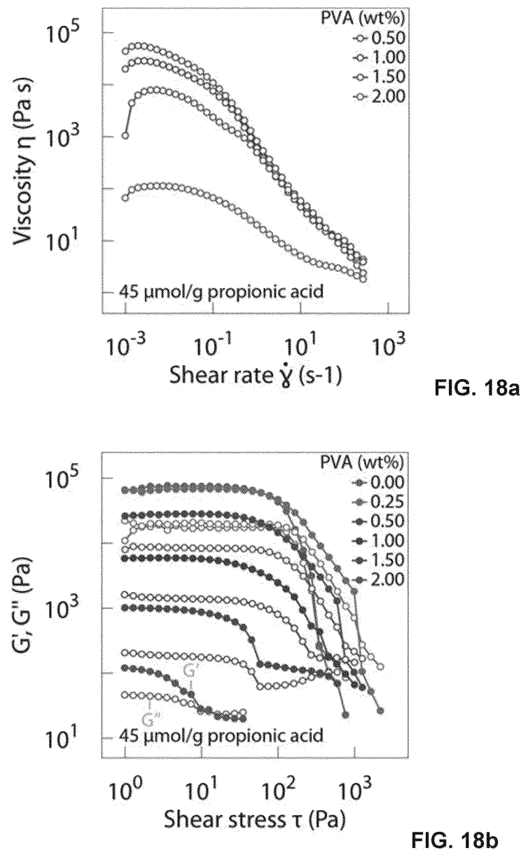

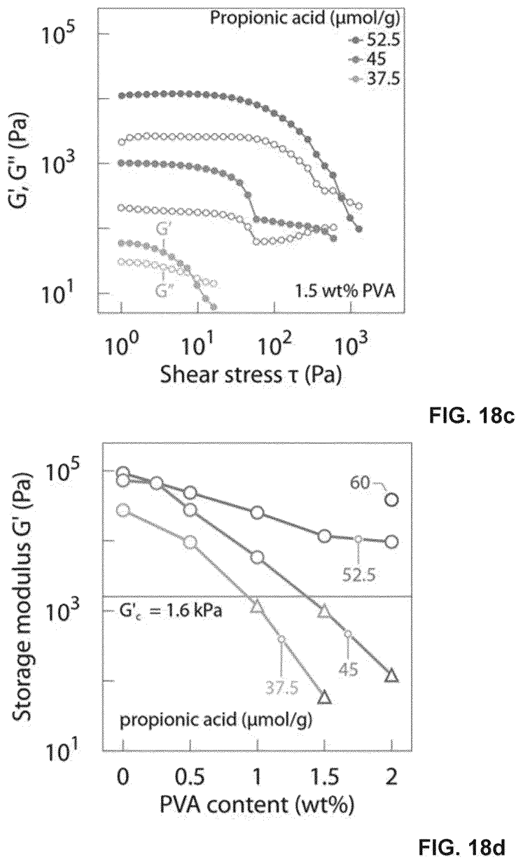

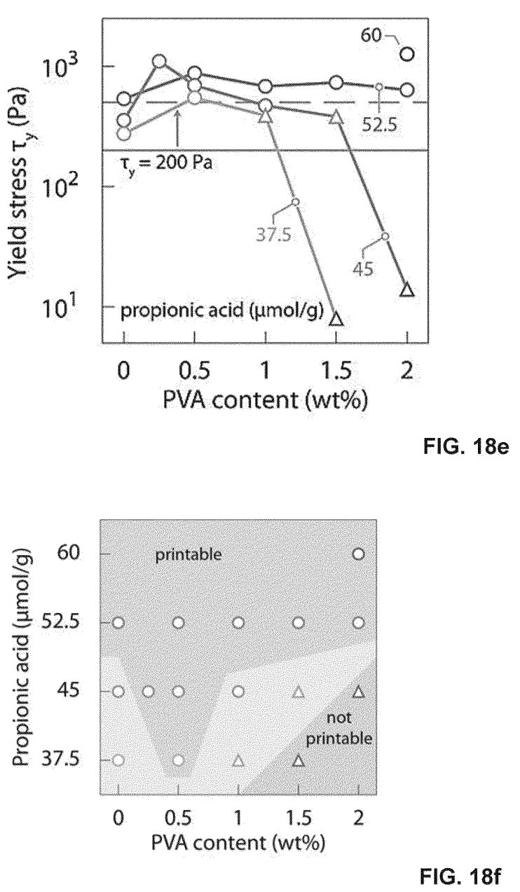

To compare the storage modulus and yield stress of our emulsions with the threshold G′ and τ_{y} values estimated above, we performed steady-state and oscillatory rheological experiments on the ink compositions that lead to macroporous structure upon drying (FIG. 18). Steady-state measurements show that emulsion exhibits a strong shear-thinning behavior, as evidenced from the decrease in apparent viscosity by 4 orders of magnitude upon increasing the applied shear rate up to 250 s-1 (FIG. 18a). The results of the oscillatory rheology reveal that all evaluated emulsions show a typical viscoelastic response with a high storage modulus (G′) at low applied stresses and a fluidization effect above the yield stress, Ty (FIG. 18b,c). The yield stress was taken here as the cross-over between the storage (G′) and the loss (G″) modulus measured under increasing shear stresses. For a fixed propionic acid concentration of 45 μmol/g, we observe that the addition of PVA drastically reduces the storage modulus of the emulsion from approximately 73 kPa at 0 wt % PVA to values as low as 0.1 kPa at 2 wt % (FIG. 18d). Interestingly, an increase of the concentration of propionic acid up to 60 μmol/g compensates for this effect, allowing for the emulsion to maintain a high storage modulus of 39 kPa even in the presence of 2 wt % PVA.

The presence of high PVA contents (2 wt %) was also found to significantly decrease the yield stress (τ_{y}) of the emulsion prepared with 45 μmol/g propionic acid (FIG. 18e). However, the addition of PVA concentrations equal and below 1 wt % leads to an increase of the τ_{y} values relative to the reference PVA-free emulsion. This result is in agreement with our interpretation that low concentrations of PVA increase the viscosity of the emulsion, thereby decreasing the droplet size achieved after mechanical mixing (FIG. 17b). Smaller droplet size lead to an enhancement of the elastic network, to higher viscosities and storage moduli, which in turn improves emulsion stability. Similar to the trend observed for the storage modulus, the yield stress of emulsions containing 2 wt % PVA can be increased to levels comparable to those of the PVA-free composition by increasing the concentration of propionic acid to 60 μmol/g.

Overall, our experiments suggest that the addition of low concentrations of PVA to the Pickering emulsions does not disturb the stabilization mechanism based on the adsorption of modified particles on the surface of the oil droplets and the formation of a percolating attractive network throughout the continuous aqueous phase. At higher concentrations, PVA competes for adsorption at the oil-water interface and probably interacts with the propionic acid molecules to decrease its hydrophobization effect on the ceria particles. The lower hydrophobicity of the inorganic particles reduces their affinity for the oil droplet surface and the strength of the percolating network, resulting in coalescence and coarsening events in the emulsion. The addition of higher amounts of propionic acid can compensate for the reduction of hydrophobicity and thus re-establish a strong percolating network.

On the basis of the rheological properties of the emulsions and the estimated threshold values for G′ and τ_{y}, we were able to establish theoretical predictions for the concentrations of propionic acid and PVA molecules required for direct ink writing of grid-like architectures and three-dimensional structures with pre-defined spanning length and height (FIG. 18f). According to these predictions, it should in principle be possible to print distortion-free grid-like structures with height of 1 cm and spanning distance of 5D for all emulsion ink compositions except those containing a combination of high PVA concentration (>1.5 wt %) and low propionic acid content (<45 μmol/g). For PVA concentrations higher than 2 wt %, ink compositions with rheological behavior suitable for printing distortion-free grids can still be formulated by further increasing the concentration of propionic acid to 52.5 μmol/g or above.

To test these predictions, we printed 1.4 cm-tall emulsion structures with different concentrations of PVA and propionic acid, and checked for possible distortions arising from insufficient yield stress or storage modulus (FIG. 19). Digital images of the printed structures confirm that emulsions with high PVA concentrations combined with low propionic acid content are not stiff and strong enough to withstand gravitational forces, rendering them non-printable (right frames on the uppermost and second uppermost lines in FIG. 19). In contrast, if the propionic acid concentration is equal or higher than 52.5 μmol/g, the G′ and Ty values are clearly high enough to enable printing of distortion-free structures (all frames on the very left as well as those on the second lowest line in FIG. 19). The same is valid for ink compositions containing the intermediate PVA concentration of 0.5 wt %, which was previously found to enhance the yield stress of the emulsion compared to the PVA-free composition (FIG. 18e).

Emulsions lying outside these well-defined regions of the map (middle frame on the second uppermost line and the middle and right frames on the middle line and lowermost line in FIG. 19) were found to be printable but undergo gravity-induced distortion in the form of slumping. With yield stresses in the range 200-500 Pa, these ink compositions were expected to be strong enough to withstand such distortion effects. The fact that the experiments did not match the theoretical predictions for this set of ink compositions suggest that the measured Ty values might not be representative of the actual yield stress of the emulsion right after extrusion. Indeed, emulsions often require time to recover their elasticity and yield stress after subjected to extensive shearing. It is therefore plausible that this well-known hysteresis effect is at the origin of the experimentally observed distorted structures. For the formulations investigated in this study, our experiments reveal that a yield stress 2.5 times higher than that measured on non-sheared emulsions provides a more conservative threshold value to ensure printing of distortion-free cm-high structures. With the help of this analysis, we selected emulsions with 1 wt % PVA and 52.5 μmol/g propionic acid for 3D printing the porous ceria structures that are designed to enhance redox performance.

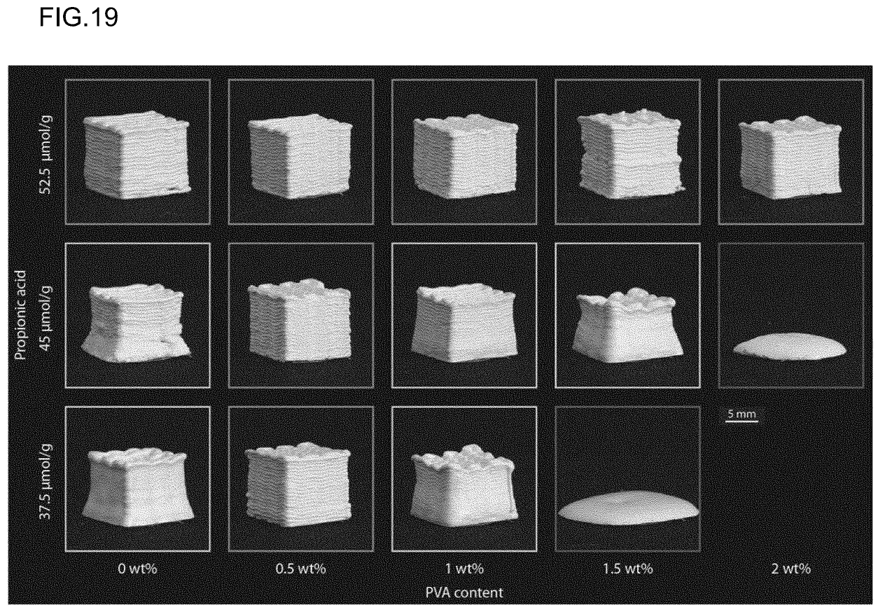

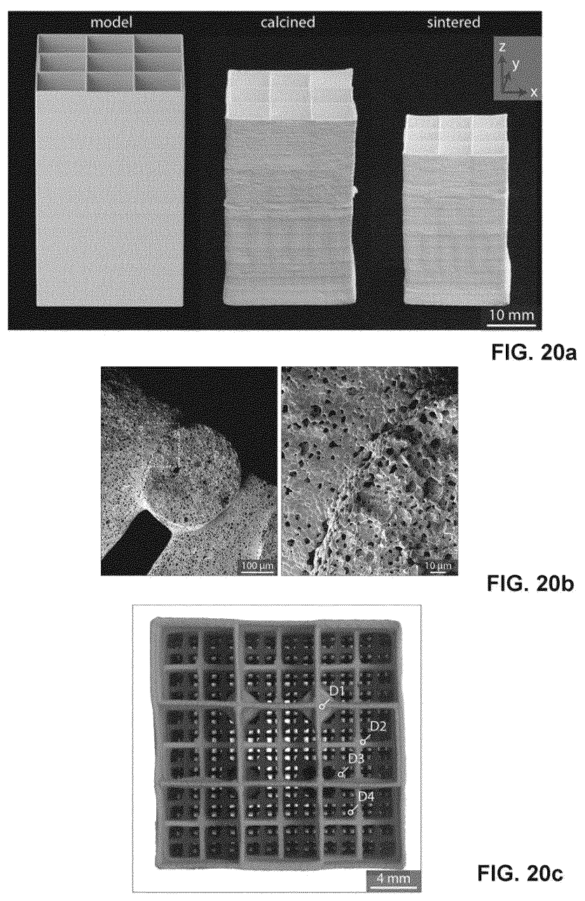

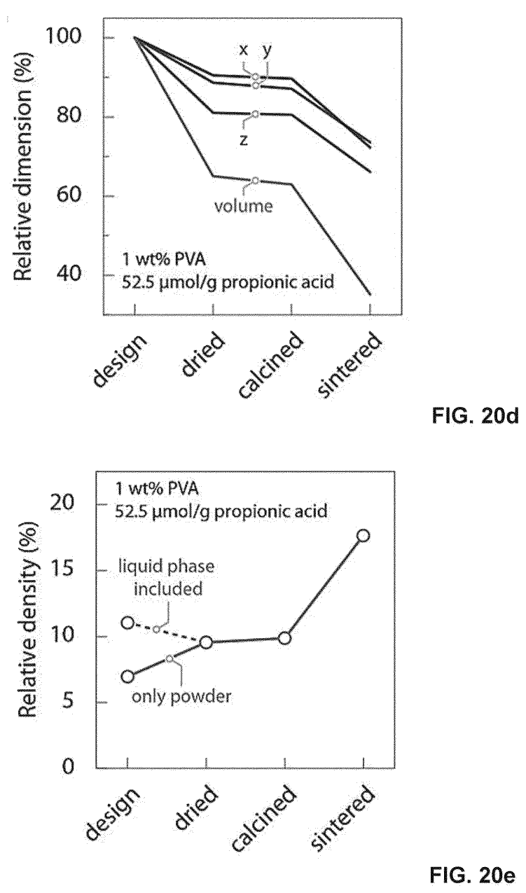

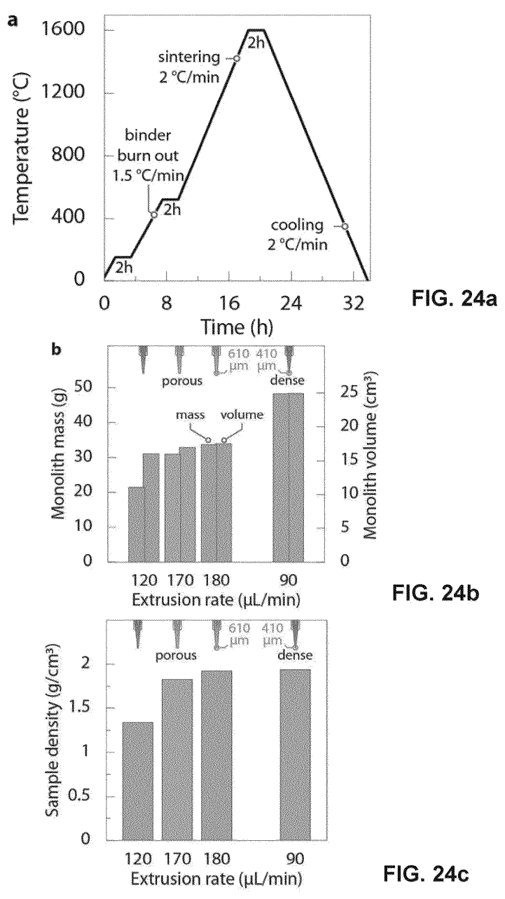

Structures up to 48 mm in height and featuring hierarchical porosity were successfully printed using the selected emulsified ink composition (FIG. 20a). Printing was performed using a multimaterial extrusion-based system equipped with a volumetric dispenser to deposit filaments at room temperature with controlled extrusion speed. As-printed structures were dried, calcined and sintered following the protocol established in prior experiments (FIG. 24a, Supporting Information).

After sintering, the 3D printed ceria monolith exhibits a well-defined hierarchical structure of pores at two distinct length scales. While the print path defines the open channels at the millimeter range, macropores with sizes on the order of 10 μm are generated from the oil droplet templates. SEM images of the dried and sintered structure reveals the morphology of the stacked filaments and of the macropores at distinct magnifications (FIG. 20b). The filaments were found to partially overlap to each other, indicating that the yield stress of the ink composition does not prevent it from flowing under the gravitational and capillary forces acting at the contact point between filaments. This is expected to increase interlayer bonding and thereby the mechanical performance of the monolith.

A closer view inside a single filament of the ceria structure shows that the macropores are uniformly distributed within the solid phase of the monolith (FIG. 20b). As expected from our earlier morphological analysis (FIG. 17a), the pores are open and well interconnected throughout the structure. The macropore size on the order of 10 μm reflects the size of the oil droplets present in the emulsion template (FIG. 17b). This open macroporosity increases the surface area available for the redox reactions and is therefore expected to enhance the thermochemical throughput of the monolith compared to macropore-free structures.

Open-channel structures with graded cross-sections of 4 relative density levels (D1-D4) were found to be mechanically robust and crack-free after the whole manufacturing cycle (FIG. 20c). In addition to the graded porous architecture, the shaping freedom of the printing technique was leveraged to also incorporate hollow tubes for thermocouples directly within the 3D structure. By hosting thermocouples at different positions along the depth of the monolith, these tubes allowed us to quantify the temperature distribution within the structure during redox performance experiments.

Drying, calcination and sintering lead to significant shrinkage of the printed structure. To quantify the dimensional changes involved during these processes, we analysed the linear and volumetric shrinkage of the structure starting from the design through the drying to the calcination and sintering steps (FIG. 20d). Shrinkage is first observed during drying step when the aqueous and oil phases are removed and the CeO₂ particles get closer to each other, thus providing mechanical stability to the green body. The second major shrinkage event happens during sintering, which causes particles to partially merge together at the contact points to further enhance the mechanical strength of the monolith.

The linear shrinkage during these two processing steps is more prominent along the longitudinal axis (z-direction) as compared to the transverse axes (x and y-directions). Further experiments have shown that the volumetric shrinkage during drying and sintering can be reduced from 32 to 27.5% and from 66 to 59.2%, respectively, by increasing the volume fraction of ceria particles in the aqueous phase from 35 to 37%. As expected, shrinkage was accompanied by an increase of the relative density of the ceria structure. The relative density, calculated as the mass divided by the volume, increased from 7% for the design to 18% after sintering of a graded monolith prepared with 1 wt % PVA and 52.5 μmol/g propionic acid (FIG. 20e). When the volumes of water and decane are also considered, the relative density of the design decreases from 11% to 9.5% after drying, before increasing to 18% upon sintering.

While the hierarchical porosity increases the surface area available for the redox reactions, it also reduces the relative density of active ceria material in the structure. If the thermochemical process is not limited by mass transport, the relative density of active material is an important parameter to control the absolute amount of fuel produced for a given redox cycle. Therefore, we explored printing strategies to increase the relative density of the hierarchical porous structures to levels comparable to those of structures with dense walls. Our hypothesis was that the volume fraction of oil present in the emulsion-based ink composition needs to be compensated by a higher volume of the deposited filament, so as to eventually reach a high relative density comparable to the dense-walled structure.

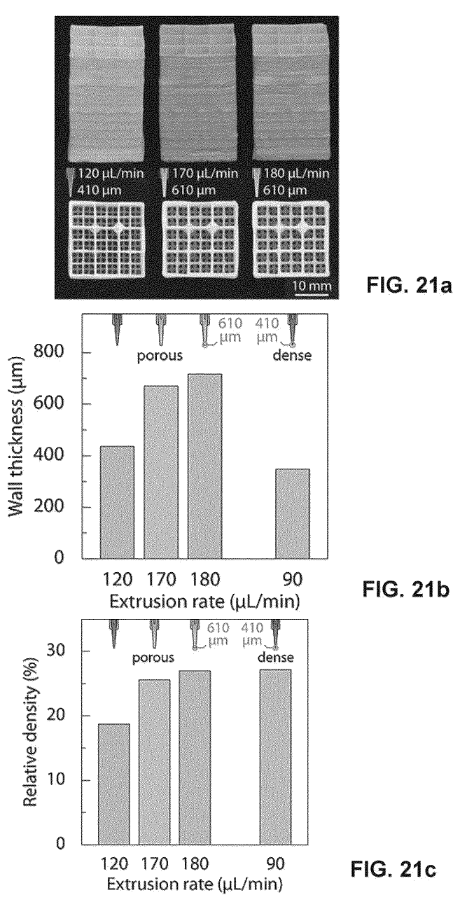

To test this hypothesis, we evaluated the effect of the extrusion rate and nozzle diameter on the wall thickness and relative density of sintered graded structures printed using emulsions or suspensions as feedstock. (FIG. 21). For the emulsion-based ink compositions, two nozzle diameters operated at different extrusion rates were tested: 410 μm at 120 μL/min (FIG. 21) or 610 μm at 170-180 μL/min (FIG. 21). As a reference, structures with dense walls were printed from a ceria suspension using a 410 μm nozzle operated at an extrusion rate of 90 μL/min.

The experimental results show that the wall thickness can be increased from 450 to 750 μm by increasing the extrusion rate and nozzle diameter from 410 μm/120 μL/min to 610 μm/180 μL/min (FIG. 21a,b). Thickening of the walls translates into an increase in relative density of ceria from 18.8 to 27% (FIG. 21c, Table 11). The relative density of the porous monolith with thicker walls deposited at a rate of 180 μL/min is comparable to that of dense counterparts printed at a rate of 90 μL/min (27.2%). This indicates that the presence of 50 vol % oil in the emulsion-based ink composition could be compensated by doubling the extrusion rate during printing to reach similar levels of relative density in the sintered structures. Interestingly, the relative density after sintering was found to depend directly on the amount of oil phase but not on the volume fraction of ceria particles in the aqueous phase of the ink compositions. After compensating for the presence of the oil phase by increasing the extrusion rate, the aqueous phase of the emulsion leads to similar relative density as the suspension-based ink composition, despite its much lower volume fraction of ceria particles (16.67 vol %, Table 10) compared to the suspension (50 vol %, Table 8). This is explained by the stronger total shrinkage of the emulsions (60 vol %) in comparison to the suspension counterparts (42 vol %).

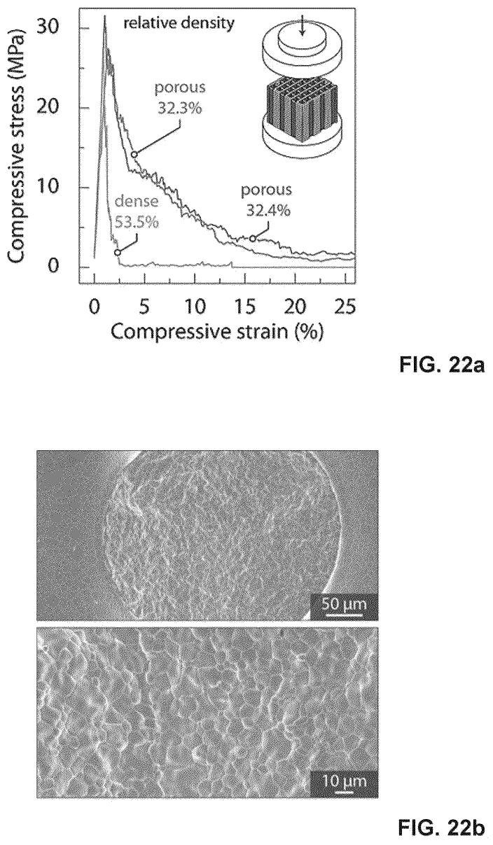

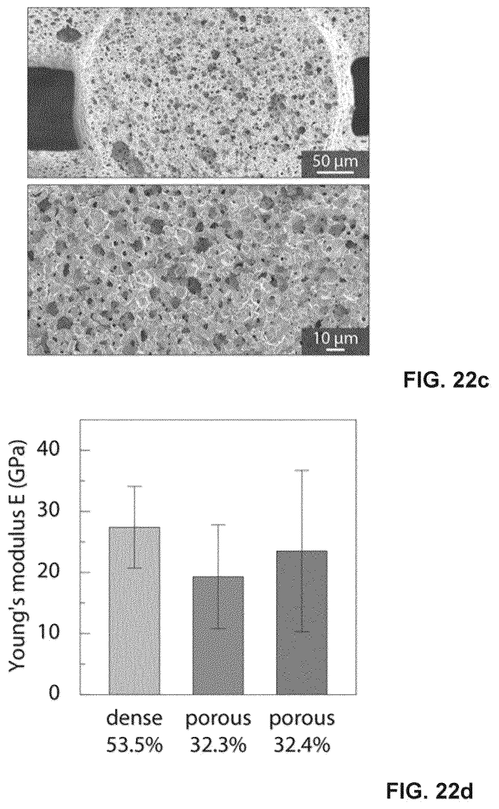

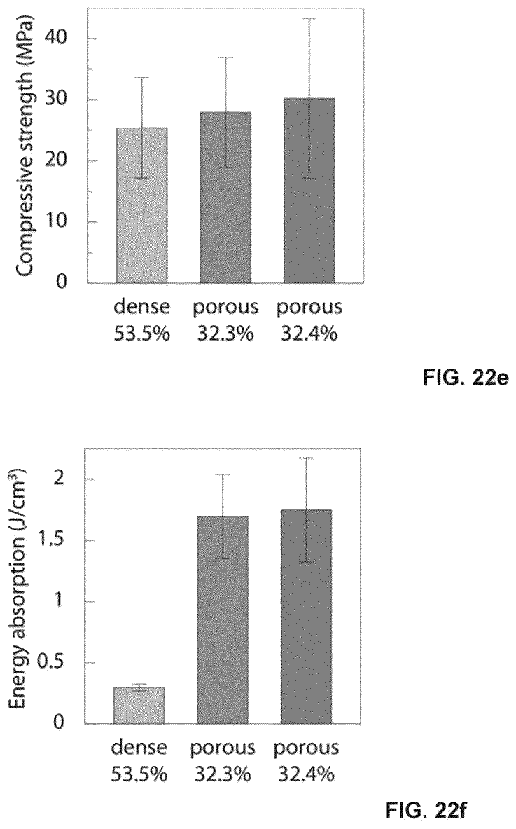

In addition to the relative density of active phase, the mechanical properties of the ceria structure also play a crucial role on the reactor's performance by determining its long-term stability under the strong heating and cooling cycles applied during operation. To evaluate the mechanical properties of the open-channel ceria structures we performed mechanical compression tests on printed grid-like monoliths with and without macroporous walls (FIG. 22). Grids with dense and porous walls were printed using a 410 μm nozzle at standard extrusion rates of 90 and 120 μL/min, respectively. To evaluate hierarchical porous structures with distinct relative densities, the volume fraction of ceria in the aqueous phase of the ink compositions were fixed to either 33 vol % or 36 vol %. This resulted in hierarchical porous monoliths with relative densities of 32.3 and 32.4%, which are significantly lower than the value of 53.5% obtained for the reference grid with dense walls.

The compression tests reveal that the presence of macropores in the walls significantly affects the stress-strain response and fracture behavior of the grid-like structures (FIG. 22a). Hierarchical porous monoliths show graceful fracture after a peak stress of 27.9-30.2 MPa is reached. In contrast, structures with dense walls can withstand nearly the same stress levels (25.4 MPa, FIG. 22e) but fail abruptly at compressive strains as low as 2.5%. When normalized with respect to the expected compressive strength of ceria of 589 MPa39, the relative strength values of the porous structures correspond to 0.047 and 0.051 for densities of 32.3 and 32.4%, respectively. These values fall within the range typically obtained for other porous ceramic materials.

As a result of this distinct failure behavior, the hierarchical porous grids are able to absorb approximately 5-6 times more fracture energy compared to their denser counterpart (FIG. 22f). Fracture energies normalized by the mass lead to 0.7 J/g and 0.08 J/g for the porous and dense monoliths, respectively. These values are in the same order of magnitude as the ones reported in the literature for zirconia with distinct relative densities. The gentle failure and high energy absorption capability of the porous monoliths results from the high density of macropores (FIGS. 22b,c), which effectively deflect propagating cracks and thus toughen the grid structure. The presence of macropores and the lower relative density of the hierarchical porous structures also translates into a slightly lower elastic modulus in the range 19.3-23.5 GPa in comparison to the dense counterparts (27.4 GPa). Based on these results, hierarchical porous monoliths should display enhanced stability under thermocycling conditions compared to structures with dense walls.

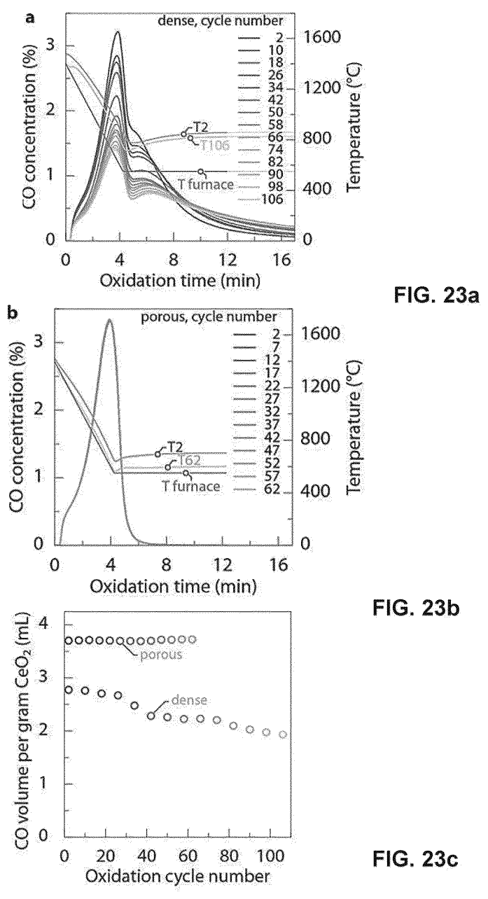

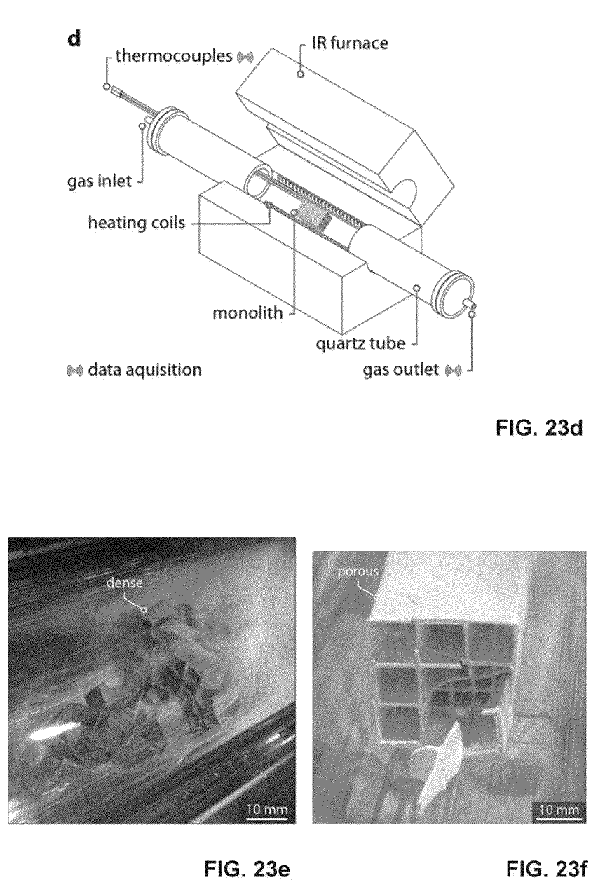

Ceria monoliths with the hierarchical porous architecture were tested in terms of redox performance by measuring the release of CO gas during the oxidation step of the redox cycle typically used for solar-driven CO₂ splitting (FIG. 23). In this test, we compare porous hierarchical specimens with dense counterparts featuring the same graded architecture of oriented channels but with dense walls. The measurements were performed in a tubular infrared oven, in which the CO release and the temperature of the structure are measured while the sample is subjected to up to 120 heating and cooling cycles at rates of 212.5° C./min (FIG. 23d). Because the graded architecture allows for deep penetration of radiation under solar illumination, the temperature cycles imposed in these experiments are expected to reflect the thermal cycles experienced by the ceria monolith under solar-driven reaction conditions. To evaluate the oxidation behavior of the ceria monolith, we focus the analysis on the cooling part of the cycle, when the temperature of the oven drops from 1400 to 550° C.

Our experimental results reveal that the presence of macropores has a major impact on the redox performance of the graded ceria monoliths (FIG. 23). First, we observe that the temperature of the macroporous monolith (FIG. 23b) follows more closely the dropping temperature of the oven in comparison to samples with dense walls (FIG. 23a). By reaching lower temperatures, the macroporous structure offers a stronger driving force for the oxidation reaction. The lower temperature mismatch measured for the hierarchical porous structure might be caused by its lower relative density of 19%, which reduces the thermal mass of such sample compared to the dense counterpart (relative density of 27%). Second, the oxidation of the macroporous structure leads to a continuous release of CO gas during the cooling step (FIG. 23b), which contrasts with the two-step gas release observed for the sample with dense ceria walls (FIG. 23a). This experimental observation suggests that CO₂ splitting in the dense structure occurs quickly on the surface of the walls, but eventually becomes diffusion-limited at a later stage of the oxidation process. Instead, the macropores of the hierarchical structure provides the high surface area needed for the oxidation process, lifting the diffusion limitations observed in specimens with dense walls. Complete re-oxidation is observed after 8 min for the porous structure, whereas it is not finished after 16 min for the monolith with dense walls. By normalizing the measured gas output over the weight of the sample, we calculated the total volume of CO obtained for an entire cycle. The CO volume of 3.7 mL per gram CeO₂ found for the porous monolith is comparable with values previously reported in the literature for RPC structures with dual porosity. Importantly, the profiled graded architecture presented here offers the additional benefit of a high radiation penetration depth compared to RPC structures.

Finally, the redox performance of the hierarchical porous structure was found to be stable over more than 60 thermal cycles, whereas long-term cycling led to a significant continuous drop in the amount of CO released from the dense-walled samples (FIG. 23c). The improved cyclability of the porous hierarchical specimen is also reflected in the better mechanical integrity of this structure, which were not as damaged as their dense counterparts during the cycling experiment (FIGS. 23e and 23f). Such thermal shock resistance is probably due to the higher fracture energy of monoliths with hierarchical porosity, in which cracks can be deflected and arrested by the macropores present within the walls of the monolith. It is also reasonable to assume that the lower temperature mismatch during each thermal cycle also contributes to the robust long-term performance of the macroporous structure. This reduces the thermal stresses developed in the material, further minimizing the nucleation and propagation of cracks that compromise the mechanical integrity and the redox performance of the structure.

In conclusion we note that ceria monoliths with graded hierarchical porosity show enhanced redox performance under temperature cycles expected in solar-driven thermochemical splitting of CO₂ and water. These hierarchical structures can be 3D printed directly from a particle-based emulsion using the direct ink writing technique. Control of the tool path during printing leads to the oriented open channels needed to increase sunlight penetration at coarser length scales, whereas macropores within the walls of the structure provide the high surface area required at smaller scales to enhance the throughput of the redox reactions. The macropores are generated from the oil droplets of the emulsion ink composition, which serve as a sacrificial template that is easily removed upon drying of the printed structure. The stabilization of the emulsion using modified ceria particles adsorbed at the oil-water interface is crucial to prevent droplet coalescence and coarsening during printing. By tuning the concentration of particle surface modifier on the ceria particle surface and of surface active additives such as poly(vinyl alcohol) molecules present in the emulsion, it is possible to formulate inks with rheological properties required for extrusion-based printing and to obtain ceria monoliths with open interconnected macropores after drying and sintering. Printing of thick filaments enables the introduction of macropores in the graded structures without compromising the relative density of the reactive ceria phase. Redox experiments under thermal cycling conditions indicate that the hierarchical porous structures generated by this approach enhances the throughput of the CO₂ splitting reaction, enables full re-oxidation of the active material, reduces thermal gradients inside the monolith and extends the lifetime of the structure compared to dense reference counterparts. The design concepts leading to this enhanced performance may aid the fabrication of the next generation of reactors for efficient and competitive solar-to-fuel energy conversion.

### Materials and Methods

### Preparation of Suspension-Based Ink Compositions

Suspension-based ink compositions were prepared by combining ceria particles, a thermoresponsive copolymer, a dispersant and limonene in water, following a multi-step mixing procedure. A stock solution containing 20 wt % PEO-PPO-PEO tri-block copolymer (Pluronic F-127, Sigma-Aldrich) in deionized water was prepared to facilitate the incorporation of the thermoresponsive copolymer in the mixture. To enable dispersion of the cerium oxide particles (99.9%, particle size<5 μm, Sigma-Aldrich, Austria), 0.5 wt % of a polyacrylic acid dispersant (Dolapix CE 64, Zschimmer und Schwarz, Germany) was added to the formulation relative to the mass of ceria. Finally, limonene oil (R-Limonene, Merck, Germany) was used to adjust the rheological properties of the ink.

In a typical mixing procedure, 32 mL of ink composition with 50 vol % (87.80 wt %) ceria is prepared using 0.57 g of polyacrylic acid, 114.08 g of cerium oxide particles and 13.97 g of the PEO-PPO-PEO stock solution. Such ink constituents were added to a 250 mL container with two zirconia balls (diameter of 10 mm) to improve dispersion during mixing. The ink composition was first mixed for 60 seconds at 2000 rpm in a planetary mixer (ARE-250, Thinky, USA). Then, the closed container was cooled down in an ice-bath for 20 minutes to minimize evaporation and reduce the viscosity of the suspension. This procedure was repeated 2 more times before adding 1.31 g of limonene oil. The suspension was then mixed one last time at 2000 rpm for 60 seconds, defoamed for 30 seconds at 2200 rpm and cooled down in an ice bath for 20 minutes. The obtained ink composition was then poured into a 30 mL printing cartridge, closed with the piston, sealed with Parafilm and centrifuged at 2200 rpm for 1 min to remove enclosed air bubbles. Finally, the ink composition was left at rest until it reached room temperature. Density values of 1 g/cm³ for the PEO-PPO-PEO aqueous solution, 1.2 g/cm³ for the polyacrylic acid dispersant and 7.13 g/cm³ for the cerium oxide particles were used to convert volume to weight fractions of the individual constituents of the ink (Table 8, Supporting Information).

### Preparation of Emulsion-Based Ink Composition

Emulsion-based ink compositions were prepared using 50 vol % of decane as oil phase and 50 vol % of an aqueous phase containing polyvinyl alcohol (PVA) and ceria particles modified with propionic acid. The concentration of ceria particles within the aqueous phase was fixed at 33.3 vol %, whereas the PVA and propionic acid contents were systematically varied (Table 9, Supporting Information). To facilitate the incorporation of polyvinyl alcohol in the aqueous phase, a stock solution containing 5 wt % PVA (Mw=30′000-70′000 g/mol, Sigma-Aldrich) in deionized water was prepared by magnetic stirring at room temperature. Before emulsification, a suspension of ceria particles was prepared to be later used as aqueous phase of the emulsion. For a typical batch of 30 mL of emulsion, cerium oxide particles were first added in a 150 mL container together with the water and 280 μL of a 1M HCl solution to adjust the pH to a value of approximately 4 for optimal dispersion. Two zirconia balls (diameter of 15 mm) were added to the container and the resulting suspension was mixed for 60 seconds at 2000 rpm in a planetary mixer (ARE-250, Thinky, USA). Afterwards, the target amount of PVA stock solution was added and the suspension was further mixed for another 30 seconds at 2000 rpm.

For the emulsification process, a metallic beater from a household kitchen mixer was installed on a laboratory mixer (BDC2002, Fischer Scientific, USA). First, the container filled with ceria suspension was mounted under the mixer. While stirring at the low speed of 200 rpm, propionic acid (>99.5%, Sigma Aldrich, Germany) was added dropwise to the suspension to prevent rapid particle agglomeration. The following amounts of propionic acid were added for a typical 30 mL emulsion batch: 100 μL (37.5 μmol/g of CeO₂ particles), 120 μL (45 μmol/g), 140 μL (52.5 μmol/g) or 160 μL (60 μmol/g). Then, decane was added to the suspension and the mixing speed was increased to 700 rpm and hold for 2 minutes. The obtained emulsion-based ink composition was filled in cartridges and centrifuged for 30 seconds at 1500 rpm. The density of the emulsion was estimated to be 1.887 g/cm3, assuming no air is incorporated through the frothing process (Table 10, Supporting Information).

In addition to the typical ceria content of 33.3 vol %, emulsions with higher particle concentrations in the aqueous phase were also prepared in order to evaluate their effect on the shrinkage of the printed structures upon drying and sintering. Suspensions with ceria fractions of 35, 36 and 37 vol % were prepared by increasing the amount of CeO₂ and decreasing the amount of water accordingly.

### Rheological Characterization

The rheological behavior of the emulsion-based ink compositions was evaluated using a stress-controlled rheometer (MCR 302, Anton-Paar, Austria). To minimize slip, the particle-stabilized emulsions were tested in a six-vane geometry (ST20-6V-20/112.5, Anton-Paar, Austria). Steady-state measurements were performed by increasing the applied shear rate \dot{γ} from 0.001 to 1000 s-1. Oscillatory measurements were conducted at a constant frequency of 10 rad/s while increasing the applied stress amplitude from 1 to 5000 Pa.

### Design of Ceria Structures

A graded structure was designed to enable deep penetration of sunlight radiation into the printed monolith. Such design displays a quadratic base with side length of 30 mm and 48 mm total height. The total height is built in a layer-by-layer fashion using an individual layer height of 0.3 mm. A stepwise gradient was created by varying the relative fraction of solid ceria phase along the height of structure (FIG. 15a-c). This resulted in 4 equally spaced sections with tailored relative density of ceria. Each fixed-density section was 12 mm high. The sections were printed with the one of highest density (D4) at the bottom and the one with lowest density (D1) at the top of the structure, closest to the irradiation source. Holes for the insertion of the thermocouples had an inner diameter of 2.8 mm and were positioned at heights of 10.2, 22.2, 34.2 and 46.2 mm from the bottom of structure.

Simplified grid-like structures were used to assess the printability of the different ink formulations (FIG. 19). In this design, a quadratic base with side length of 15 mm was filled with a serpentine pattern comprising 7 parallel lines separated by a distance of 2.5 mm. This pattern was rotated by 90° in every second layer to generate the grid-like structure. A full grid with 14.1 mm height was created by printing 38 layers with individual height of 0.37 mm.

### 3D Printing

Graded structures were printed using a direct ink writing printer (3D Discovery, regenHU, Switzerland) equipped with a volumetric-controlled dispensing unit (preeflow eco-PEN300, ViscoTec, Germany). The extrusion rate was set to the standard values of 90 μL/min for the suspension-based ink composition and 120 μL/min for the emulsion-based ink composition, if not stated otherwise. During printing, a pressure of 3-4 bar was applied to the cartridge to enable ink flow into the volumetric dispenser. Polypropylene nozzles with inner diameter of 0.41 mm (blue) or 0.61 mm (pink) were used depending on the extrusion rates applied (FIG. 21).

The simplified grid-like structures were printed on a customized Fused Filament Fabrication (FFF) printer (Ultimaker2+, Ultimaker B.V., Netherlands) equipped with a volume-controlled extruder. The ink composition was filled in a 20 mL syringe with Luer-Lock fitting (BD Syringe, USA). During printing, the extrusion volume was controlled by the linear motion of a screw turned by a stepper motor. A nozzle with inner diameter of 0.84 mm was employed to print the grid-like structures used for printability (FIG. 19) and compression tests (FIG. 22).

### Drying and Sintering

Printed structures were dried in air at room temperature for a minimum of 24 hours to remove both oil and water. The resulting green bodies were placed on an alumina ceramic plate, calcined and sintered in an electrical oven (HT08/18, Nabertherm, Switzerland) following a well-defined protocol (FIG. 24a, Supporting Information). In this protocol, samples were first heated to 150° C. at a heating rate of 1.5° C./min and held at this temperature for 2 h to remove the residual liquid content. Next, the oven temperature was increased to 520° C. at 1.5° C./min and held for 2 h to thermally decompose and remove the organic phase. Finally, the temperature was raised further to 1600° C. at 2° C./min and kept for 2 h before cooling back to room temperature at 2° C./min.

### Density and Porosity Analysis

The absolute density of the printed structures was determined by dividing their mass by their geometrical volume. Relative density and porosity were calculated assuming that a dense structure has the theoretical density of ceria of 7.13 g/cm³. Open and closed porosities within the printed filaments were estimated by the Archimedes method using samples obtained by casting the emulsion-based ink composition into a cylindrical mold with diameter of 25 mm and height of 20 mm. The cast sample was dried, calcined and sintered with the same procedure described earlier. The weight of dried and water-infiltrated samples was measured following the Archimedes method. To facilitate infiltration of the samples with deionized water, a vacuum of 10 mbar was applied until no rising air bubble were visible anymore. The weight of the infiltrated sample was measured in water and in air.

### Macroscopic Imaging, Pore Size and Microstructure Analysis

Photographs of the printed structures were captured with a digital camera (FIG. 19). Calcined and sintered samples were measured with a digital caliper to quantify linear shrinkages along different directions (FIG. 20). Wall thicknesses were determined by image analysis of photographed samples and represent averaged values from 10 measurements (FIG. 21). The microstructure of printed specimens was analysed by scanning electron microscopy (Gemini SEM 450, Zeiss, Germany). To this end, broken structures were mounted on a SEM sample holder and covered with 3 nm platinum in a sputter coater (CCU-010, Safematic, Switzerland). The pore size was determined by superimposing a circle on the pore and measuring its diameter with an image analysis tool (ImageJ). The reported average and standard deviation values were obtained by measuring approximately 50 pores per sample.

### Mechanical Testing

Samples for mechanical testing were printed on the customized FFF printer (Ultimaker2+) using a nozzle with inner diameter of 0.84 mm. After sintering, the top surface of the sample was mechanically grinded and polished to obtain parallel planes. Compression experiments were performed on a universal mechanical testing machine (Instron 8562, USA) equipped with a 100 kN load cell. Experiments were run under displacement control by applying a displacement rate of 0.5 mm/min until a total compression stroke of 2.5 mm was reached. The Young's modulus (E) of the specimens was calculated from the initial linear slope of the obtained stress-strain curves. The ultimate strength was taken as the maximum stress that the sample could withstand, whereas the energy absorption was obtained by integrating the area below the measured stress-strain curve.

### IR Furnace for Fast Cycling

Fast thermochemical cycling was performed in a high-power infrared furnace42 (VHT-E48, Advance Riko Inc., Japan) equipped with 4 IR lamps with a total power of 24 kW, a heated length of 225 mm and maximum operating temperature of 1800° C. (FIG. 23a). Samples were placed in a quartz tube of 40 mm inner diameter. The temperatures of the furnace and of the sample were measured with two thermocouples. Thermal cycling was performed between 55° and 1400° C. Heating and cooling rates of 212.5° C./min were applied. The chamber and the sample were purged with Ar gas during heating while the CeO₂ is reduced and with CO₂ gas after cooling to induce re-oxidation of the oxide. Exhaust gases were collected for chemical analysis. The concentration of O₂ was measured by an electrochemical sensor, whereas the concentrations of CO and CO₂ were measured by an infrared sensor at a frequency of 2 Hz (Ultramat 23, Siemens, Switzerland).

### Supporting Information

### Estimation of Threshold Storage Modulus

Filaments in grid-like structures may undergo undesired sagging due to gravitational forces. To prevent filament sagging, the ink composition should display a sufficiently high storage modulus. Following earlier work, we estimate the minimum critical storage modulus required to prevent sagging (G_{c}′) using beam theory, according to which:

G_{c}′=1.4ws⁴D, Eq. S1

where w is the specific weight of the ink composition (=0.25ρᵢₙₖg), ρᵢₙₖ is the specific gravity of the ink, g is the gravitational acceleration, s is the reduced span distance (LID), D is the diameter of the filament, and L is the span length. The above expression is valid for a maximum acceptable deflection of 0.05D at the center of the filament.

Taking ρᵢₙₖ=1.89 g/cm3, g=9.81 m/s2, D=400 μm, we estimate a G_{c}′ value of 1.6 kPa for a reduced span distance (s) of 5.

### Estimation of Threshold Yield Stress

To print distortion-free structures, the yield stress of the ink composition needs to be higher than the stresses arising from gravitational and capillary forces.

Capillary forces may lead to distortion at highly curved surfaces of the printed structure. To determine the minimum critical yield stress (τ_{y,c}) required to prevent such type of distortion, one can balance the capillary forces and the yield stress of the ink composition, yielding the following relation as a simplified one-dimensional approximation:

$${τ}_{y , c} = γ / R , \qquad Eq . S2$$

where γ is the surface tension of the ink and R is the local radius of curvature of the surface. Taking a typical surface tension of 0.040 N/m, the above equation predicts a critical yield stress (τ_{y,c}) of 200 Pa for a surface with a radius of curvature (R) of 200 μm.

In addition to capillary forces, gravity may also cause distortion of printed structures if the yield stress of the ink composition is not high enough to prevent flow in regions of the printed part under high gravitational forces. The flow-inducing gravitational force increases from the top to the bottom of the structure. Balancing this force with the yield stress of the ink composition leads to the following predictive relation for the maximum height (H) for a distortion-free structure:

$$H = \frac{{τ}_{y}}{{ρ}_{ink} g} , \qquad Eq . S3$$

where τ_{y} is the yield stress of the ink.

Taking τ_{y}=175 Pa and ρᵢₙₖ=1.89 g/cm³, we predict that the height of the printed structure should be lower than 9.5 mm to prevent gravity-induced flow of the ink composition at the bottom of the printed part.

### Compositions of Inks Based on Suspensions and Emulsions

The compositions of the suspensions and emulsions used as ink compositions are shown in Tables 8, 9 and 10. Emulsions were prepared with varied concentrations of PVA and propionic acid (Table 9).

### Sintering and Characterization of Monoliths

The geometrical density of ceria monoliths was calculated based on the x, y, and z-dimensions and the weight of calcined and sintered specimens printed at distinct extrusion rates (Table 11). Calcination and sintering were carried out at 520° C. and 1600° C., respectively (FIG. 24a). Our results indicate that an emulsion with 50 vol % oil phase extruded at 180 μL/min shows the same density as a sample obtained from a suspension extruded at 90 μL/min. This shows that it is possible to introduce macropores in the walls of the structures and thereby increase the re-oxidation rate without compromising the relative density of active material available for the redox reaction. In such approach the macroporosity in the walls of the printed structures is created at the expense of the volume fraction of open channels.

TABLE 8
Composition of the suspension-based ceria ink composition in terms
of volume and mass fractions of individual constituents.

| | | | Volume | | |
|---|---|---|---|---|---|
| | | Volume | in 32 ml | Equivalent | Mass |
| | Density | fraction | batch | mass | fraction |
| | (g/cm3) | (vol %) | (ml) | (g) | (wt %) |
| Dolapix CE 64 | 1.200 | 1.48 | 0.48 | 0.57 | 0.44 |
| Cerium oxide powder | 7.130 | 50.00 | 16.00 | 114.08 | 87.80 |
| 20 wt % Pluronic | 1.000 | 43.66 | 13.97 | 13.97 | 10.75 |
| solution in water | | | | | |
| Limonene | 0.841 | 4.87 | 1.56 | 1.31 | 1.01 |
| Total | 4.060 | 100.00 | 32.00 | 129.93 | 100.00 |

TABLE 9
Formulation of emulsion-based ceria ink compositions containing
33.3 vol % ceria and varying weight fractions of PVA in the aqueous
phase. The PVA fraction is calculated with respect to water. To
each ink batch containing 35.65 g ceria, a volume of 100 μL, 120 μL,
140 μL or 160 μL propionic acid was added for emulsification. These
correspond to propionic acid concentrations of 37.5, 45, 52.5 and 60
μmol/g of CeO₂ particles, respectively.

| | | | | | | |
|---|---|---|---|---|---|---|
| PVA content | 0.00 | 0.25 | 0.50 | 1.00 | 1.50 | 2.00 |
| (wt %) | | | | | | |
| Water (g) | 10.00 | 9.50 | 9.00 | 8.00 | 7.00 | 6.00 |
| Ceria (g) | 35.65 | 35.65 | 35.65 | 35.65 | 35.65 | 35.65 |
| 1M HCl (μL) | 280 | 280 | 280 | 280 | 280 | 280 |
| 5 wt % PVA | 0.00 | 0.50 | 1.00 | 2.00 | 3.00 | 4.00 |
| solution (g) | | | | | | |
| Propionic | 100, | 120 | 100, | 100, | 100, | 120, |
| acid (μL) | 120, | | 120, | 120, | 120, | 140, |
| | or 140 | | or 140 | or 140 | or 140 | or 160 |
| Decane (mL) | 15.00 | 15.00 | 15.00 | 15.00 | 15.00 | 15.00 |

TABLE 10
Composition of emulsion-based ceria inks in terms of volume and
mass fractions of individual constituents. The volumes and masses
of propionic acid (100-160 μL) and HCl (280 μL) used in each
individual batch (35.65 g ceria) were neglected in the calculations.

| | | Volume | | | Mass |
|---|---|---|---|---|---|
| | Density | fraction | Volume | Mass | fraction |
| | (g/cm3) | (vol %) | (ml) | (g) | (wt %) |
| Water phase, 50 | | | | | |
| vol % | | | | | |
| Cerium oxide powder | 7.130 | 16.67 | 5.00 | 35.65 | 62.99 |
| Water + 5 wt % PVA | 1.000 | 33.33 | 10.00 | 10.00 | 17.67 |
| solution | | | | | |
| Oil phase, 50 vol % | | | | | |
| Decane | 0.730 | 50.00 | 15.00 | 10.95 | 19.35 |
| Total | 1.887 | 100.00 | 30.00 | 56.60 | 100.00 |

TABLE 11
Calculation of the density of sintered ceria monoliths.

| Monolith | X | Y | Z | Volume | Weight | Density |
|---|---|---|---|---|---|---|
| (extrusion rate) | (mm) | (mm) | (mm) | (cm3) | (g) | (g/cm3) |
| Porous (120 μL/min) | 21.57 | 21.58 | 34.39 | 16.01 | 21.40 | 1.337 |
| Porous (170 μL/min) | 22.19 | 22.21 | 34.40 | 16.95 | 30.95 | 1.826 |
| Porous (180 μL/min) | 22.53 | 22.54 | 34.41 | 17.47 | 33.64 | 1.925 |
| Dense (90 μL/min) | 25.36 | 25.39 | 38.68 | 24.91 | 48.25 | 1.937 |

1. An ink composition for additive manufacturing comprising:
at least a first phase, the first phase being a liquid phase; and
inorganic particles being distributed in the first phase,
wherein the inorganic particles are redox active,
characterized in that the first phase furthermore comprises at least one organic processing additive.

2. The ink composition according to claim 1, wherein the ink composition is free from inorganic rheology additives such as silica or boehmite.

3. The ink composition according to claim 1, wherein the organic processing additive is at least one of: a thermoresponsive material, and/or capable of undergoing a temperature-dependent self-assembly or a thermo-gelling process.

4. The ink composition according to claim 1, wherein at least one of:
the ink composition is a suspension, or
the ink composition further comprises at least one dispersing agent, and wherein at least one of:
the dispersing agent is at least one of: capable of preventing an agglomeration of the inorganic particles or is capable of adsorbing on a surface of the inorganic particles, or
the dispersing agent is at least one of a polyelectrolyte dispersing agent, an organic acid or a derivative or a polymer or a copolymer thereof, an inorganic acid or a derivative or a polymer or a copolymer thereof, a polyamine or copolymers thereof, a poly(methacrylate) or their acids or copolymers thereof, poly(acrylates) or their acids or copolymers thereof, or polyvinylalcohol.

5. The ink composition according to claim 1, wherein the organic processing additive is at least one of: a particle surface modifier or a surface active additive.

6. The ink composition according to claim 1, wherein at least one of:
the ink composition is an emulsion, or
the ink composition further comprises a second phase, wherein the first phase is a continuous phase and the second phase is a dispersed phase, and
wherein at least one of the continuous phase is an aqueous phase or the dispersed phase is an oil phase.

7. The ink composition according to claim 1, wherein at least one of:
the ink composition is a wet foam, or
the ink composition further comprises a second phase, wherein the first phase is a continuous phase and the second phase is a dispersed phase, and
wherein at least one of the continuous phase is an aqueous phase or the dispersed phase a gaseous phase such as air.

8. The ink composition according to claim 1, further comprising at least one rheology modifier.

9. A method of producing the ink composition according to claim 1, the method comprising the steps of distributing the inorganic particles and dissolving the organic processing additive in a liquid solution in order to form the first phase.

10. Use of the ink composition as claimed in claim 1 for additive manufacturing a structure for use at least one of in a thermochemical fuel production process or in a heat transfer application.

11. A method of additive manufacturing a structure for use in a thermochemical fuel production process, the method comprising the steps of:
Providing the ink composition as claimed in claim 1;
Depositing the ink composition so as to form a precursor structure; and
Subjecting the precursor structure to at least one thermal treatment so as to form the structure for use in the thermochemical fuel production process.

12. A method of additive manufacturing a structure for use in a heat transfer application, the method comprising the steps of:
Providing the ink composition as claimed in claim 1;
Depositing the ink composition so as to form a precursor structure; and
Subjecting the precursor structure to at least one thermal treatment so as to form the structure for use in the heat transfer application.

13. The method according to claim 11, wherein the method of additive manufacturing is direct ink writing.

14. The method according to claim 11, wherein the precursor structure, while being formed by the deposition of the ink composition, is at least partially dried.

15. The method according to claim 11, wherein the precursor structure after the sintering step is coated with at least one coating, and wherein at least one of:
wherein the coating is applied to the precursor structure under vacuum,
the coating when being applied to the precursor structure corresponds to a suspension comprising inorganic particles being redox reactive, or
the coated precursor structure is subjected to at least one thermal treatment, wherein the thermal treatment comprises at least one of: at least one drying step, calcination step or sintering step.

16. A structure for use in a thermochemical fuel production process being produced in the method according to claim 11,
wherein said structure has an open-cell void phase and a solid phase, and wherein the structure has an effective porosity, defined as the ratio of a volume of the void phase to a total volume of the structure, being lower than 0.9 or being lower than 0.75, and wherein the structure when exposed to a radiative flux of at least 1300 kilowatts per square meter reaches a temperature at which the inorganic particles undergo reduction and exhibits a temperature gradient of maximal 200 degrees Celsius per centimeter of the structure along any direction of the structure.

17. The structure according to claim 16, wherein the solid phase comprises or consists of the inorganic particles.

18. The structure according to claim 16, wherein at least one of:
the effective porosity decreases along a path of radiation being incident on the structure, or
the structure has an extinction coefficient for solar or infrared radiation, and
wherein the extinction coefficient increases along a path of radiation being incident on the structure.

19. The structure according to claim 16, further comprising at least one coating, wherein the coating comprises the inorganic particles.

20. A method of producing a fuel in a thermochemical fuel production process comprising the steps of:
Providing a structure being produced in the method according to claim 11,
Irradiating the structure with radiation, wherein the structure absorbs the radiation and is reduced,
Subjecting the reduced structure to at least one reacting gas and oxidizing the reduced structure, whereby the reacting gas is reduced and is converted to the fuel.

21. A method of heating a heat transfer fluid in a heat transfer application comprising the steps of:
Providing a structure being produced in the method according to claim 12,
Providing at least one heat transfer fluid that flows across the structure,
Irradiating the structure with radiation, wherein the structure absorbs the radiation and transfers the thus converted heat by convection and radiation to the heat transfer fluid, whereby the heat transfer fluid is heated.

22. A method of heating a structure in a heat transfer application comprising the steps of:
Providing a structure being produced in the method according to claim 12,
Providing at least one heat transfer fluid that flows across the structure to transfer heat by convection and radiation to the structure, whereby the structure is heated.

23. The ink composition according to claim 3, wherein at least one of:
the temperature-dependent self-assembly is reversible or irreversible, or
the thermoresponsive material is a thermoresponsive polymer or copolymer.

24. The ink composition according to claim 5, wherein at least one of:
the particle surface modifier is at least one of: an organic acid or a derivative thereof, a carboxylic acid, propionic acid, valeric acid, a gallate, an alkyl amine, a surfactant or an amphiphile, or
the surface active additive is at least one of: a polymeric surfactant, a vinyl polymer, polyvinylalcohol or polyvinylpyrrolidone.

25. The ink composition according to claim 8, wherein at least one of:
the rheology modifier is provided at least one of in the first phase or in a second phase, or
the rheology modifier is at least one of: a terpene, limonene, cellulose or a cellulose derivative, a polysaccharide, or an alkali swellable emulsion.

26. The method according to claim 11, wherein the thermal treatment comprises at least one of: at least one drying step, calcination step or sintering step.

27. The method according to claim 12, wherein the thermal treatment comprises at least one of: at least one drying step, calcination step or sintering step.

28. The method according to claim 12, wherein the method of additive manufacturing is direct ink writing.

29. The method according to claim 12, wherein the precursor structure, while being formed by the deposition of the ink composition, is at least partially dried.

30. The method according to claim 12, wherein the precursor structure after the sintering step is coated with at least one coating, and wherein at least one of:
the coating is applied to the precursor structure under vacuum,
the coating when being applied to the precursor structure corresponds to a suspension comprising inorganic particles being redox reactive, or
the coated precursor structure is subjected to at least one thermal treatment, wherein the thermal treatment comprises at least one of: at least one drying step, calcination step or sintering step.

31. The method according to claim 20, wherein the radiation is solar radiation.

32. The method according to claim 21, wherein the radiation is solar radiation.
